(19) United States
(12) Patent Application Publication
(10) Pub. No.: US 2026/0228927 A1
(43) Pub. Date: Aug. 6, 2026

(54) ENCODING DEVICE, DECODING DEVICE, ENCODING METHOD, AND DECODING METHOD

(71) Applicant: Panasonic Intellectual Property Corporation of America, Torrance, CA (US)

(72) Inventors: Chong Soon LIM, Singapore (SG); Zheng Wu, Singapore (SG); Han Boon Teo, Singapore (SG); Keng Liang Loi, Singapore (SG); Chung Dean Han, Johor Bahru (MY); Farman Dumanov, Singapore (SG); Kian Soon Cheng, Johor Bahru (MY); Praveen Kumar Yadav, Singapore (SG); Noritaka Iguchi, Osaka (JP); Toshiyasu Sugio, Osaka (JP); Takahiro Nishi, Nara (JP); Atsushi Ito, Osaka (JP)

(21) Appl. No.: 19/576,727

(22) Filed: Mar. 24, 2026

Related U.S. Application Data
(63) Continuation of application No. PCT/JP2024/033967, filed on Sep. 24, 2024.
(60) Provisional application No. 63/542,857, filed on Oct. 6, 2023.

(51) Int. Cl. G06T 9/20; G06T 9/00

(52) U.S. Cl. CPC G06T 9/20; G06T 9/001

(57) ABSTRACT

An encoding device according to an aspect of the present disclosure includes: a circuit; and memory that is connected to the circuit. In operation, the circuit: determines whether, among a plurality of vertices included in a first submesh that has been divided from a three-dimensional mesh, a first vertex that is not positioned on an edge included in an outer periphery of the first submesh overlaps a vertex included in a second submesh that has been divided from the three-dimensional mesh; and based on a determination result of the determination, encodes, into a bitstream, first information indicating whether the first vertex overlaps the vertex included in the second submesh.

### CROSS REFERENCE TO RELATED APPLICATIONS

This is a continuation application of PCT International Application No. PCT/JP2024/033967 filed on September 24, 2024, designating the United States of America, which is based on and claims priority of U.S. Provisional Patent Application No. 63/542857 filed on October 6, 2023. The entire disclosures of the above-identified applications, including the specifications, drawings and claims are incorporated herein by reference in their entirety.

### FIELD

The present disclosure relates to, for example, an encoding device.

### BACKGROUND

PTL 1 proposes a method and a device for encoding and decoding three-dimensional mesh data.

### Citation List

### Patent Literature

PTL 1: Japanese Unexamined Patent Application Publication No. 2006-187015

### SUMMARY

### Technical Problem

There are demands for further improvement in processing of encoding or decoding three-dimensional data. An object of the present disclosure is to improve processing of encoding or decoding three-dimensional data.

### Solution to Problem

An encoding device according to an aspect of the present disclosure includes: a circuit; and memory that is connected to the circuit. In operation, the circuit: determines whether, among a plurality of vertices included in a first submesh that has been divided from a three-dimensional mesh, a first vertex that is not positioned on an edge included in an outer periphery of the first submesh overlaps a vertex included in a second submesh that has been divided from the three-dimensional mesh; and based on a determination result of the determination, encodes, into a bitstream, first information indicating whether the first vertex overlaps the vertex included in the second submesh.

Noted that these general or specific aspects may be implemented using a system, a device, a method, an integrated circuit, a computer program, or a non-transitory computer-readable recording medium such as a CD-ROM, or any combination of systems, devices, methods, integrated circuits, computer programs, and recording media.

### Advantageous Effects

The present disclosure can contribute toward improving processing of encoding three-dimensional data and the like.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a conceptual diagram illustrating a three-dimensional mesh according to an embodiment.

FIG. 2 is a conceptual diagram illustrating basic elements of the three-dimensional mesh according to the embodiment.

FIG. 3 is a conceptual diagram illustrating mapping according to the embodiment.

FIG. 4 is a block diagram illustrating a configuration example of an encoding/decoding system according to the embodiment.

FIG. 5 is a block diagram illustrating a configuration example of an encoding device according to the embodiment.

FIG. 6 is a block diagram illustrating another configuration example of the encoding device according to the embodiment.

FIG. 7 is a block diagram illustrating a configuration example of a decoding device according to the embodiment.

FIG. 8 is a block diagram illustrating another configuration example of the decoding device according to the embodiment.

[FIG. 9] Is a conceptual diagram illustrating a configuration example of a bitstream according to the embodiment.

FIG. 10 is a conceptual diagram illustrating another configuration example of the bitstream according to the embodiment.

FIG. 11 is a conceptual diagram illustrating yet another configuration example of the bitstream according to the embodiment.

FIG. 12 is a block diagram illustrating a specific example of the encoding/decoding system according to the embodiment.

FIG. 13 is a conceptual diagram illustrating a configuration example of point cloud data according to the embodiment.

FIG. 14 is a conceptual diagram illustrating a data file example of the point cloud data according to the embodiment.

FIG. 15 is a conceptual diagram illustrating a configuration example of mesh data according to the embodiment.

FIG. 16 is a conceptual diagram illustrating a data file example of the mesh data according to the embodiment.

FIG. 17 is a conceptual diagram illustrating a type of three-dimensional data according to the embodiment.

FIG. 18 is a block diagram illustrating a configuration example of a three-dimensional data encoder according to the embodiment.

FIG. 19 is a block diagram illustrating a configuration example of a three-dimensional data decoder according to the embodiment.

FIG. 20 is a block diagram illustrating another configuration example of the three-dimensional data encoder according to the embodiment.

FIG. 21 is a block diagram illustrating another configuration example of the three-dimensional data decoder according to the embodiment.

FIG. 22 is a conceptual diagram illustrating a specific example of encoding processing according to the embodiment.

FIG. 23 is a conceptual diagram illustrating a specific example of decoding processing according to the embodiment.

FIG. 24 is a block diagram illustrating an implementation example of the encoding device according to the embodiment.

FIG. 25 is a block diagram illustrating an implementation example of the decoding device according to the embodiment.

FIG. 26 is a block diagram illustrating another configuration example of the encoding/decoding system according to the embodiment.

FIG. 27 is a block diagram illustrating another configuration example of the encoding device according to the embodiment.

FIG. 28 is a block diagram illustrating another configuration example of the decoding device according to the embodiment.

FIG. 29 is a block diagram illustrating a detailed configuration example of the encoding device according to the embodiment.

FIG. 30 is a block diagram illustrating a detailed configuration variation of the encoding device according to the embodiment.

FIG. 31 is a flowchart illustrating a process by the encoding device according to the embodiment.

FIG. 32 is an explanatory diagram schematically illustrating the encoding of a mesh frame according to the embodiment.

FIG. 33 is a block diagram illustrating a detailed configuration example of the decoding device according to the embodiment.

FIG. 34 is a block diagram illustrating a detailed configuration variation of the decoding device according to the embodiment.

FIG. 35 is a flowchart illustrating a process by the decoding device according to the embodiment.

[FIG. 36] is an explanatory diagram schematically illustrating the decoding of a mesh frame according to the embodiment.

FIG. 37 is an explanatory diagram illustrating an example of a subdivision according to the embodiment.

FIG. 38 is an explanatory diagram illustrating an example of the displacement of vertices in which the vertices are subdivided and then displaced, according to the embodiment.

FIG. 39 is an explanatory diagram illustrating an example of the vertices of an original mesh according to the embodiment.

FIG. 40 is an explanatory diagram illustrating an example of a mesh according to the embodiment.

FIG. 41 is an explanatory diagram illustrating an example of the division of a mesh into submeshes according to the embodiment.

FIG. 42 is a first explanatory diagram illustrating an example of the packing of displacement information into an image frame according to the embodiment.

FIG. 43 is a second explanatory diagram illustrating an example of the packing of displacement information into an image frame according to the embodiment.

FIG. 44 is a third explanatory diagram illustrating an example of the packing of displacement information into an image frame according to the embodiment.

FIG. 45 is a block diagram illustrating another configuration example of the encoding device according to the embodiment.

FIG. 46 is a block diagram illustrating a configuration example of a preprocessor according to the embodiment.

FIG. 47 is a block diagram illustrating another configuration example of the decoding device according to the embodiment.

FIG. 48 is a block diagram illustrating a specific configuration example of the decoding device according to the embodiment.

FIG. 49 is a flowchart illustrating a process for a submesh boundary performed by the encoding device according to the embodiment.

FIG. 50 is a flowchart illustrating an example of a process for a submesh boundary performed by the decoding device according to the embodiment.

FIG. 51 is a flowchart illustrating another example of the process for a submesh boundary performed by the decoding device according to the embodiment.

FIG. 52 is a flowchart illustrating a process for a submesh performed by the decoding device according to the embodiment.

FIG. 53 is a diagram illustrating an example of a submesh according to the embodiment.

FIG. 54 is a diagram illustrating another example of the submesh according to the embodiment.

FIG. 55 is a diagram illustrating another example of the submesh according to the embodiment.

FIG. 56 is a diagram illustrating an example of syntax related to signaling of boundary information according to the embodiment.

FIG. 57 is a diagram illustrating another example of the syntax related to signaling of boundary information according to the embodiment.

FIG. 58 is a diagram for describing an example of a method of using syntax according to the embodiment.

FIG. 59 is a diagram for describing an order in which vertices according to the embodiment are processed.

FIG. 60 is a diagram for describing an example of the order in which vertices according to the embodiment are processed.

FIG. 61 is a diagram for describing another example of an order in which vertices according to the embodiment are processed.

FIG. 62 is a diagram for describing another example of the order in which vertices according to the embodiment are processed.

FIG. 63 is a diagram illustrating an example of syntax related to signaling of the number of submeshes according to the embodiment.

FIG. 64 is a diagram illustrating another example of the syntax related to signaling of boundary information according to the embodiment.

FIG. 65 is a diagram illustrating another example of the syntax related to signaling of boundary information according to the embodiment.

FIG. 66 is a flowchart illustrating an example of a basic encoding process according to the embodiment.

FIG. 67 is a flowchart illustrating an example of a basic decoding process according to the embodiment.

### DESCRIPTION OF EMBODIMENT ( S )

### Introduction

Three-dimensional (3D) meshes are used in, for example, a computer graphics video. For example, the computer graphics video may include a plurality of frames different in time from one another, and each of the frames may be represented in the form of three-dimensional meshes.

The three-dimensional meshes each include vertex information indicating the positions of a plurality of vertices in a three-dimensional space, connection information indicating the connections between the plurality of vertices, and attribute information indicating attributes of the vertices or faces. The faces are each built in accordance with the connectivity relation among the plurality of vertices. Such three-dimensional meshes can represent various computer graphics videos.

For the transmission and storage of three-dimensional meshes, an efficient encoding and decoding of three-dimensional meshes is expected. For the efficient encoding and decoding of three-dimensional meshes, arithmetic encoding and arithmetic decoding may be used.

There is a demand for further improvement in an encoding or decoding process related to three-dimensional data. The present disclosure improves the encoding or decoding process related to three-dimensional data.

Hereinafter, aspects of the invention derived from the content of the disclosure of the present description will be described by way of example, and the effects and the like derived from the aspect of the invention will be described.

An encoding device according to Example 1 includes: a circuit; and memory that is connected to the circuit. In operation, the circuit: determines whether, among a plurality of vertices included in a first submesh that has been divided from a three-dimensional mesh, a first vertex that is not positioned on an edge included in an outer periphery of the first submesh overlaps a vertex included in a second submesh that has been divided from the three-dimensional mesh; and based on a determination result of the determination, encodes, into a bitstream, first information indicating whether the first vertex overlaps the vertex included in the second submesh.

Accordingly, for example, a decoding device that has received the bitstream can determine whether the first vertex overlaps the vertex included in the second submesh by only checking the first information, without decoding the first submesh and the second submesh and performing a process for determining whether the first vertex overlaps the vertex included in the second submesh. Accordingly, it is possible to reduce the processing amount.

An encoding device according to Example 2 is the encoding device according to Example 1, in which the circuit may further encode, into the bitstream, second information indicating a second vertex on which a predetermined process is performed first among two or more vertices that are included in the plurality of vertices and sequentially subjected to the predetermined process.

Accordingly, the decoding device that has received the bitstream can perform the predetermined process on the second vertex first among the two or more vertices, based on the second information. Therefore, the decoding device can perform the predetermined process on the two or more vertices in an appropriate order.

An encoding device according to Example 3 is the encoding device according to Example 1 or Example 2, in which the circuit may further encode, into the bitstream, third information indicating a third vertex on which a predetermined process is performed last among two or more vertices that are included in the plurality of vertices and sequentially subjected to the predetermined process.

Accordingly, the decoding device that has received the bitstream can perform the predetermined process on the third vertex last among the two or more vertices, based on the third information. Therefore, the decoding device can perform the predetermined process on the two or more vertices in an appropriate order.

An encoding device according to Example 4 is the encoding device according to any one of Example 1 to Example 3, in which the circuit may further encode, into the bitstream, fourth information indicating an order of the plurality of vertices when a predetermined process is performed on each of the plurality of vertices.

Accordingly, the decoding device that has received the bitstream can perform the predetermined process sequentially on the two or more vertices, based on the fourth information. Therefore, the decoding device can perform the predetermined process on the two or more vertices in an appropriate order.

A decoding device according to Example 5 includes: a circuit; and memory that is connected to the circuit. In operation, the circuit: decodes, from a bitstream, first information indicating whether, among a plurality of vertices included in a first submesh that has been divided from a three-dimensional mesh, a first vertex that is not positioned on an edge included in an outer periphery of the first submesh overlaps a vertex included in a second submesh that has been divided from the three-dimensional mesh; and based on the first information, determines whether the first vertex overlaps the vertex included in the second submesh.

Accordingly, the decoding device can determine whether the first vertex overlaps the vertex included in the second submesh by only checking the first information, without decoding the first submesh and the second submesh and performing a process for determining whether the first vertex overlaps the vertex included in the second submesh. Accordingly, it is possible to reduce the processing amount.

A decoding device according to Example 6 is the decoding device according to Example 5, in which the circuit may further decode, from the bitstream, second information indicating a second vertex on which a predetermined process is performed first among two or more vertices that are included in the plurality of vertices and sequentially subjected to the predetermined process.

Accordingly, the decoding device can perform the predetermined process on the second vertex first among the two or more vertices, based on the second information. Therefore, the decoding device can perform the predetermined process on the two or more vertices in an appropriate order.

A decoding device according to Example 7 is the decoding device according to Example 5 or Example 6, in which the circuit may further decode, from the bitstream, third information indicating a third vertex on which a predetermined process is performed last among two or more vertices that are included in the plurality of vertices and sequentially subjected to the predetermined process.

Accordingly, the decoding device can perform the predetermined processing on the third vertex last among the two or more vertices, based on the third information. Therefore, the decoding device can perform the predetermined process on the two or more vertices in an appropriate order.

A decoding device according to Example 8 is the decoding device according to any one of Example 5 to Example 7, in which the circuit may further decode, from the bitstream, fourth information indicating an order of the plurality of vertices when a predetermined process is performed on each of the plurality of vertices.

Accordingly, the decoding device can perform the predetermined process sequentially on the two or more vertices, based on the fourth information. Therefore, the decoding device can perform the predetermined process on the two or more vertices in an appropriate order.

An encoding method according to Example 9 includes: determining whether, among a plurality of vertices included in a first submesh that has been divided from a three-dimensional mesh, a first vertex that is not positioned on an edge included in an outer periphery of the first submesh overlaps a vertex included in a second submesh that has been divided from the three-dimensional mesh; and based on a determination result of the determining, encoding, into a bitstream, first information indicating whether the first vertex overlaps the vertex included in the second submesh.

With this, the same advantageous effects as those of the encoding device according to Example 1 can be produced.

A decoding method according to Example 10 includes: decoding, from a bitstream, first information indicating whether, among a plurality of vertices included in a first submesh that has been divided from a three-dimensional mesh, a first vertex that is not positioned on an edge included in an outer periphery of the first submesh overlaps a vertex included in a second submesh that has been divided from the three-dimensional mesh; and based on the first information, determining whether the first vertex overlaps the vertex included in the second submesh.

With this, the same advantageous effects as those of the decoding device according to Example 5 can be produced.

Moreover, these general or specific aspects may be implemented using a system, a device, a method, an integrated circuit, a computer program, or a non-transitory computer-readable recording medium such as a CD-ROM, or any combination of systems, devices, methods, integrated circuits, computer programs, and recording media.

### Expressions and terms

The following expressions and terms will be used herein.

(1) Three-dimensional mesh

A three-dimensional mesh is a set of a plurality of faces and indicates, for example, a three-dimensional object. In addition, a three-dimensional mesh is mainly constituted of vertex information, connection information, and attribute information. A three-dimensional mesh may be expressed as a polygon mesh or a mesh. In addition, a three-dimensional mesh may have a temporal change. A three-dimensional mesh may include metadata related to vertex information, connection information, and attribute information or other additional information.

(2) Vertex information

Vertex information is information indicating a vertex. For example, vertex information indicates a position of a vertex in a three-dimensional space. In addition, a vertex corresponds to a vertex of a face that constitutes a three-dimensional mesh. Vertex information may be expressed as "geometry". In addition, vertex information may also be expressed as position information.

(3) Connection information

Connection information is information indicating a connection between vertexes. For example, connection information indicates a connection for constructing a face or an edge of a three-dimensional mesh. Connection information may be expressed as "connectivity". In addition, connection information may also be expressed as face information.

(4) Attribute information

Attribute information is information indicating an attribute of a vertex or a face. For example, attribute information indicates an attribute such as a color, an image, a normal vector, and the like associated with a vertex or a face. Attribute information may be expressed as "texture".

(5) Face

A face is an element that constitutes a three-dimensional mesh. Specifically, a face is a polygon on a plane in a three-dimensional space. For example, a face can be determined as a triangle in the three-dimensional space.

(6) Plane

A plane is a two-dimensional plane in a three-dimensional space. For example, a polygon is formed on a plane and a plurality of polygons are formed on a plurality of planes.

(7) Bitstream

A bitstream corresponds to encoded information. A bitstream can also be expressed as a stream, an encoded bitstream, a compressed bitstream, or an encoded signal.

(8) Encoding and decoding

The expression "encode" may be replaced with expressions such as store, include, write, describe, signalize, send out, notify, save, or compress and such expressions may be interchangeably used. For example, encoding information may mean including information in a bitstream. In addition, encoding information in a bitstream may mean encoding the information and generating a bitstream that includes the encoded information.

In addition, the expression "decode" may be replaced with expressions such as read, interpret, scan, load, derive, acquire, receive, extract, restore, reconstruct, decompress, or expand and such expressions may be interchangeably used. For example, decoding information may mean acquiring information from a bitstream. In addition, decoding information from a bitstream may mean decoding the bitstream and acquiring information included in the bitstream.

(9) Ordinal numbers

In the description, an ordinal number such as first, second, or the like may be affixed to a constituent element or the like. Such ordinal numbers may be replaced as necessary. In addition, an ordinal number may be newly affixed to or removed from a constituent element or the like. Furthermore, the ordinal numbers may be affixed to elements in order to identify the elements and may not correspond to any meaningful order.

### Three-dimensional mesh

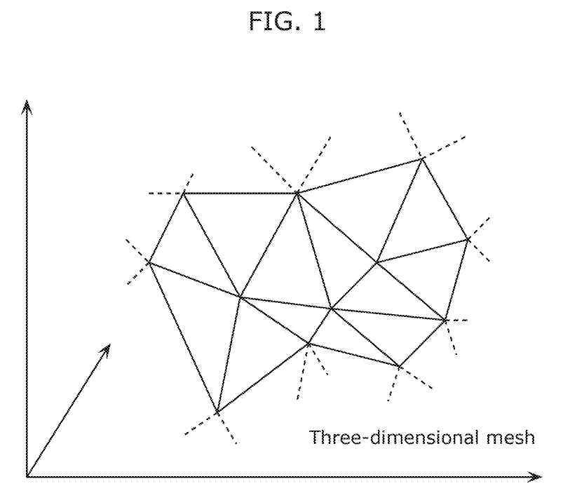

FIG. 1 is a conceptual diagram illustrating a three-dimensional mesh according to the present embodiment. The three-dimensional mesh is constituted of a plurality of faces. For example, each face is a triangle. Vertexes of the triangles are determined in a three-dimensional space. In addition, a three-dimensional mesh indicates a three-dimensional object. Each face may have a color or an image.

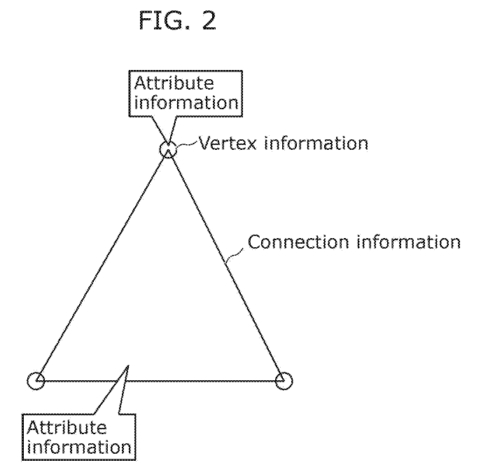

FIG. 2 is a conceptual diagram illustrating basic elements of a three-dimensional mesh according to the present embodiment. The three-dimensional mesh is constituted of vertex information, connection information, and attribute information. Vertex information indicates a position of a vertex of a face in a three-dimensional space. Connection information indicates a connection between vertexes. A face can be identified based on vertex information and connection information. In other words, an uncolored three-dimensional object is formed in a three-dimensional space based on vertex information and connection information.

Attribute information may be associated with a vertex or associated with a face. Attribute information associated with a vertex may be expressed as "attribute per point". Attribute information associated with a vertex may indicate an attribute of the vertex itself or indicate an attribute of a face connected to the vertex.

For example, a color may be associated with a vertex as attribute information. The color associated with the vertex may be the color of the vertex or the color of a face connected to the vertex. The color of the face may be an average of a plurality of colors associated with a plurality of vertexes of the face. In addition, a normal vector may be associated with a vertex or a face as attribute information. Such a normal vector can express a front and a rear of a face.

In addition, a two-dimensional image may be associated with a face as attribute information. The two-dimensional image associated with a face is also expressed as a texture image or an "attribute map". In addition, information indicating mapping between a face and a two-dimensional image may be associated with the face as attribute information. Such information indicating mapping may be expressed as mapping information, vertex information of a texture image, texture coordinates, or an "attribute UV coordinate".

Furthermore, information on a color, an image, a moving image, and the like to be used as attribute information may be expressed as "parametric space".

A texture is reflected in a three-dimensional object based on such attribute information. In other words, a colored three-dimensional object is formed in a three-dimensional space based on vertex information, connection information, and attribute information.

Note that while attribute information is associated with a vertex or a face in the description given above, alternatively, attribute information may be associated with an edge.

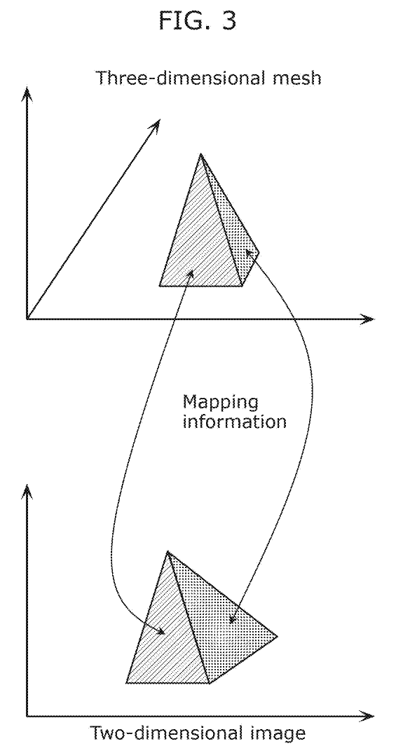

FIG. 3 is a conceptual diagram illustrating mapping according to the present embodiment. For example, a region of a two-dimensional image on a two-dimensional plane can be mapped to a face of a three-dimensional mesh in a three-dimensional space. Specifically, coordinate information of a region in the two-dimensional image is associated with a face of the three-dimensional mesh. Accordingly, an image of the mapped region in the two-dimensional image is reflected in the face of the three-dimensional mesh.

The use of mapping enables a two-dimensional image to be used as attribute information to be separated from the three-dimensional mesh. For example, in encoding of the three-dimensional mesh, the two-dimensional image may be encoded based on an image encoding system or a video encoding system.

### System configuration

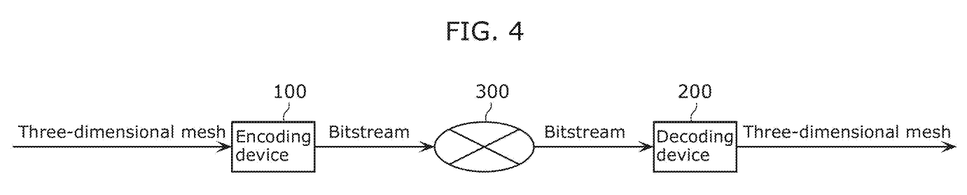

FIG. 4 is a block diagram illustrating a configuration example of an encoding/decoding system according to the present embodiment. In FIG. 4, the encoding/decoding system includes encoding device 100 and decoding device 200.

For example, encoding device 100 acquires a three-dimensional mesh and encodes the three-dimensional mesh into a bitstream. In addition, encoding device 100 outputs the bitstream to network 300. For example, the bitstream includes an encoded three-dimensional mesh and control information for decoding the encoded three-dimensional mesh. Encoding of the three-dimensional mesh causes information of the three-dimensional mesh to be compressed.

Network 300 transmits the bitstream from encoding device 100 to decoding device 200. Network 300 may be the Internet, a wide area network (WAN), a local area network (LAN), or a combination thereof. Network 300 is not necessarily limited to two-way communication and may be a unidirectional communication network for terrestrial digital broadcasting, satellite broadcasting, or the like.

In addition, network 300 may be replaced with a recording medium such as a DVD (digital versatile disc), a BD (Blu-Ray Disc (registered trademark)), or the like.

Decoding device 200 acquires a bitstream and decodes a three-dimensional mesh from the bitstream. Decoding of the three-dimensional mesh causes information of the three-dimensional mesh to be expanded. For example, decoding device 200 decodes a three-dimensional mesh according to a decoding method corresponding to an encoding method used by encoding device 100 to encode the three-dimensional mesh. In other words, encoding device 100 and decoding device 200 perform encoding and decoding according to an encoding method and a decoding method which correspond to each other.

Note that the three-dimensional mesh before encoding can also be expressed as an original three-dimensional mesh. In addition, the three-dimensional mesh after decoding is also expressed as a reconstructed three-dimensional mesh.

### Encoding device

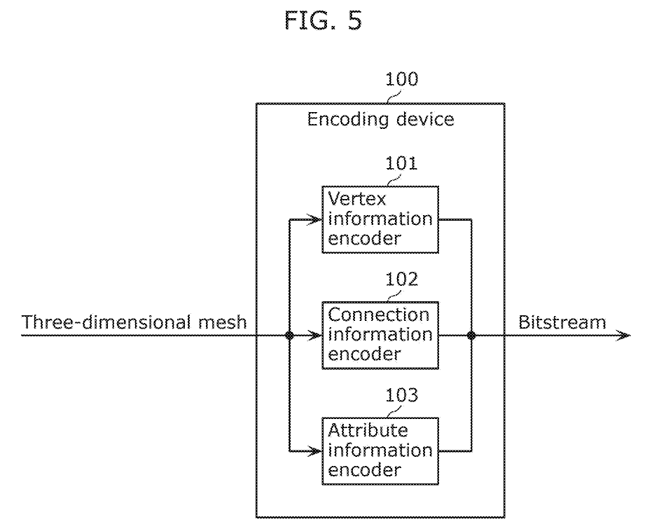

FIG. 5 is a block diagram illustrating a configuration example of encoding device 100 according to the present embodiment. For example, encoding device 100 includes vertex information encoder 101, connection information encoder 102, and attribute information encoder 103.

Vertex information encoder 101 is an electric circuit which encodes vertex information. For example, vertex information encoder 101 encodes vertex information into a bitstream according to a format defined with respect to the vertex information.

Connection information encoder 102 is an electric circuit which encodes connection information. For example, connection information encoder 102 encodes connection information into a bitstream according to a format defined with respect to the connection information.

Attribute information encoder 103 is an electric circuit which encodes attribute information. For example, attribute information encoder 103 encodes attribute information into a bitstream according to a format defined with respect to the attribute information.

Variable-length coding or fixed length coding may be used for encoding vertex information, connection information, and attribute information. The variable-length coding may accommodate Huffman coding, context-adaptive binary arithmetic coding (CABAC), or the like.

Vertex information encoder 101, connection information encoder 102, and attribute information encoder 103 may be integrated. Alternatively, each of vertex information encoder 101, connection information encoder 102, and attribute information encoder 103 may be more finely segmentalized into a plurality of constituent elements.

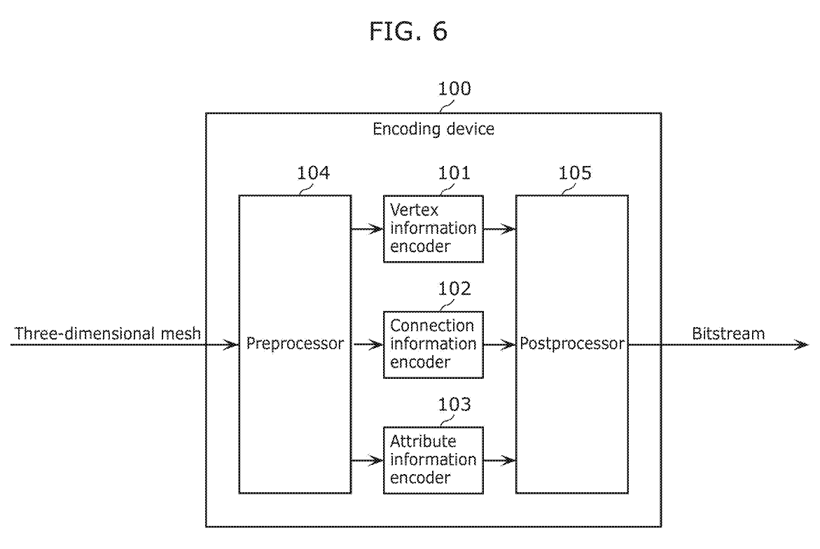

FIG. 6 is a block diagram illustrating another configuration example of encoding device 100 according to the present embodiment. For example, in addition to the components illustrated in FIG. 5, encoding device 100 includes preprocessor 104 and postprocessor 105.

Preprocessor 104 is an electric circuit which performs processing before encoding of vertex information, connection information, and attribute information. For example, preprocessor 104 may perform transformation processing, demultiplexing, multiplexing, or the like with respect to a three-dimensional mesh before encoding. More specifically, for example, preprocessor 104 may demultiplex vertex information, connection information, and attribute information from the three-dimensional mesh before encoding.

Postprocessor 105 is an electric circuit which performs processing after the encoding of vertex information, connection information, and attribute information. For example, postprocessor 105 may perform transformation processing, demultiplexing, multiplexing, or the like with respect to vertex information, connection information, and attribute information after encoding. More specifically, for example, postprocessor 105 may multiplex vertex information, connection information, and attribute information after encoding into a bitstream. In addition, for example, postprocessor 105 may further perform variable-length coding with respect to vertex information, connection information, and attribute information after the encoding.

### Decoding device

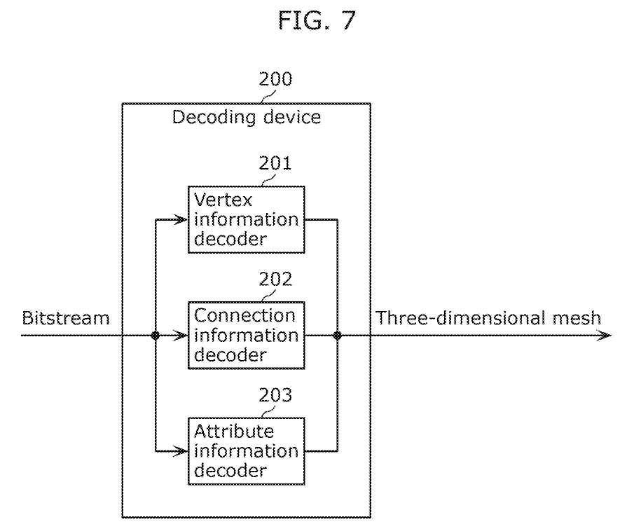

FIG. 7 is a block diagram illustrating a configuration example of decoding device 200 according to the present embodiment. For example, decoding device 200 includes vertex information decoder 201, connection information decoder 202, and attribute information decoder 203.

Vertex information decoder 201 is an electric circuit which decodes vertex information. For example, vertex information decoder 201 decodes vertex information from a bitstream according to a format defined with respect to the vertex information.

Connection information decoder 202 is an electric circuit which decodes connection information. For example, connection information decoder 202 decodes connection information from a bitstream according to a format defined with respect to the connection information.

Attribute information decoder 203 is an electric circuit which decodes attribute information. For example, attribute information decoder 203 decodes attribute information from a bitstream according to a format defined with respect to the attribute information.

Variable-length decoding or fixed length decoding may be used for decoding vertex information, connection information, and attribute information. The variable-length decoding may accommodate Huffman coding, context-adaptive binary arithmetic coding (CABAC), or the like.

Vertex information decoder 201, connection information decoder 202, and attribute information decoder 203 may be integrated. Alternatively, each of vertex information decoder 201, connection information decoder 202, and attribute information decoder 203 may be more finely segmentalized into a plurality of constituent elements.

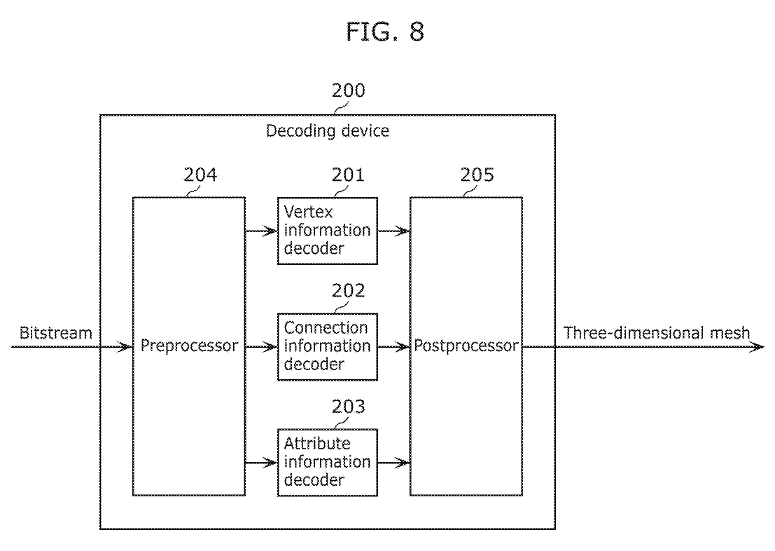

FIG. 8 is a block diagram illustrating another configuration example of decoding device 200 according to the present embodiment. For example, in addition to the components illustrated in FIG. 7, decoding device 200 includes preprocessor 204 and postprocessor 205.

Preprocessor 204 is an electric circuit which performs processing before decoding of vertex information, connection information, and attribute information. For example, preprocessor 204 may perform transformation processing, demultiplexing, multiplexing, or the like with respect to a bitstream before decoding of vertex information, connection information, and attribute information.

More specifically, for example, preprocessor 204 may demultiplex, from a bitstream, a sub-bitstream corresponding to vertex information, a sub-bitstream corresponding to connection information, and a sub-bitstream corresponding to attribute information. In addition, for example, preprocessor 204 may perform variable-length decoding with respect to the bitstream in advance before decoding of vertex information, connection information, and attribute information.

Postprocessor 205 is an electric circuit which performs processing after the decoding of vertex information, connection information, and attribute information. For example, postprocessor 205 may perform transformation processing, demultiplexing, multiplexing, or the like with respect to vertex information, connection information, and attribute information after decoding. More specifically, for example, postprocessor 205 may multiplex vertex information, connection information, and attribute information after decoding into a three-dimensional mesh.

### Bitstream

Vertex information, connection information, and attribute information are encoded and stored in a bitstream. A relationship between these pieces of information and the bitstream will be described below.

FIG. 9 is a conceptual diagram illustrating a configuration example of a bitstream according to the present embodiment. In this example, connection information, vertex information, and attribute information are integrated in the bitstream. For example, connection information, vertex information, and attribute information may be included in one file.

In addition, a plurality of portions of the pieces of information may be sequentially stored such as a first portion of connection information, a first portion of vertex information, a first portion of attribute information, a second portion of connection information, a second portion of vertex information, a second portion of attribute information, ... The plurality of portions may correspond to a plurality of temporally different portions, correspond to a plurality of spatially different portions, or correspond to a plurality of different faces.

Furthermore, an order of storage of connection information, vertex information, and attribute information is not limited to the example described above and an order of storage that differs from the above may be used.

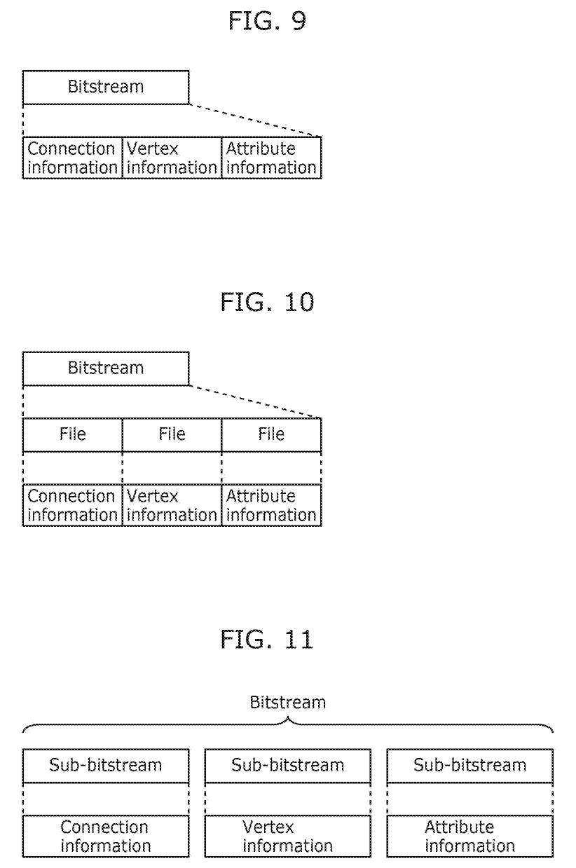

FIG. 10 is a conceptual diagram illustrating another configuration example of a bitstream according to the present embodiment. In the example, a plurality of files are included in a bitstream and connection information, vertex information, and attribute information are respectively stored in different files. While a file including connection information, a file including vertex information, and a file including attribute information are illustrated here, storage formats are not limited to this example. For example, two types of information among connection information, vertex information, and attribute information may be included in one file and the one remaining type of information may be included in another file.

Alternatively, the pieces of information can be stored by being divided into a larger number of files. For example, a plurality of portions of connection information may be stored in a plurality of files, a plurality of portions of vertex information may be stored in a plurality of files, and a plurality of portions of attribute information may be stored in a plurality of files. The plurality of portions may correspond to a plurality of temporally different portions, correspond to a plurality of spatially different portions, or correspond to a plurality of different faces.

Furthermore, an order of storage of connection information, vertex information, and attribute information is not limited to the example described above and an order of storage that differs from the above may be used.

FIG. 11 is a conceptual diagram illustrating another configuration example of a bitstream according to the present embodiment. In the example, a bitstream is constituted of a plurality of separable sub-bitstreams and connection information, vertex information, and attribute information are respectively stored in different sub-bitstreams.

While a sub-bitstream including connection information, a sub-bitstream including vertex information, and a sub-bitstream including attribute information are illustrated here, storage formats are not limited to this example.

For example, two types of information among connection information, vertex information, and attribute information may be included in one sub-bitstream and the one remaining type of information may be included in another sub-bitstream. Specifically, attribute information such as a two-dimensional image may be stored in a sub-bitstream conforming to an image coding system separately from a sub-bitstream of connection information and vertex information.

In addition, each sub-bitstream may include a plurality of files. Furthermore, a plurality of portions of connection information may be stored in a plurality of files, a plurality of portions of vertex information may be stored in a plurality of files, and a plurality of portions of attribute information may be stored in a plurality of files.

Furthermore, an order of storage of connection information, vertex information, and attribute information is not limited to the example illustrated in FIG. 9, FIG. 10, and FIG. 11, and an order of storage that differs from this example may be used. For example, vertex information, connection information, and attribute information may be stored in a bitstream in this order. Alternatively, in an order other than this order, e.g., in any of orders: connection information, attribute information, and vertex information; vertex information, attribute information, and connection information; attribute information, connection information, and vertex information; and attribute information, vertex information, and connection information, these pieces of information may be stored in a bitstream.

Furthermore, each of connection information, vertex information, and attribute information may be divided into a plurality of data items, and the plurality of data items may be stored in a bitstream in a periodic order or in a random order.

### Specific example

FIG. 12 is a block diagram illustrating a specific example of the encoding/decoding system according to the present embodiment. In FIG. 12, the encoding/decoding system includes three-dimensional data encoding system 110, three-dimensional data decoding system 210, and external connector 310.

Three-dimensional data encoding system 110 includes controller 111, input/output processor 112, three-dimensional data encoder 113, three-dimensional data generator 115, and system multiplexer 114. Three-dimensional data decoding system 210 includes controller 211, input/output processor 212, three-dimensional data decoder 213, system demultiplexer 214, presenter 215, and user interface 216.

In three-dimensional data encoding system 110, sensor data is input from a sensor terminal to three-dimensional data generator 115. Three-dimensional data generator 115 generates three-dimensional data that is point cloud data, mesh data, or the like from the sensor data and inputs the three-dimensional data to three-dimensional data encoder 113.

For example, three-dimensional data generator 115 generates vertex information and generates connection information and attribute information which correspond to the vertex information. Three-dimensional data generator 115 may process vertex information when generating connection information and attribute information. For example, three-dimensional data generator 115 may reduce a data amount by deleting overlapping vertexes or transform vertex information (position shift, rotation, normalization, or the like). In addition, three-dimensional data generator 115 may render attribute information.

While three-dimensional data generator 115 is a constituent element of three-dimensional data encoding system 110 in FIG. 12, three-dimensional data generator 115 may be disposed on the outside independent of three-dimensional data encoding system 110.

For example, a sensor terminal that provides sensor data for generating three-dimensional data may be a mobile object such as an automobile, a flying object such as an airplane, a mobile terminal, a camera, or the like. Alternatively, a range sensor such as LIDAR, a millimeter-wave radar, an infrared sensor, or a range finder, a stereo camera, a combination of a plurality of monocular cameras, or the like may be used as the sensor terminal.

The sensor data may be a distance (position) of an object, a monocular camera image, a stereo camera image, a color, a reflectance, an attitude or an orientation of a sensor, a gyro, a sensing position (GPS information or elevation), a velocity, an acceleration, a time of day of sensing, air temperature, air pressure, humidity, magnetism, or the like.

Three-dimensional data encoder 113 corresponds to encoding device 100 illustrated in FIG. 5 and the like. For example, three-dimensional data encoder 113 encodes three-dimensional data and generates encoded data. In addition, three-dimensional data encoder 113 generates control information when encoding the three-dimensional data. Furthermore, three-dimensional data encoder 113 inputs the encoded data to system multiplexer 114 together with the control information.

The encoding system of three-dimensional data may be an encoding system using geometry or an encoding system using a video codec. In this case, an encoding system using geometry may also be expressed as a geometry-based encoding system. An encoding system using a video codec may also be expressed as a video-based encoding system.

System multiplexer 114 multiplexes encoded data and control information input from three-dimensional data encoder 113 and generates multiplexed data using a prescribed multiplexing system. System multiplexer 114 may multiplex other media such as video, audio, subtitles, application data, or document files, reference time information, or the like together with the encoded data and control information of three-dimensional data. Furthermore, system multiplexer 114 may multiplex attribute information related to sensor data or three-dimensional data.

For example, multiplexed data has a file format for accumulation, a packet format for transmission, or the like. ISOBMFF or an ISOBMFF-based system may be used as an accumulation system or a transmission system. Alternatively, MPEG-DASH, MMT, MPEG-2 TS Systems, RTP, or the like may be used.

In addition, multiplexed data is output as a transmission signal by input/output processor 112 to external connector 310. The multiplexed data may be transmitted as a transmission signal in a wired manner or in a wireless manner. Alternatively, the multiplexed data is accumulated in an internal memory or a storage device. The multiplexed data may be transmitted via the Internet to a cloud server or stored in an external storage device.

For example, the transmission or accumulation of the multiplexed data is performed by a method in accordance with a medium for transmission or accumulation such as broadcasting or communication. As a communication protocol, http, ftp, TCP, UDP, IP, or a combination thereof may be used. In addition, a pull-type communication scheme may be used or a push-type communication scheme may be used.

Ethernet (registered trademark), USB, RS-232C, HDMI (registered trademark), a coaxial cable, or the like may be used for wired transmission. In addition, 3GPP (registered trademark), 3G/4G/5G as specified by IEEE, a wireless LAN, Bluetooth, or a millimeter-wave may be used for wireless transmission. Furthermore, for example, DVB-T2, DVB-S2, DVB-C2, ATSC 3.0, ISDB-S3, or the like may be used as a broadcasting system.

Note that sensor data may be input to three-dimensional data generator 115 or system multiplexer 114. In addition, three-dimensional data or encoded data may be output as-is as a transmission signal to external connector 310 via input/output processor 112. The transmission signal output from three-dimensional data encoding system 110 is input to three-dimensional data decoding system 210 via external connector 310.

In addition, each operation of three-dimensional data encoding system 110 may be controlled by controller 111 which executes application programs.

In three-dimensional data decoding system 210, a transmission signal is input to input/output processor 212. Input/output processor 212 decodes multiplexed data having a file format or a packet format from the transmission signal and inputs the multiplexed data to system demultiplexer 214. System demultiplexer 214 acquires encoded data and control information from the multiplexed data and inputs the encoded data and the control information to three-dimensional data decoder 213. System demultiplexer 214 may extract other media, reference time information, or the like from the multiplexed data.

Three-dimensional data decoder 213 corresponds to decoding device 200 illustrated in FIG. 7 and the like. For example, three-dimensional data decoder 213 decodes three-dimensional data from the encoded data based on an encoding system specified in advance. Subsequently, the three-dimensional data is presented to a user by presenter 215.

In addition, additional information such as sensor data may be input to presenter 215. Presenter 215 may present three-dimensional data based on the additional information. In addition, an instruction by the user may be input to user interface 216 from a user terminal. Furthermore, presenter 215 may present three-dimensional data based on the input instruction.

Note that input/output processor 212 may acquire three-dimensional data and encoded data from external connector 310.

In addition, each operation of three-dimensional data decoding system 210 may be controlled by controller 211 which executes application programs.

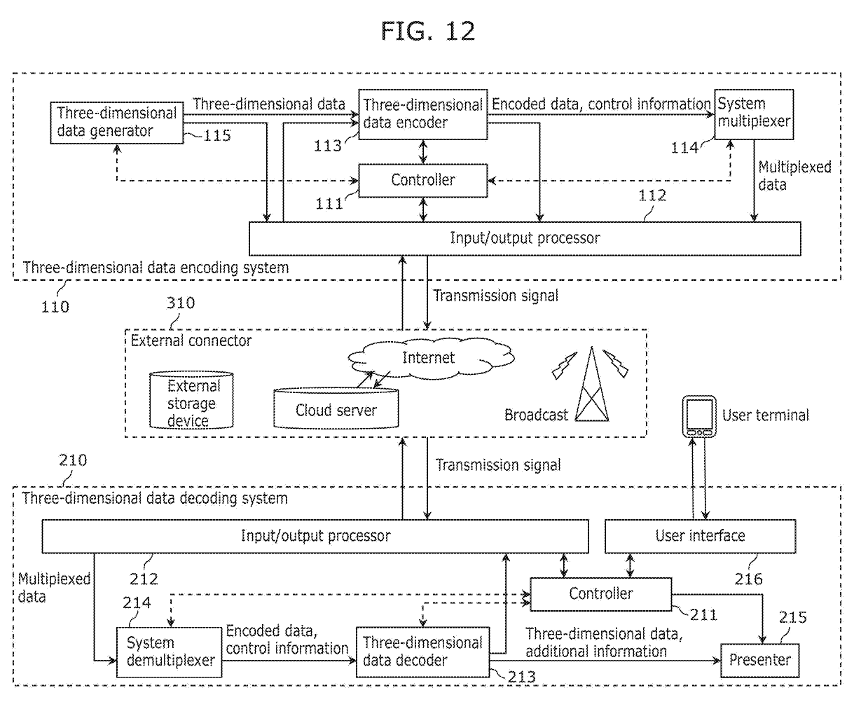

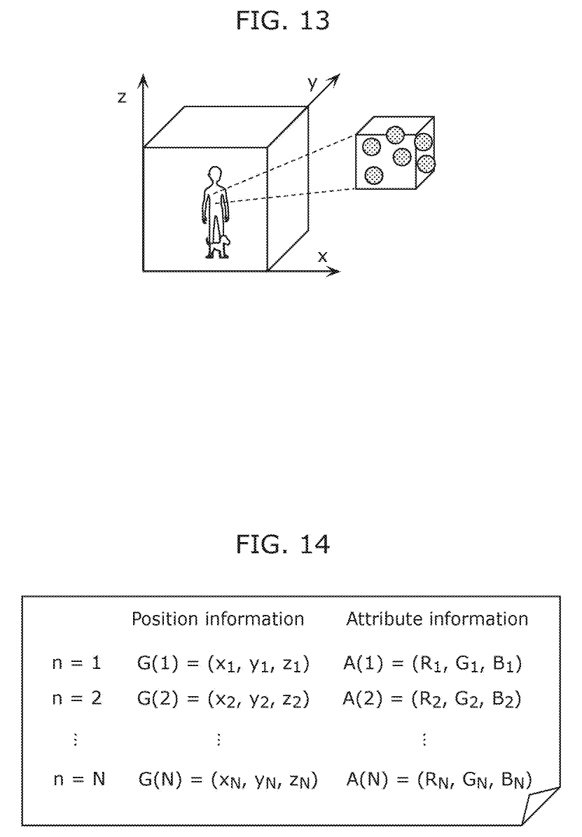

FIG. 13 is a conceptual diagram illustrating a configuration example of point cloud data according to the present embodiment. Point cloud data refers to data of a point cloud that indicates a three-dimensional object.

Specifically, a point cloud is constituted of a plurality of points and has position information which indicates a three-dimensional coordinate position of each point and attribute information which indicates an attribute of each point. The position information is also expressed as geometry.

For example, a type of attribute information may be a color, a reflectance, or the like. Attribute information related to one type may be associated with one point, attribute information related to a plurality of different types may be associated with one point, or attribute information having a plurality of values with respect to a same type may be associated with one point.

FIG. 14 is a conceptual diagram illustrating a data file example of the point cloud data according to the present embodiment. The example is an example of a case where items of position information and items of attribute information have a one-to-one correspondence and the example indicates position information and attribute information of N-number of points which constitute the point cloud data. In this example, position information is information indicating a three-dimensional coordinate position by three axes of x, y, and z and attribute information is information indicating a color by RGB. As a representative data file of point cloud data, a PLY file or the like can be used.

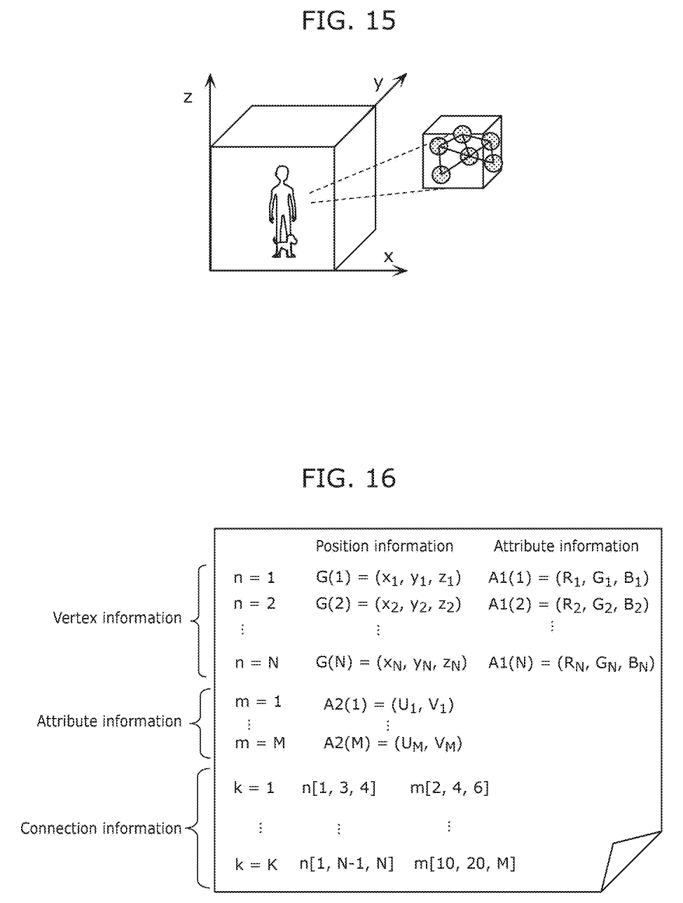

FIG. 15 is a conceptual diagram illustrating a configuration example of mesh data according to the present embodiment. Mesh data is data used in CG (computer graphics) or the like and is data of a three-dimensional mesh which represents a three-dimensional shape of an object by a plurality of faces. Each face is also expressed as a polygon and has a polygonal shape such as a triangle or a quadrilateral.

Specifically, in addition to the plurality of points which constitute a point cloud, a three-dimensional mesh is constituted of a plurality of edges and a plurality of faces. Each point is also expressed as a vertex or a position. Each edge corresponds to a line segment which connects two vertexes. Each face corresponds to an area enclosed by three or more edges.

In addition, a three-dimensional mesh has position information indicating three-dimensional coordinate positions of vertexes. The position information is also expressed as vertex information or geometry. Furthermore, a three-dimensional mesh has connection information indicating a relationship among a plurality of vertexes constituting an edge or a face. The connection information is also expressed as connectivity. In addition, a three-dimensional mesh has attribute information indicating an attribute with respect to a vertex, an edge, or a face. The attribute information in a three-dimensional mesh is also expressed as a texture.

For example, attribute information may indicate a color, a reflectance, or a normal vector with respect to a vertex, an edge, or a face. An orientation of a normal vector can express a front and a rear of a face.

An object file or the like may be used as a data file format of mesh data.

FIG. 16 is a conceptual diagram illustrating a data file example of the mesh data according to the present embodiment. In the example, a data file includes pieces of position information G(1) to G(N) and pieces of attribute information A1(1) to A1(N) of N-number of vertexes which constitute a three-dimensional mesh. In addition, in the example, M-number of pieces of attribute information A2(1) to A2(M) are included. An item of attribute information need not correspond one-to-one to a vertex and need not correspond one-to-one to a face. In addition, attribute information need not exist.

Connection information is indicated by a combination of indexes of vertexes. n [1, 3, 4] indicates a face of a triangle constituted of three vertexes n = 1, n = 3, and n = 4. In addition, m [2, 4, 6] indicates that pieces of attribute information m = 2, m = 4, and m = 6 respectively correspond to the three vertexes.

In addition, a substantive content of the attribute information may be described in a separate file. Furthermore, a pointer with respect to the content may be associated with a vertex, a face, or the like. For example, attribute information indicating an image with respect to a face may be stored in a two-dimensional attribute map file. In addition, a file name of the attribute map and a two-dimensional coordinate value in the attribute map may be described in pieces of attribute information A2(1) to A2(M). Methods of designating attribute information with respect to a face are not limited to these methods and any kind of method may be used.

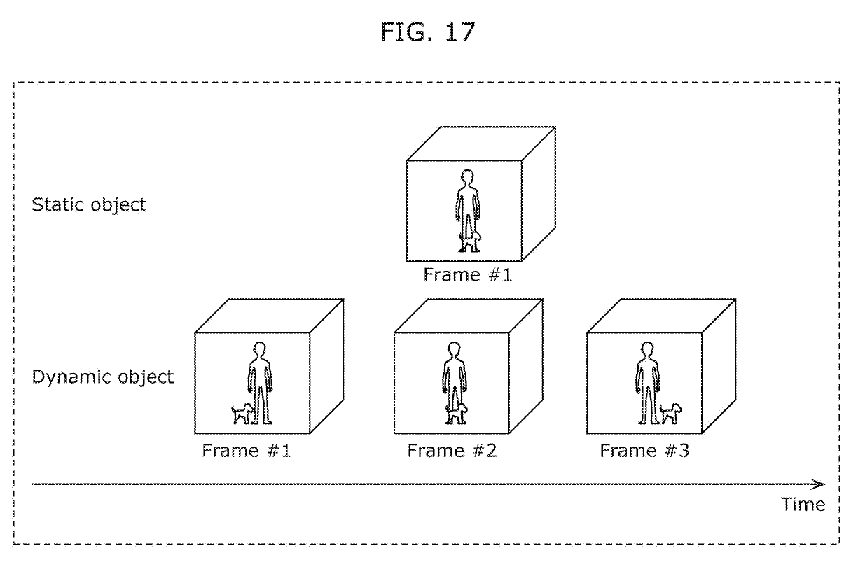

FIG. 17 is a conceptual diagram illustrating a type of three-dimensional data according to the present embodiment. Point cloud data and mesh data may either indicate a static object or a dynamic object. A static object is an object that does not temporally change and a dynamic object is an object that temporally changes. A static object may correspond to three-dimensional data with respect to an arbitrary time point.

For example, point cloud data with respect to an arbitrary time point may be expressed as a PCC frame. In addition, mesh data with respect to an arbitrary time point may be expressed as a mesh frame. Furthermore, a PCC frame and a mesh frame may be simply expressed as a frame.

In addition, an area of an object may be limited to a certain range in a similar manner to ordinary video data or need not be limited in a similar manner to map data. Furthermore, a density of points or faces may be set in various ways. Sparse point cloud data or sparse mesh data may be used or dense point cloud data or dense mesh data may be used.

Next, encoding and decoding of a point cloud or a three-dimensional mesh will be described. A device, processing, or a syntax for encoding and decoding vertex information of a three-dimensional mesh according to the present disclosure may be applied to the encoding and decoding of a point cloud. A device, processing, or a syntax for encoding and decoding a point cloud according to the present disclosure may be applied to the encoding and decoding of vertex information of a three-dimensional mesh.

In addition, a device, processing, or a syntax for encoding and decoding attribute information of a point cloud according to the present disclosure may be applied to the encoding and decoding of connection information or attribute information of a three-dimensional mesh. Furthermore, a device, processing, or a syntax for encoding and decoding connection information or attribute information of a three-dimensional mesh according to the present disclosure may be applied to the encoding and decoding of attribute information of a point cloud.

Furthermore, at least a part of processing may be commonalized between the encoding and decoding of point cloud data and the encoding and decoding of mesh data. Accordingly, sizes of circuits and software programs can be suppressed.

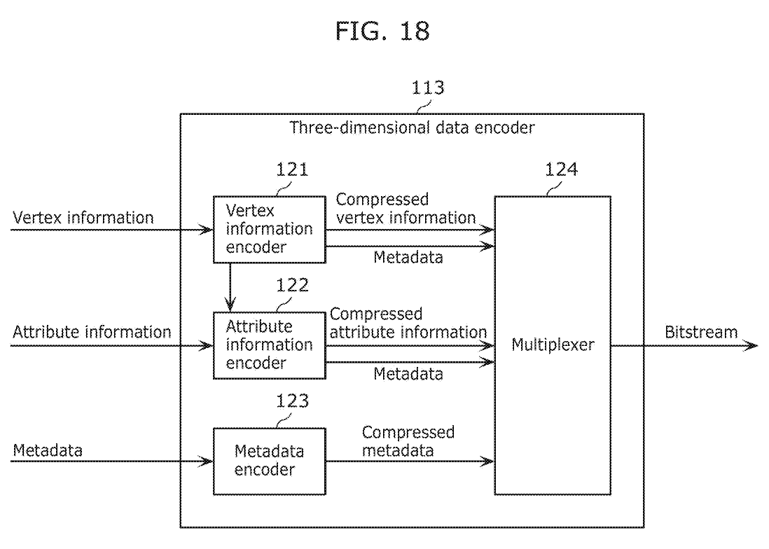

FIG. 18 is a block diagram illustrating a configuration example of three-dimensional data encoder 113 according to the present embodiment. In this example, three-dimensional data encoder 113 includes vertex information encoder 121, attribute information encoder 122, metadata encoder 123, and multiplexer 124. Vertex information encoder 121, attribute information encoder 122, and multiplexer 124 may correspond to vertex information encoder 101, attribute information encoder 103, postprocessor 105, and the like illustrated in FIG. 6.

In addition, in this example, three-dimensional data encoder 113 encodes three-dimensional data according to a geometry-based encoding system. Encoding according to the geometry-based encoding system takes a three-dimensional structure into consideration. Furthermore, in encoding according to the geometry-based encoding system, attribute information is encoded using configuration information obtained during encoding of vertex information.

Specifically, first, vertex information, attribute information, and metadata included in three-dimensional data generated from sensor data are respectively input to vertex information encoder 121, attribute information encoder 122, and metadata encoder 123. In this case, connection information included in three-dimensional data may be handled in a similar manner to attribute information. In addition, in the case of point cloud data, position information may be handled as vertex information.

Vertex information encoder 121 encodes vertex information into compressed vertex information and outputs the compressed vertex information to multiplexer 124 as encoded data. In addition, vertex information encoder 121 generates metadata of the compressed vertex information and outputs the metadata to multiplexer 124. Furthermore, vertex information encoder 121 generates configuration information and outputs the configuration information to attribute information encoder 122.

Attribute information encoder 122 encodes attribute information into compressed attribute information using the configuration information generated by vertex information encoder 121 and outputs the compressed attribute information to multiplexer 124 as encoded data. In addition, attribute information encoder 122 generates metadata of the compressed attribute information and outputs the metadata to multiplexer 124.

Metadata encoder 123 encodes compressible metadata into compressed metadata and outputs the compressed metadata to multiplexer 124 as encoded data. The metadata encoded by metadata encoder 123 may be used to encode vertex information and to encode attribute information.

Multiplexer 124 multiplexes the compressed vertex information, the metadata of the compressed vertex information, the compressed attribute information, the metadata of the compressed attribute information, and the compressed metadata into a bitstream. In addition, multiplexer 124 inputs the bitstream into a system layer.

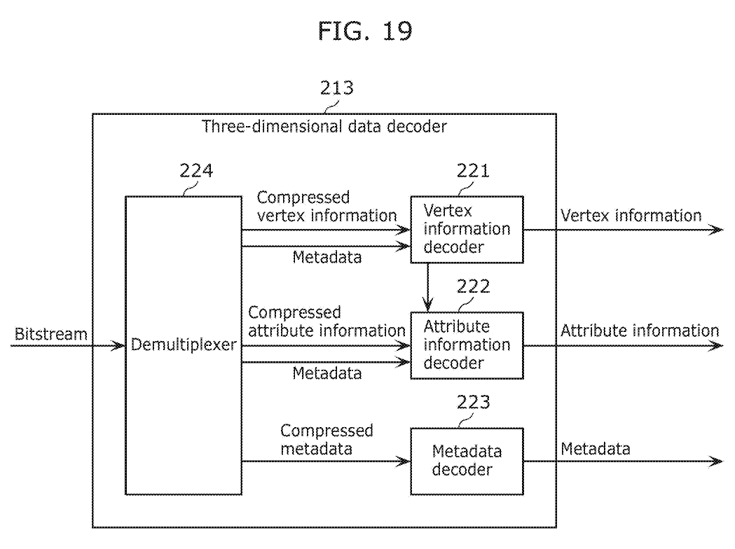

FIG. 19 is a block diagram illustrating a configuration example of three-dimensional data decoder 213 according to the present embodiment. In this example, three-dimensional data decoder 213 includes vertex information decoder 221, attribute information decoder 222, metadata decoder 223, and demultiplexer 224. Vertex information decoder 221, attribute information decoder 222, and demultiplexer 224 may correspond to vertex information decoder 201, attribute information decoder 203, preprocessor 204, and the like illustrated in FIG. 8.

In addition, in this example, three-dimensional data decoder 213 decodes three-dimensional data according to a geometry-based encoding system. Decoding according to the geometry-based encoding system takes a three-dimensional structure into consideration. Furthermore, in decoding according to the geometry-based encoding system, attribute information is decoded using configuration information obtained during decoding of vertex information.

Specifically, first, a bitstream is input from a system layer into demultiplexer 224. Demultiplexer 224 separates compressed vertex information, metadata of the compressed vertex information, compressed attribute information, metadata of the compressed attribute information, and compressed metadata from the bitstream. The compressed vertex information and the metadata of the compressed vertex information are input to vertex information decoder 221. The compressed attribute information and the metadata of the compressed attribute information are input to attribute information decoder 222. The metadata is input to metadata decoder 223.

Vertex information decoder 221 decodes vertex information from the compressed vertex information using the metadata of the compressed vertex information. In addition, vertex information decoder 221 generates configuration information and outputs the configuration information to attribute information decoder 222. Attribute information decoder 222 decodes attribute information from the compressed attribute information using the configuration information generated by vertex information decoder 221 and the metadata of the compressed attribute information. Metadata decoder 223 decodes metadata from the compressed metadata. The metadata decoded by metadata decoder 223 may be used to decode vertex information and to decode attribute information.

Subsequently, the vertex information, the attribute information, and the metadata are output from three-dimensional data decoder 213 as three-dimensional data. For example, the metadata is metadata of vertex information and attribute information and can be used in an application program.

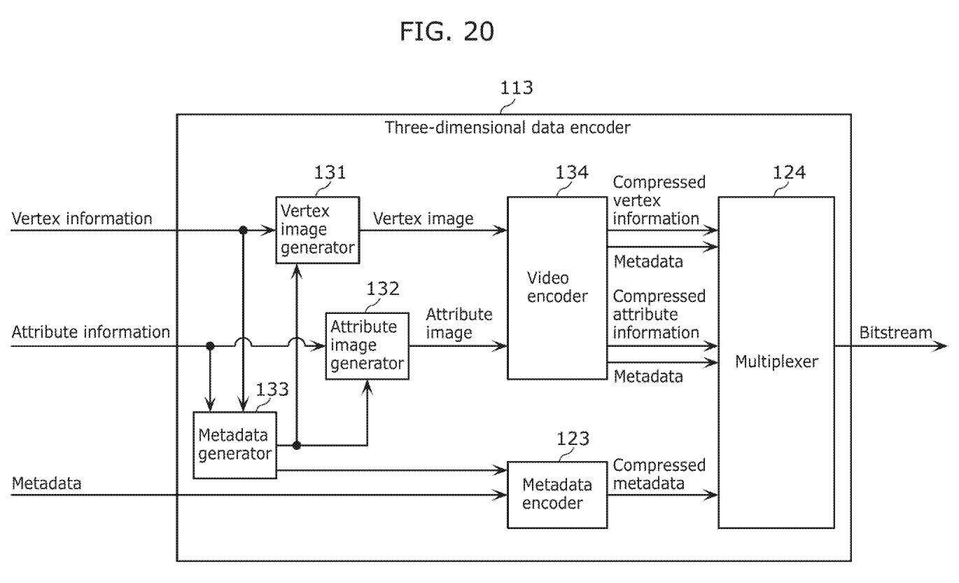

FIG. 20 is a block diagram illustrating another configuration example of three-dimensional data encoder 113 according to the present embodiment. In this example, three-dimensional data encoder 113 includes vertex image generator 131, attribute image generator 132, metadata generator 133, video encoder 134, metadata encoder 123, and multiplexer 124. Vertex image generator 131, attribute image generator 132, and video encoder 134 may correspond to vertex information encoder 101, attribute information encoder 103, and the like illustrated in FIG. 6.

In addition, in this example, three-dimensional data encoder 113 encodes three-dimensional data according to a video-based encoding system. In encoding according to the video-based encoding system, a plurality of two-dimensional images are generated from three-dimensional data and the plurality of two-dimensional images are encoded according to a video encoding system. In this case, the video encoding system may be HEVC (high efficiency video coding), VVC (versatile video coding), or the like.

Specifically, first, vertex information and attribute information included in three-dimensional data generated from sensor data are input to metadata generator 133. In addition, the vertex information and the attribute information are respectively input to vertex image generator 131 and attribute image generator 132. Furthermore, the metadata included in the three-dimensional data is input to metadata encoder 123. In this case, connection information included in three-dimensional data may be handled in a similar manner to attribute information. In addition, in the case of point cloud data, position information may be handled as vertex information.

Metadata generator 133 generates map information of a plurality of two-dimensional images from the vertex information and the attribute information. In addition, metadata generator 133 inputs the map information into vertex image generator 131, attribute image generator 132, and metadata encoder 123.

Vertex image generator 131 generates a vertex image based on the vertex information and the map information and inputs the vertex image into video encoder 134. Attribute image generator 132 generates an attribute image based on the attribute information and the map information and inputs the attribute image into video encoder 134.

Video encoder 134 respectively encodes the vertex image and the attribute image into compressed vertex information and compressed attribute information according to the video encoding system and outputs the compressed vertex information and the compressed attribute information to multiplexer 124 as encoded data. In addition, video encoder 134 generates metadata of the compressed vertex information and metadata of the compressed attribute information and outputs the pieces of metadata to multiplexer 124.

Metadata encoder 123 encodes compressible metadata into compressed metadata and outputs the compressed metadata to multiplexer 124 as encoded data. Compressible metadata includes map information. In addition, the metadata encoded by metadata encoder 123 may be used to encode vertex information and to encode attribute information.

Multiplexer 124 multiplexes the compressed vertex information, the metadata of the compressed vertex information, the compressed attribute information, the metadata of the compressed attribute information, and the compressed metadata into a bitstream. In addition, multiplexer 124 inputs the bitstream into a system layer.

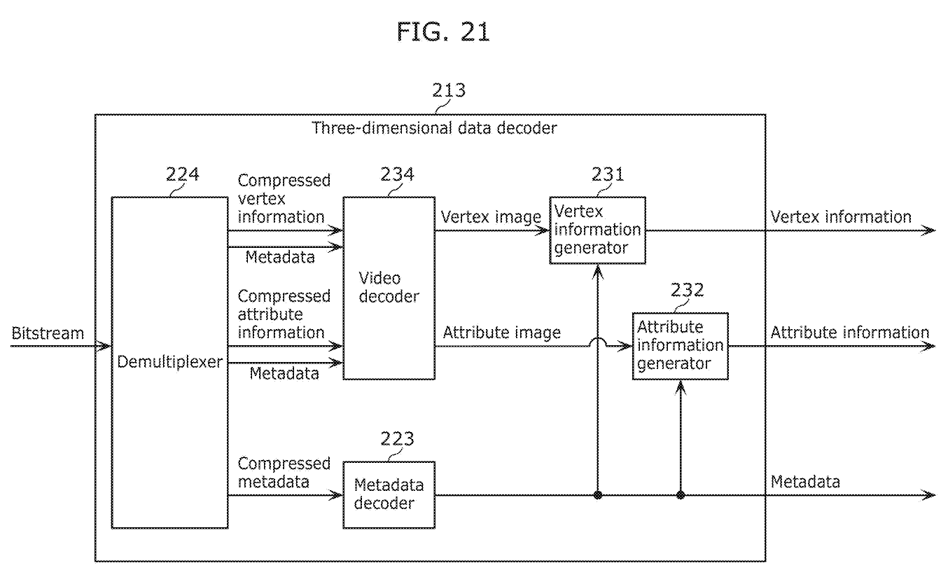

FIG. 21 is a block diagram illustrating another configuration example of three-dimensional data decoder 213 according to the present embodiment. In this example, three-dimensional data decoder 213 includes vertex information generator 231, attribute information generator 232, video decoder 234, metadata decoder 223, and demultiplexer 224. Vertex information generator 231, attribute information generator 232, and video decoder 234 may correspond to vertex information decoder 201, attribute information decoder 203, and the like illustrated in FIG. 8.

In addition, in this example, three-dimensional data decoder 213 decodes three-dimensional data according to a video-based encoding system. In decoding according to the video-based encoding system, a plurality of two-dimensional images are decoded according to a video encoding system and three-dimensional data is generated from the plurality of two-dimensional images. In this case, the video encoding system may be HEVC (high efficiency video coding), VVC (versatile video coding), or the like.

Specifically, first, a bitstream is input from a system layer into demultiplexer 224. Demultiplexer 224 separates compressed vertex information, metadata of the compressed vertex information, compressed attribute information, metadata of the compressed attribute information, and compressed metadata from the bitstream. The compressed vertex information, the metadata of the compressed vertex information, the compressed attribute information, and the metadata of the compressed attribute information are input to video decoder 234. The compressed metadata is input to metadata decoder 223.

Video decoder 234 decodes a vertex image according to the video encoding system. In doing so, video decoder 234 decodes the vertex image from the compressed vertex information using the metadata of the compressed vertex information. In addition, video decoder 234 inputs the vertex image into vertex information generator 231. Furthermore, video decoder 234 decodes an attribute image according to the video encoding system. In doing so, video decoder 234 decodes the attribute image from the compressed attribute information using the metadata of the compressed attribute information. In addition, video decoder 234 inputs the attribute image into attribute information generator 232.

Metadata decoder 223 decodes metadata from the compressed metadata. The metadata decoded by metadata decoder 223 includes map information to be used to generate vertex information and to generate attribute information. In addition, the metadata decoded by metadata decoder 223 may be used to decode the vertex image and to decode the attribute image.

Vertex information generator 231 reproduces vertex information from the vertex image according to the map information included in the metadata decoded by metadata decoder 223. Attribute information generator 232 reproduces attribute information from the attribute image according to the map information included in the metadata decoded by metadata decoder 223.

Subsequently, the vertex information, the attribute information, and the metadata are output from three-dimensional data decoder 213 as three-dimensional data. For example, the metadata is metadata of vertex information and attribute information and can be used in an application program.

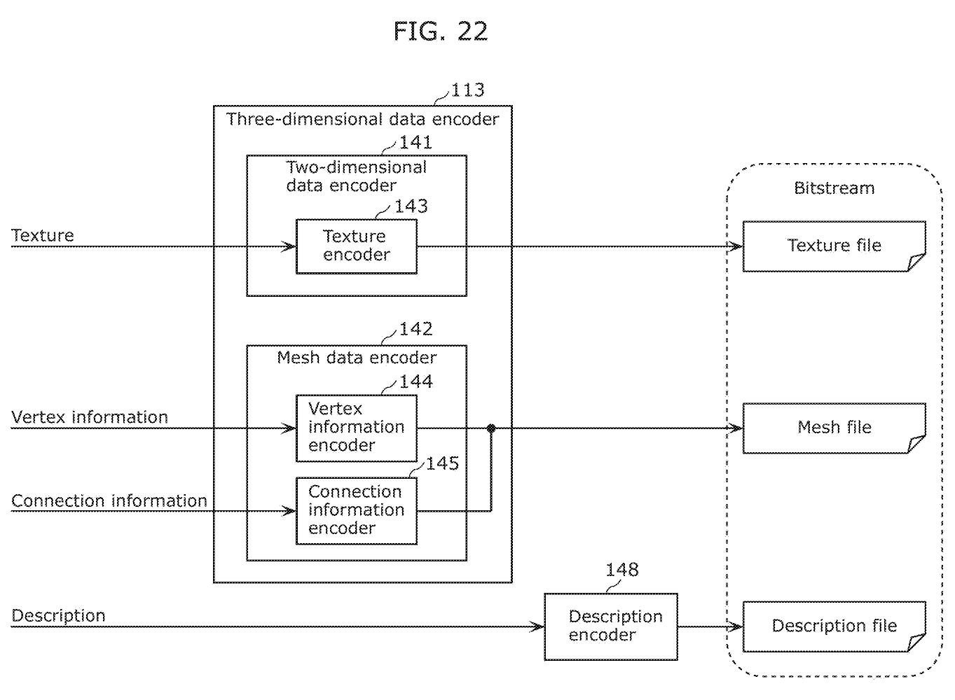

FIG. 22 is a conceptual diagram illustrating a specific example of encoding processing according to the present embodiment. FIG. 22 illustrates three-dimensional data encoder 113 and description encoder 148. In this example, three-dimensional data encoder 113 includes two-dimensional data encoder 141 and mesh data encoder 142. Two-dimensional data encoder 141 includes texture encoder 143. Mesh data encoder 142 includes vertex information encoder 144 and connection information encoder 145.

Vertex information encoder 144, connection information encoder 145, and texture encoder 143 may correspond to vertex information encoder 101, connection information encoder 102, attribute information encoder 103, and the like illustrated in FIG. 6.

For example, two-dimensional data encoder 141 operates as texture encoder 143 and generates a texture file by encoding a texture corresponding to attribute information as two-dimensional data according to an image encoding system or a video encoding system.

In addition, mesh data encoder 142 operates as vertex information encoder 144 and connection information encoder 145 and generates a mesh file by encoding vertex information and connection information. Mesh data encoder 142 may further encode mapping information with respect to a texture. The encoded mapping information may be included in a mesh file.

In addition, description encoder 148 generates a description file by encoding a description corresponding to metadata such as text data. Description encoder 148 may encode a description in the system layer. For example, description encoder 148 may be included in system multiplexer 114 illustrated in FIG. 12.

Due to the operation described above, a bitstream including a texture file, a mesh file, and a description file is generated. The files may be multiplexed in the bitstream in a file format such as gITF (graphics language transmission format) or USD (universal scene description).

Note that three-dimensional data encoder 113 may include two mesh data encoders as mesh data encoder 142. For example, one mesh data encoder encodes vertex information and connection information of a static three-dimensional mesh and the other mesh data encoder encodes vertex information and connection information of a dynamic three-dimensional mesh.

In addition, two mesh files may be included in the bitstream so as to correspond to the three-dimensional meshes. For example, one mesh file corresponds to the static three-dimensional mesh and the other mesh file corresponds to the dynamic three-dimensional mesh.

Furthermore, the static three-dimensional mesh may be an intra-frame three-dimensional mesh which is encoded using intra-prediction and the dynamic three-dimensional mesh may be an inter-frame three-dimensional mesh which is encoded using inter-prediction. In addition, as information of the dynamic three-dimensional mesh, difference information between vertex information or connection information of the intra-frame three-dimensional mesh and vertex information or connection information of the inter-frame three-dimensional mesh may be used.

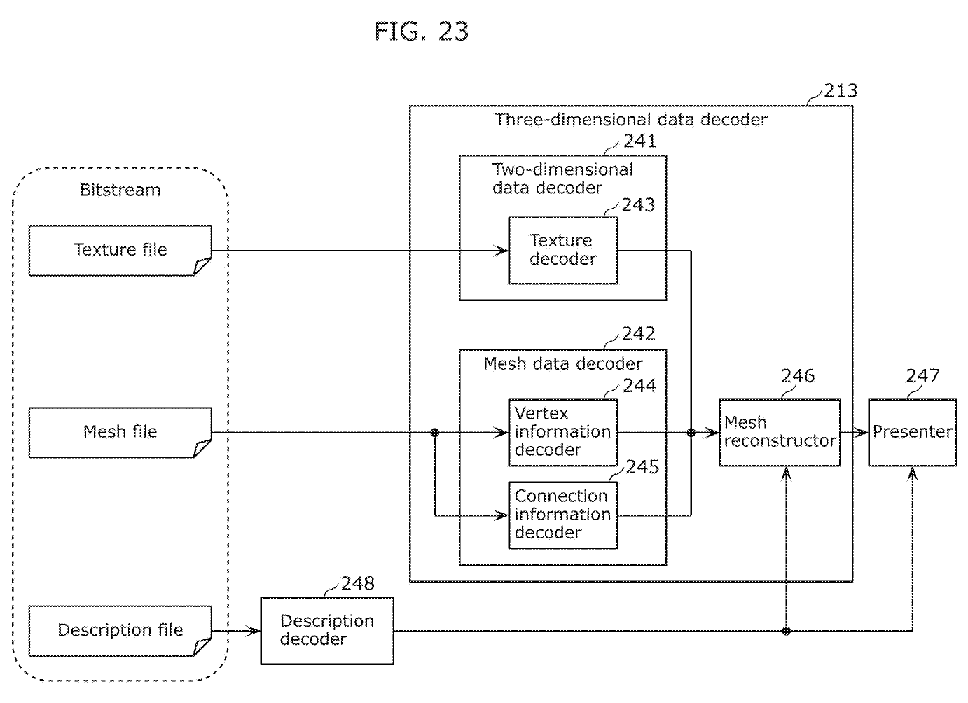

FIG. 23 is a conceptual diagram illustrating a specific example of decoding processing according to the present embodiment. FIG. 23 illustrates three-dimensional data decoder 213, description decoder 248, and presenter 247. In this example, three-dimensional data decoder 213 includes two-dimensional data decoder 241, mesh data decoder 242, and mesh reconstructor 246. Two-dimensional data decoder 241 includes texture decoder 243. Mesh data decoder 242 includes vertex information decoder 244 and connection information decoder 245.

Vertex information decoder 244, connection information decoder 245, texture decoder 243, and mesh reconstructor 246 may correspond to vertex information decoder 201, connection information decoder 202, attribute information decoder 203, postprocessor 205, and the like illustrated in FIG. 8. Presenter 247 may correspond to presenter 215 and the like illustrated in FIG. 12.

For example, two-dimensional data decoder 241 operates as texture decoder 243 and decodes a texture corresponding to attribute information from a texture file as two-dimensional data according to an image encoding system or a video encoding system.

In addition, mesh data decoder 242 operates as vertex information decoder 244 and connection information decoder 245 and decodes vertex information and connection information from a mesh file. Mesh data decoder 242 may further decode mapping information with respect to a texture from the mesh file.

Furthermore, description decoder 248 decodes a description corresponding to metadata such as text data from a description file. Description decoder 248 may decode a description in the system layer. For example, description decoder 248 may be included in system demultiplexer 214 illustrated in FIG. 12.

Mesh reconstructor 246 reconstructs a three-dimensional mesh from vertex information, connection information, and a texture according to a description. Presenter 247 renders and outputs the three-dimensional mesh according to the description.

Due to the operation described above, a three-dimensional mesh is reconstructed and output from a bitstream including a texture file, a mesh file, and a description file.

Note that three-dimensional data decoder 213 may include two mesh data decoders as mesh data decoder 242. For example, one mesh data decoder decodes vertex information and connection information of a static three-dimensional mesh and the other mesh data decoder decodes vertex information and connection information of a dynamic three-dimensional mesh.

In addition, two mesh files may be included in the bitstream so as to correspond to the three-dimensional meshes. For example, one mesh file corresponds to the static three-dimensional mesh and the other mesh file corresponds to the dynamic three-dimensional mesh.

Furthermore, the static three-dimensional mesh may be an intra-frame three-dimensional mesh which is encoded using intra-prediction and the dynamic three-dimensional mesh may be an inter-frame three-dimensional mesh which is encoded using inter-prediction. In addition, as information of the dynamic three-dimensional mesh, difference information between vertex information or connection information of the intra-frame three-dimensional mesh and vertex information or connection information of the inter-frame three-dimensional mesh may be used.

An encoding system of a dynamic three-dimensional mesh may be called DMC (dynamic mesh coding). In addition, a video-based encoding system of a dynamic three-dimensional mesh may be called VDMC (video-based dynamic mesh coding).

An encoding system of a point cloud may be called PCC (point cloud compression). A video-based encoding system of a point cloud may be called V-PCC (video-based point cloud compression). In addition, a geometry-based encoding system of a point cloud may be called G-PCC (geometry-based point cloud compression).

Implementation example

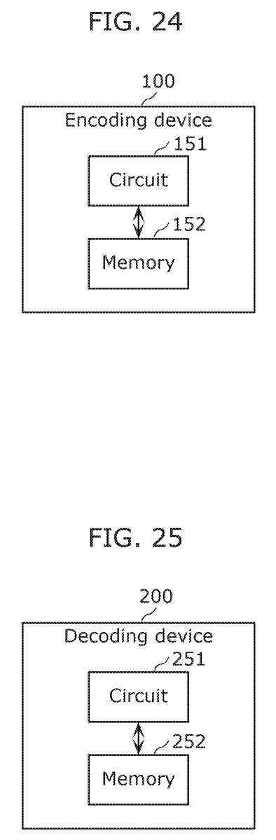

FIG. 24 is a block diagram illustrating an implementation example of encoding device 100 according to the present embodiment. Encoding device 100 includes circuit 151 and memory 152. For example, a plurality of constituent elements of encoding device 100 illustrated in FIG. 5 and the like are implemented by circuit 151 and memory 152 illustrated in FIG. 24.

Circuit 151 is a circuit which performs information processing and which is capable of accessing memory 152. For example, circuit 151 is a dedicated or general-purpose electric circuit which encodes a three-dimensional mesh. Circuit 151 may be a processor such as a CPU. Alternatively, circuit 151 may be a set of a plurality of electric circuits.

Memory 152 is a dedicated or general-purpose memory that stores information used by circuit 151 to encode a three-dimensional mesh. Memory 152 may be an electric circuit and may be connected to circuit 151. In addition, memory 152 may be included in circuit 151. Alternatively, memory 152 may be a set of a plurality of electric circuits. Furthermore, memory 152 may be a magnetic disk, an optical disk, or the like or may be expressed as a storage, a recording medium, or the like. In addition, memory 152 may be a non-volatile memory or a volatile memory.

For example, memory 152 may store a three-dimensional mesh or a bitstream. In addition, memory 152 may store a program used by circuit 151 to encode a three-dimensional mesh.

Note that in encoding device 100, all of the plurality of constituent elements illustrated in FIG. 5 and the like need not be implemented and all of the plurality of processing steps described herein need not be performed. A part of the plurality of constituent elements illustrated in FIG. 5 and the like may be included in another device and a part of the plurality of processing steps described herein may be executed by another device. In addition, a plurality of constituent elements according to the present disclosure may be optionally combined and implemented or a plurality of processing steps according to the present disclosure may be optionally combined and executed in encoding device 100.

FIG. 25 is a block diagram illustrating an implementation example of decoding device 200 according to the present embodiment. Decoding device 200 includes circuit 251 and memory 252. For example, a plurality of constituent elements of decoding device 200 illustrated in FIG. 7 and the like are implemented by circuit 251 and memory 252 illustrated in FIG. 25.

Circuit 251 is a circuit which performs information processing and which is capable of accessing memory 252. For example, circuit 251 is a dedicated or general-purpose electric circuit which decodes a three-dimensional mesh. Circuit 251 may be a processor such as a CPU. Alternatively, circuit 251 may be a set of a plurality of electric circuits.

Memory 252 is a dedicated or general-purpose memory that stores information used by circuit 251 to decode a three-dimensional mesh. Memory 252 may be an electric circuit and may be connected to circuit 251. In addition, memory 252 may be included in circuit 251. Alternatively, memory 252 may be a set of a plurality of electric circuits. Furthermore, memory 252 may be a magnetic disk, an optical disk, or the like or may be expressed as a storage, a recording medium, or the like. In addition, memory 252 may be a non-volatile memory or a volatile memory.

For example, memory 252 may store a three-dimensional mesh or a bitstream. In addition, memory 252 may store a program used by circuit 251 to decode a three-dimensional mesh.

Note that in decoding device 200, all of the plurality of constituent elements illustrated in FIG. 7 and the like need not be implemented and all of the plurality of processing steps described herein need not be performed. A part of the plurality of constituent elements illustrated in FIG. 7 and the like may be included in another device and a part of the plurality of processing steps described herein may be executed by another device. In addition, a plurality of constituent elements according to the present disclosure may be optionally combined and implemented or a plurality of processing steps according to the present disclosure may be optionally combined and executed in decoding device 200.

An encoding method and a decoding method including steps performed by each constituent element of encoding device 100 and decoding device 200 according to the present disclosure may be executed by any device or system. For example, a part of or all of the encoding method and the decoding method may be executed by a computer including a processor, a memory, an input/output circuit, and the like. In doing so, the encoding method and the decoding method may be executed by having the computer execute a program that enables the computer to execute the encoding method and the decoding method.

In addition, a program or a bitstream may be recorded on a non-transitory computer-readable recording medium such as a CD-ROM.

An example of a program may be a bitstream. For example, a bitstream including an encoded three-dimensional mesh includes a syntax element that enables decoding device 200 to decode the three-dimensional mesh. In addition, the bitstream causes decoding device 200 to decode the three-dimensional mesh according to the syntax element included in the bitstream. Therefore, a bitstream can perform a similar role to a program.

The bitstream described above may be an encoded bitstream including an encoded three-dimensional mesh or a multiplexed bitstream including an encoded three-dimensional mesh and other information.

In addition, each constituent element of encoding device 100 and decoding device 200 may be constituted of dedicated hardware, general-purpose hardware which executes the program or the like described above, or a combination thereof. Furthermore, the general-purpose hardware may be constituted of a memory on which a program is recorded, a general-purpose processor which reads the program from the memory and executes the program, and the like. In this case, the memory may be a semiconductor memory, a hard disk, or the like and the general-purpose processor may be a CPU or the like.

Furthermore, the dedicated hardware may be constituted of a memory, a dedicated processor, and the like. For example, the dedicated processor may execute the encoding method and the decoding method by referring to a memory for recording data.

In addition, as described above, the respective constituent elements of encoding device 100 and decoding device 200 may be electric circuits. The electric circuits may constitute one electric circuit as a whole or may be respectively different electric circuits. Furthermore, the electric circuits may correspond to dedicated hardware or to general-purpose hardware which executes the program or the like described above. Moreover, encoding device 100 and decoding device 200 may be implemented as integrated circuits.

In addition, encoding device 100 may be a transmitting device which transmits a three-dimensional mesh. Decoding device 200 may be a receiving device which receives a three-dimensional mesh.

Encoding and decoding of displacement

The following terms will be used here as examples.

(1) Image

An image is a data unit constituted of a set of pixels. An image includes a picture or blocks, which are smaller than a picture. Images include a still image in addition to a moving image.

(2) Picture

A picture is an image processing unit constituted of a set of pixels. A picture will also be referred to as a frame or a field.

(3) Block

A block is a processing unit constituted of a set of a particular number of pixels. For a block, the terms shown as the following examples are also used. The shapes of blocks are not particularly limited. Examples of blocks can include a rectangle shape of M × N pixels or a square shape of M × M pixels. The examples of blocks may also include a triangular shape, a circular shape, and other shapes. Examples of blocks are as follows.

Slice, tile, or brick

CTU, super block, or basic dividing unit

VPDU, processing dividing unit for hardware

CU, processing block unit, prediction block unit (PU), or orthogonal transform block unit (TU)

Sub-block

(4) Pixel or sample

A pixel or a sample is the smallest point of an image, in other words, the smallest unit. Pixels or samples include not only a pixel at an integer position but also a pixel at a sub-pixel position that is generated based on a pixel at an integer position.

(5) Pixel value or sample value

A pixel value or a sample value is an eigen value of a pixel. Pixel values or sample values include a luma value, a chroma value, and an RGB gradation level. Pixel values or sample values can also include a depth value or a binary value of 0 or 1.

(6) Flag

A flag indicates one or more bits. A flag is, for example, a parameter or an index represented by two or more bits. A flag may indicate not only a value represented by a binary number but also a value represented by a numerical value other than a binary number.

(7) Signal

A signal is one that is symbolized or encoded to convey information. Signals include a discrete digital signal and an analog signal that takes a continuous value.

(8) Stream or bitstream

A stream or a bitstream is a digital data string indicating a digital data flow. A stream or a bitstream may be one stream or may be constituted of a plurality of streams having a plurality of hierarchical layers. A stream or a bitstream may be transmitted in serial communication using a single transmission path or may be transmitted in packet communication using a plurality of transmission paths.

(9) Difference

In the case of scalar quantities, a difference can include a simple difference (x - y) and a difference calculation. Differences can include an absolute value of a difference (|x - y|), a squared difference (x^2 - y^2), a square root of a difference (√(x - y)), a weighted difference (ax - by: a and b are constants), or an offset difference (x - y + a: a is an offset).

(10) Sum

In the case of scalar quantities, sums can include a simple sum (x + y) and a sum calculation. Sums include an absolute value of a sum (|x + y|), a squared sum (x^2 + y^2), a square root of a sum (√(x + y)), a weighted sum (ax + by: a and b are constants), and an offset sum (x + y + a: a is an offset).

(11) "Based on"

The phrase "based on something" means that a thing other than the "something" may be taken into consideration. In addition, the term "based on" may be used in a case where a direct result is obtained or a case where a result is obtained through an interim result.

(12) "Used" or "using"

The phrase "something is used" or "using something" means that a thing other than the "something" may be taken into consideration. In addition, the term "used" or "using" may be used in a case where a direct result is obtained or a case where a result is obtained through an interim result.

(13) Prohibit, forbid

The term "prohibit" or "forbid" can be rephrased as "does not permit" or "does not allow." In addition, the phrase "being not prohibited/forbidden" or "being permitted/allowed" does not always mean "obligation."

(14) "Limit", or "restriction/restrict/restricted"

The term "limit" or "restriction/restrict/restricted" can be rephrased as "does not permit/allow" or "being not permitted/allowed." In addition, the phrase "being prohibited/forbidden," "being not prohibited/forbidden," "being not permitted/allowed," or "being permitted/allowed" does not always mean "obligation." Furthermore, part of something may be prohibited/forbidden quantitatively or qualitatively, or something may be fully prohibited/forbidden quantitatively or qualitatively.

(15) Chroma

Chroma is an adjective that is represented by the symbols Cb and Cr, specifying that a sample array or a single sample represents one of two color difference signals related to primary colors. The term chroma may be used instead of the term chrominance.

(16) Luma

Luma is an adjective that is represented by the symbol or subscript Y or L, specifying that a sample array or a single sample represents a monochrome signal related to primary colors. The term luma may be used instead of the term luminance.

Hereinafter, an encoding/decoding system of the present embodiment will be described.

A generic three-dimensional model (also referred to as a 3D model) represents an object digitally such that a user can explorer a model using zooming, panning, and rotation in all three dimensions while rendering it temporally. One way to construct such a representation is to construct a 3D mesh using triangles. The model stores the positions of the vertices of each triangle, connectivity of the vertices of the triangle with each other, and the attributes associated therewith (such as a normal, UV patches, etc.).

Storing all of these types of information in an uncompressed form needs very large storage space, which in turn needs a very large bandwidth for transmission. The triangles forming the mesh often have a repetitive pattern and similar attributes especially in the temporal and spatial neighborhood. The repetition can be used to formulate an efficient encoding and decoding method for storage and transmission. One such encoding and decoding method is Video-based Dynamic Mesh Coding (V-DMC).

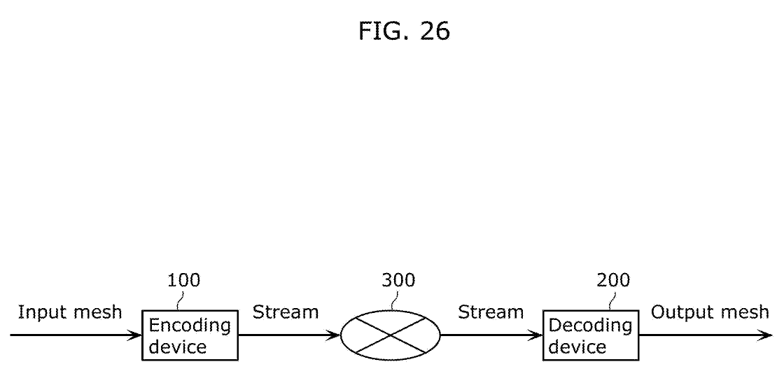

FIG. 26 is a block diagram illustrating another configuration example of the encoding/decoding system according to the present embodiment. As illustrated in FIG. 26, the encoding/decoding system includes encoding device 100 and decoding device 200.

The encoding/decoding system receives a three-dimensional mesh (also referred to as a 3D mesh) that is input in the form of three-dimensional coordinates (vertex information), connectivity (connection information), and associated attributes (attribute information) of vertices. Note that the 3D mesh can include not only geometry but also a texture map.

Encoding device 100 takes in the 3D mesh that has been input (also referred to as an input 3D mesh or an input mesh) in the form of the vertices' three-dimensional coordinates, connectivity, and associated attributes. Encoding device 100 is responsible for encoding all related information into a stream. The stream may include a single bitstream or a plurality of bitstreams.

Network 300 transmits the stream generated by the encoding device to decoding device 200. Network 300 may be the Internet, a wide area network (WAN), a local area network (LAN), or any combination of these networks. Network 300 is not always limited to a bidirectional communication network. Network 300 may be a unidirectional communication network that transmits broadcast waves of digital terrestrial broadcasting, satellite broadcasting, or the like. Alternatively, network 300 may be replaced by a recording medium such as a Digital Versatile Disc (DVD), a Blue-Ray Disc (BD), or the like on which the stream is recorded.

The stream is transmitted to decoding device 200 through network 300. Decoding device 200 decodes the bitstream to produce a three-dimensional mesh using the decoded vertices' three-dimensional coordinates, connectivity, and associated attributes. Decoding device 200 outputs the produced three-dimensional mesh (also referred to as an output 3D mesh or an output mesh).

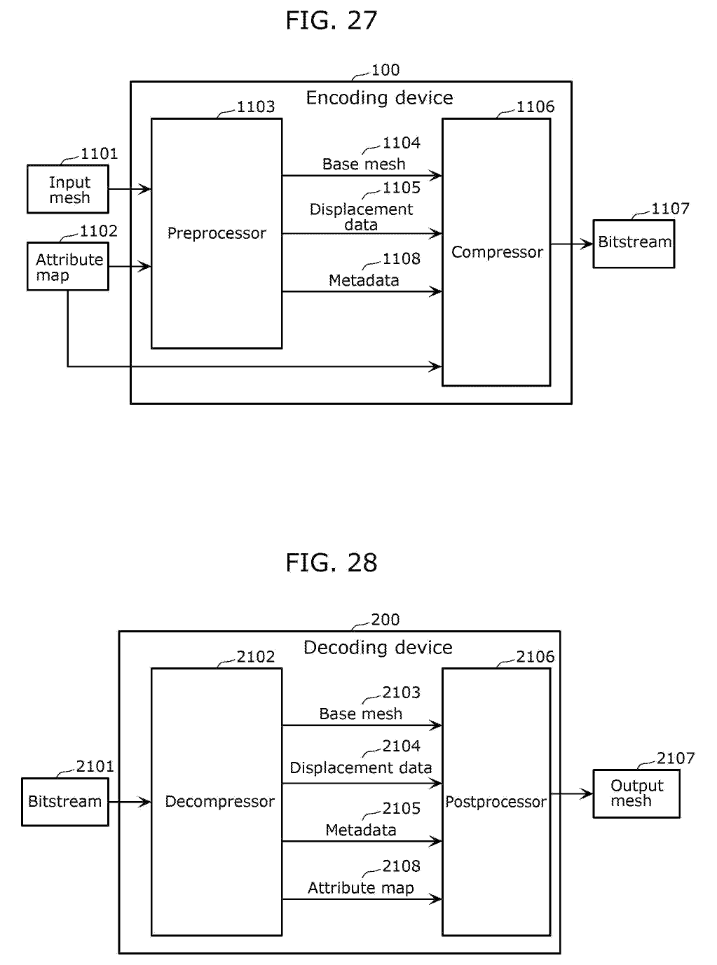

FIG. 27 is a diagram illustrating another configuration example of encoding device 100.

As illustrated in FIG. 27, encoding device 100 includes preprocessor 1103 and compressor 1106.

Encoding device 100 reads input mesh 1101 and attribute map 1102 and passes them to preprocessor 1103. Preprocessor 1103 processes the input mesh to extract base mesh 1104 and displacement data 1105. Attribute map 1102 along with base mesh 1104 and displacement data 1105 having been extracted are passed to compressor 1106.

Compressor 1106 compresses base mesh 1104, displacement data 1105, and attribute map 1102 to generate bitstream 1107. Compressor 1106 can additionally include metadata 1108 in bitstream 1107 to send the supplementary information to decoding device 200.

FIG. 28 is a diagram illustrating another configuration example of decoding device 200.

As illustrated in FIG. 28, decoding device 200 includes decompressor 2102 and postprocessor 2106.

Decoding device 200 reads bitstream 2101 and passes it to decompressor 2102. Decompressor 2102 decompresses base mesh 2103, displacement data 2104, and attribute map 2108 from bitstream 2101 and passes them to postprocessor 2106. One example of displacement data 2104 is displacement vectors.

Postprocessor 2106 processes base mesh 2103 as per displacement data 2104 and attribute map 2108 to produce output mesh 2107. Postprocessor 2106 may additionally use information from metadata 2105 to produce output mesh 2107.

Hereinafter, details of the configuration of encoding device 100 will be described.

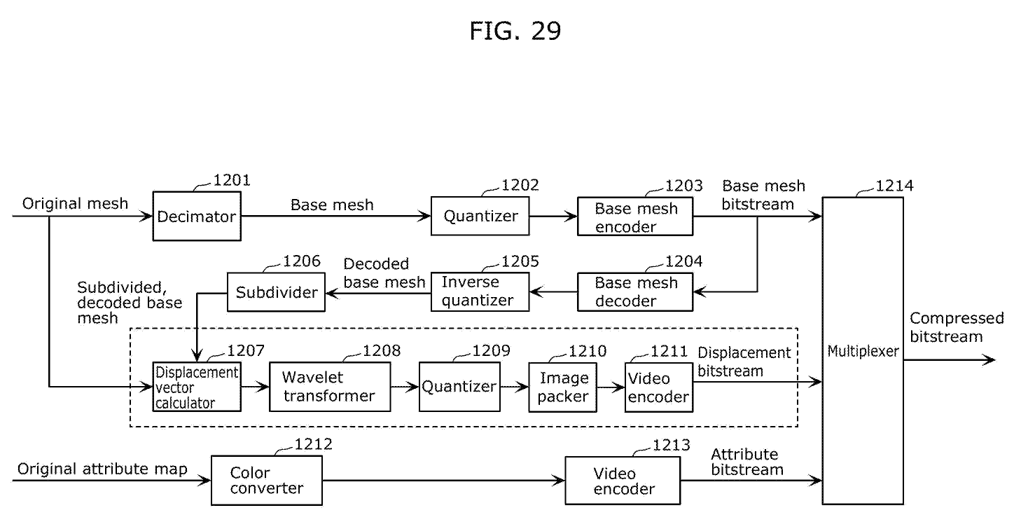

FIG. 29 is a block diagram illustrating a detailed configuration example of encoding device 100.

As illustrated in FIG. 29, encoding device 100 includes decimator 1201, quantizer 1202, base mesh encoder 1203, base mesh decoder 1204, inverse quantizer 1205, subdivider 1206, displacement vector calculator 1207, wavelet transformer 1208, quantizer 1209, image packer 1210, video encoder 1211, color converter 1212, video encoder 1213, and multiplexer 1214.

Decimator 1201 acquires a mesh that is input into encoding device 100 (equivalent to input mesh 1101) as an original mesh and performs a decimating process (in other words, a thinning-out process) on the acquired original mesh to produce a base mesh. The decimating process is a process of deleting (in other words, thinning out) some of vertices included in the original mesh. The decimating process may include a process of changing the positions of at least some of the vertices included in the original mesh or may include a process of changing the connectivity of at least some of the vertices included in the original mesh. The decimating process will also be referred to simply as decimating.

The base mesh produced through the decimating process is a mesh including fewer vertices than the original mesh. The vertices of the base mesh may be positioned differently from the vertices of the original mesh. In addition, the connectivity of the vertices of the base mesh may be different from the connectivity of the vertices of the original mesh. Decimator 1201 provides the produced base mesh to quantizer 1202.

Quantizer 1202 quantizes the base mesh produced by decimator 1201. Quantizer 1202 provides the quantized base mesh to base mesh encoder 1203.

Base mesh encoder 1203 encodes the base mesh quantized by quantizer 1202 into a bitstream (also referred to as a base mesh bitstream) (in other words, generates the base mesh bitstream). Base mesh encoder 1203 provides the base mesh bitstream to base mesh decoder 1204 and multiplexer 1214.

Base mesh decoder 1204 decodes the base mesh bitstream provided from base mesh encoder 1203 to acquire the quantized base mesh. Base mesh decoder 1204 provides the quantized base mesh to inverse quantizer 1205.

Inverse quantizer 1205 inverse quantizes the quantized base mesh provided from base mesh decoder 1204 to produce the base mesh (also referred to as a decoded base mesh). Inverse quantizer 1205 provides the decoded base mesh to subdivider 1206. The processes of quantization and inverse quantization may make the decoded base mesh produced by inverse quantizer 1205 different from the base mesh produced by decimator 1201.

Subdivider 1206 performs a subdivision process on the decoded base mesh produced by inverse quantizer 1205. The subdivision process can be a process of subdividing each face included in the decoded base mesh to segmentalize the face. Subdivider 1206 provides the subdivided, decoded base mesh to displacement vector calculator 1207.

Specifically, subdivider 1206 subdivides a mesh by generating a new vertex between two vertices that are included in the mesh and connected to each other. Repeating the generation of new vertex can increase the number of the vertices included in the mesh to a predetermined number. The iteration of the subdivision over the entire mesh (in other words, the plurality of executions of the subdivision) generates a plurality of levels of detail (LoD) layers.

Displacement vector calculator 1207 acquires the original mesh acquired by encoding device 100 and acquires, from subdivider 1206, the subdivided, decoded base mesh. Displacement vector calculator 1207 calculates vectors from the vertices of the subdivided, decoded base mesh to the vertices, faces, or edges of the original mesh, as displacement vectors. Displacement vector calculator 1207 provides the displacement vectors to wavelet transformer 1208.

Wavelet transformer 1208 performs a wavelet transforming process on the displacement vectors calculated by displacement vector calculator 1207 to acquire wavelet coefficients. Wavelet transformer 1208 provides the wavelet coefficients to quantizer 1209. In the wavelet transformation, wavelet transformer 1208 assigns the vertices to a plurality of LoD layers and applies, for example, the lifting scheme to the displacement vectors of the vertices. Wavelet transformer 1208 can thus calculate wavelet coefficients representing various components from low-frequency components to high-frequency components.

Quantizer 1209 quantizes the wavelet coefficients acquired by wavelet transformer 1208. Quantizer 1209 can quantize the wavelet coefficients for each LoD layer. Quantizer 1209 provides the quantized wavelet coefficients to image packer 1210.

Image packer 1210 generates an image containing the wavelet coefficients quantized by quantizer 1209. Image packer 1210 can generate the image by mapping the wavelet coefficients quantized by quantizer 1209 onto pixels in a two-dimensional image format. Image packer 1210 provides the generated image to video encoder 1211. In the process of mapping the quantized wavelet coefficients onto the pixels in the two-dimensional image format, mapping information that represents the assignment of the quantized wavelet coefficients to the pixels in the two-dimensional image format can be used.

Video encoder 1211 encodes the image generated by image packer 1210 into a bitstream (also referred to as a displacement bitstream) (in other words, generates the displacement bitstream). Video encoder 1211 provides the displacement bitstream to multiplexer 1214. The displacement bitstream can be a bitstream including displacement information in the form of an image. The format of the image can be, for example, a format including two items of chroma information and one item of luma information.

Color converter 1212 acquires an attribute map acquired by encoding device 100 as an original attribute map and performs a color converting process on the original attribute map. The color converting process can include a process of converting a representation form of color or a color space. Color converter 1212 provides the attribute map subjected to the color converting process to video encoder 1213. Note that although here is described the case where the original attribute map is input into color converter 1212 by way of example, the feature map may be converted in accordance with the structure of the decoded mesh in the case where the decoded mesh differs from the original mesh in the number or positions of the vertices.

Video encoder 1213 encodes the attribute map converted by color converter 1212 into a bitstream (also referred to as an attribute bitstream) (in other words, generates the attribute bitstream). Video encoder 1213 provides the attribute bitstream to multiplexer 1214.

Multiplexer 1214 acquires the base mesh bitstream from base mesh encoder 1203, acquires the displacement bitstream from video encoder 1211, acquires the attribute bitstream from video encoder 1213, and multiplexes these bitstreams to generate and output a compressed bitstream. Outputting the compressed bitstream by multiplexer 1214 can be equivalent to outputting of the bitstream by encoding device 100.

Note that the process of encoding the wavelet coefficients into the displacement bitstream, which is executed by image packer 1210 and video encoder 1211, may be performed through an arithmetic encoding process. In addition, encoding device 100 may be configured to be capable of selecting whether the process is to be executed through the process by image packer 1210 and video encoder 1211 (also referred to as a video encoding process) or executed through the arithmetic encoding process. An example of such a configuration will be described below.

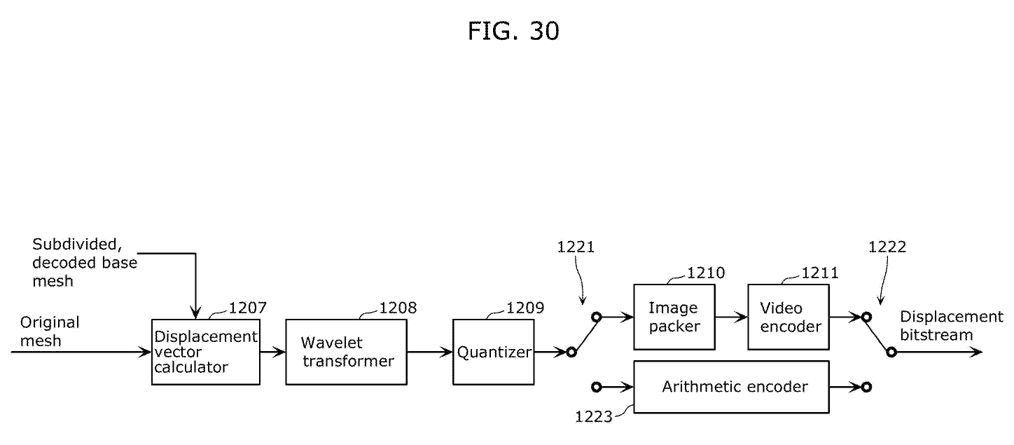

FIG. 30 is a block diagram illustrating a detailed configuration variation of encoding device 100. FIG. 30 illustrates a variation of the functional blocks enclosed by the dotted-line frame illustrated in FIG. 29.

Displacement vector calculator 1207, wavelet transformer 1208, quantizer 1209, image packer 1210, and video encoder 1211 illustrated in FIG. 30 are the same as those illustrated in FIG. 29.

As illustrated in FIG. 30, encoding device 100 further includes switcher 1221, switcher 1222, and arithmetic encoder 1223.

Switcher 1221 and switcher 1222 are switchers that switch whether image packer 1210 and video encoder 1211 or arithmetic encoder 1223 is to execute the process of encoding the wavelet coefficients into the displacement bitstream.

Switcher 1221 and switcher 1222 may dynamically switch a constituent component that is to execute the process to image packer 1210 and video encoder 1211 or arithmetic encoder 1223. Switcher 1221 and switcher 1222 may be configured to always (in other words, fixedly) use image packer 1210 and video encoder 1211 as the constituent component that is to execute the process or may be configured to always (in other words, fixedly) use arithmetic encoder 1223 as the constituent component.

Arithmetic encoder 1223 executes the process of encoding the wavelet coefficients into the displacement bitstream by means of arithmetic encoding.

Note that encoding device 100 may add, to header information, information indicating whether the process of encoding the wavelet coefficients into the displacement bitstream has been executed by image packer 1210 and video encoder 1211 (in other words, the process has been executed through the video encoding process) or by arithmetic encoder 1223 (in other words, the process has been executed through the arithmetic encoding process). This enables decoding device 200 receiving the bitstream encoded in the above manner to appropriately decode the bitstream by switching decoding methods of decoding the bitstream with reference to the header information.

Hereinafter, an encoding process performed by encoding device 100 will be described in detail.

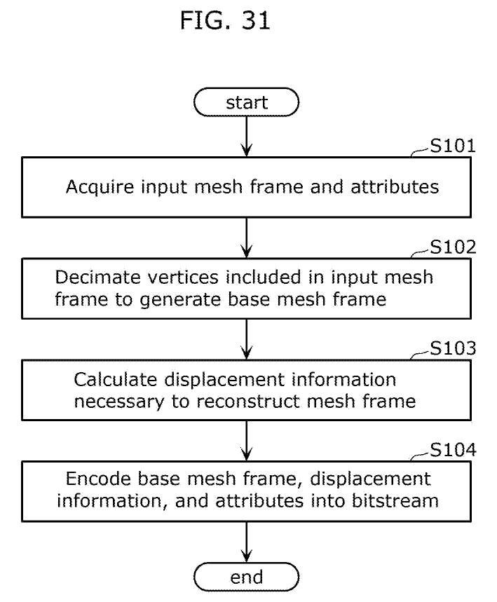

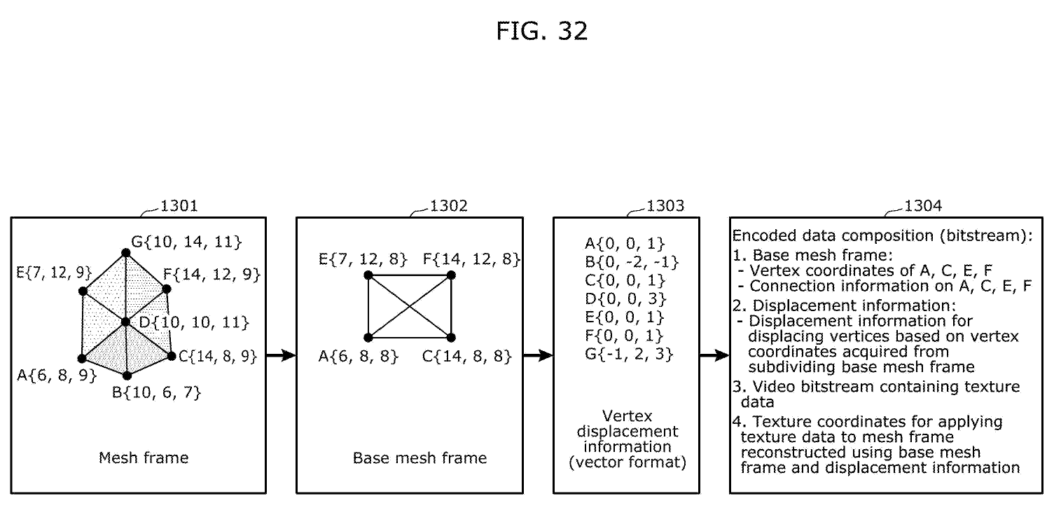

FIG. 31 is a flowchart illustrating the process by encoding device 100. FIG. 32 is an explanatory diagram schematically illustrating the encoding of a mesh frame. With reference to FIG. 31 and FIG. 32, the process by encoding device 100 will be described.

In step S101, encoding device 100 reads a 3D mesh frame, which is an input mesh frame, and its attributes. The input mesh frame is a mesh frame input into encoding device 100. An example of the 3D mesh frame being the input mesh frame is illustrated as mesh frame 1301 (see FIG. 32).

In step S102, encoding device 100 performs the decimating process on the input mesh frame that is read in step S101 to produce a base mesh frame, which has a smaller number of vertices than the input mesh frame. The base mesh frame produced by decimating mesh frame 1301 is illustrated as base mesh frame 1302 (see FIG. 32).

In step S103, encoding device 100 calculates displacement information to be used by decoding device 200 to reconstruct the mesh frame. The displacement information is equivalent to displacement vectors from the vertices of the base mesh frame produced in step S102 to the vertices of the input mesh frame. Methods of calculating the displacement information include a method in which the sets of coordinates of the vertices of the base mesh frame are subtracted from the coordinates of the vertices of the input mesh frame. The displacement information calculated from mesh frame 1301 and base mesh frame 1302 is illustrated as displacement information 1303 (see FIG. 32). Displacement information 1303 is in a vector format. In other words, displacement information 1303 is represented as displacement vectors.

In step S104, encoding device 100 encodes the base mesh frame produced in step S102, the displacement information generated in step S103, and the attributes of the input mesh frame into a bitstream (equivalent to a compressed bitstream). An example of the bitstream is illustrated as bitstream 1304 (see FIG. 32).

Specifically, bitstream 1304 includes sets of vertex coordinates of and connection information on vertices A, C, E, and F, the displacement information, a video bitstream including texture data, and a compressed attribute map (see FIG. 32). The displacement information includes displacement information for displacing vertices based on the vertex coordinates acquired from the base mesh frame that has been subdivided. The compressed attribute map includes texture coordinates used to apply the texture data to the mesh frame that is reconstructed using the base mesh frame and the displacement information.

Hereinafter, details of the configuration of decoding device 200 will be described.

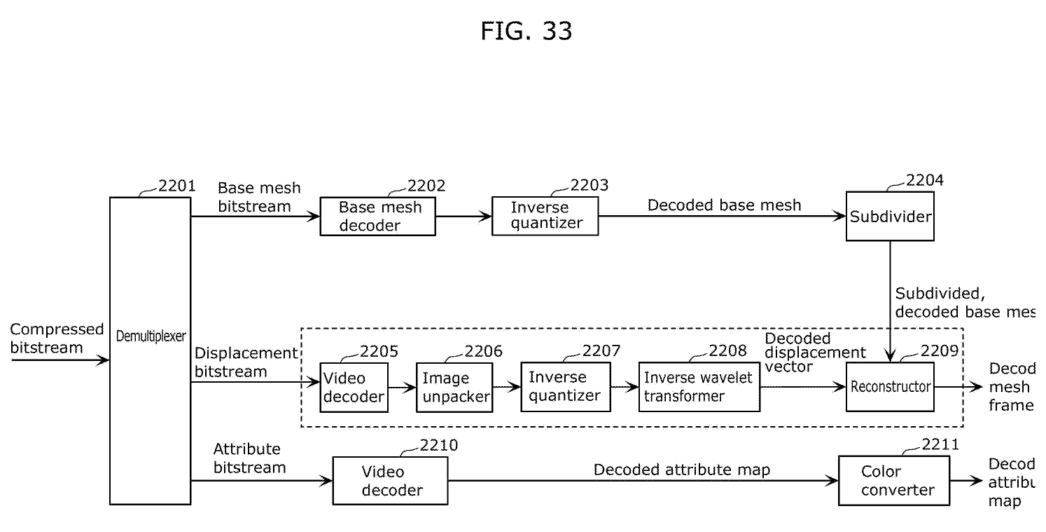

FIG. 33 is a block diagram illustrating a detailed configuration example of decoding device 200.

As illustrated in FIG. 33, decoding device 200 includes demultiplexer 2201, base mesh decoder 2202, inverse quantizer 2203, subdivider 2204, video decoder 2205, image unpacker 2206, inverse quantizer 2207, inverse wavelet transformer 2208, reconstructor 2209, video decoder 2210, and color converter 2211.

Demultiplexer 2201 acquires a compressed bitstream input into decoding device 200 and separates a base mesh bitstream, a displacement bitstream, and an attribute bitstream from the compressed bitstream. Demultiplexer 2201 provides the base mesh bitstream to base mesh decoder 2202, provides the displacement bitstream to video decoder 2205, and provides the attribute bitstream to video decoder 2210. The compressed bitstream input into decoding device 200 can be, for example, a compressed bitstream output by encoding device 100. The description will be made on this case as an example.

Base mesh decoder 2202 decodes the base mesh bitstream provided from demultiplexer 2201 to acquire a quantized base mesh. Base mesh decoder 2202 provides the quantized base mesh to inverse quantizer 2203.

Inverse quantizer 2203 inverse quantizes the quantized base mesh provided from base mesh decoder 2202 to produce the base mesh (also referred to as a decoded base mesh). Inverse quantizer 2203 provides the decoded base mesh to subdivider 2204.

Subdivider 2204 performs the subdivision process on the decoded base mesh produced by inverse quantizer 2203. The subdivision process is the same as the subdivision process executed by subdivider 1206. Subdivider 2204 provides the subdivided, decoded base mesh to reconstructor 2209.

Video decoder 2205 decodes displacement bitstream provided from demultiplexer 2201 into an image. The image can be an image in which quantized wavelet coefficients are contained by the mapping of the quantized wavelet coefficients onto pixels in a two-dimensional image format. Video decoder 2205 provides the image to image unpacker 2206.

Image unpacker 2206 takes out the quantized wavelet coefficients from the image provided from video decoder 2205. In the process of taking out the quantized wavelet coefficients from the image, a mapping that represents the assignment of the quantized wavelet coefficients to the pixels in the two-dimensional image format can be used. Image unpacker 2206 provides the quantized wavelet coefficients taken out from the image to inverse quantizer 2207.

Inverse quantizer 2207 inverse quantizes the quantized wavelet coefficients provided from image unpacker 2206 to generate wavelet coefficients.

Inverse wavelet transformer 2208 performs an inverse wavelet transforming process on the wavelet coefficients provided from inverse quantizer 2207 to generate displacement vectors (equivalent to decoded displacement vectors). The inverse wavelet transforming process is equivalent to the inverse transform of the wavelet transforming process performed by wavelet transformer 1208. Inverse wavelet transformer 2208 provides the generated decoded displacement vectors to reconstructor 2209.

Reconstructor 2209 reconstructs a mesh (equivalent to a decoded mesh frame) using the subdivided, decoded base mesh provided from subdivider 2204 and the decoded displacement vectors provided from inverse wavelet transformer 2208. Reconstructor 2209 outputs the reconstructed, decoded mesh as output mesh 2107.

Video decoder 2210 decodes the attribute bitstream provided from demultiplexer 2201 into an attribute map (equivalent to a decoded attribute map). Video decoder 2210 provides the decoded attribute map to color converter 2211.

Color converter 2211 performs a color converting process on the decoded attribute map provided from video decoder 2210. The color converting process is equivalent to the inverse conversion of the color converting process executed by color converter 1212 and can include a process of converting a representation form of color or a color space. Color converter 2211 outputs the decoded attribute map subjected to the color converting process.

Note that the process of decoding the displacement bitstream into the wavelet coefficients, which is executed by video decoder 2205 and image unpacker 2206, may be performed through an arithmetic encoding process. In addition, decoding device 200 may be configured to be capable of selecting whether the process is to be executed through the process by video decoder 2205 and image unpacker 2206 (also referred to as a video decoding process) or executed through the arithmetic encoding process. An example of such a configuration will be described below.

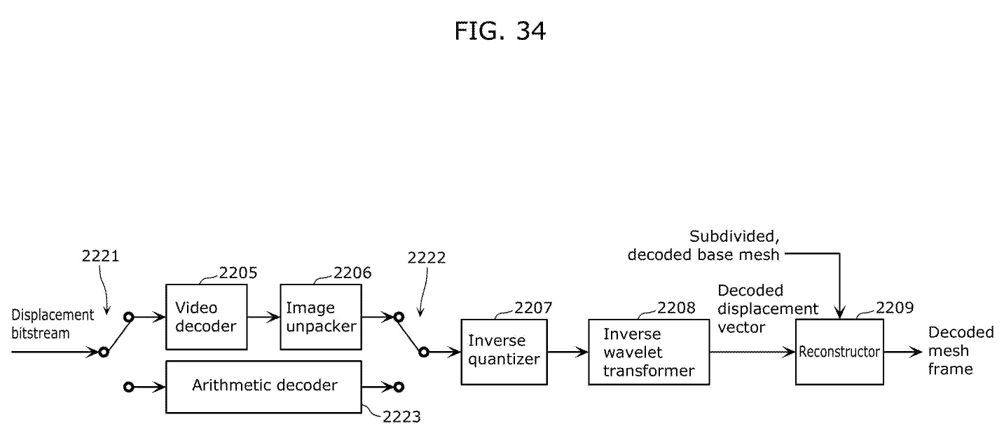

FIG. 34 is a block diagram illustrating a detailed configuration variation of decoding device 200. FIG. 34 illustrates a variation of the functional blocks enclosed by the dotted-line frame illustrated in FIG. 33.

Video decoder 2205, image unpacker 2206, inverse quantizer 2207, inverse wavelet transformer 2208, and reconstructor 2209 illustrated in FIG. 34 are the same as those illustrated in FIG. 33.

As illustrated in FIG. 34, decoding device 200 further includes switcher 2221, switcher 2222, and arithmetic decoder 2223.

Switcher 2221 and switcher 2222 are switchers that switch whether video decoder 2205 and image unpacker 2206 or arithmetic decoder 2223 is to execute the process of decoding the displacement bitstream into the wavelet coefficients.

Switcher 2221 and switcher 2222 may dynamically switch a constituent component that is to execute the process to video decoder 2205 and image unpacker 2206 or arithmetic decoder 2223. Switcher 2221 and switcher 2222 may be configured to always (in other words, fixedly) use video decoder 2205 and image unpacker 2206 as the constituent component that is to execute the process or may be configured to always (in other words, fixedly) use arithmetic decoder 2223 as the constituent component.

Arithmetic decoder 2223 executes the process of decoding the displacement bitstream into the wavelet coefficients by means of arithmetic decoding.

Note that information indicating whether video decoder 2205 and image unpacker 2206 or arithmetic decoder 2223 has executed the process of decoding the displacement bitstream into the wavelet coefficients (in other words, whether the process has been executed through the video decoding process or the arithmetic decoding process) may have been added to header information. In this case, decoding device 200 can appropriately decode the bitstream by switching the decoding methods of decoding the bitstream with reference to the header information.

Hereinafter, a decoding process performed by decoding device 200 will be described in detail.

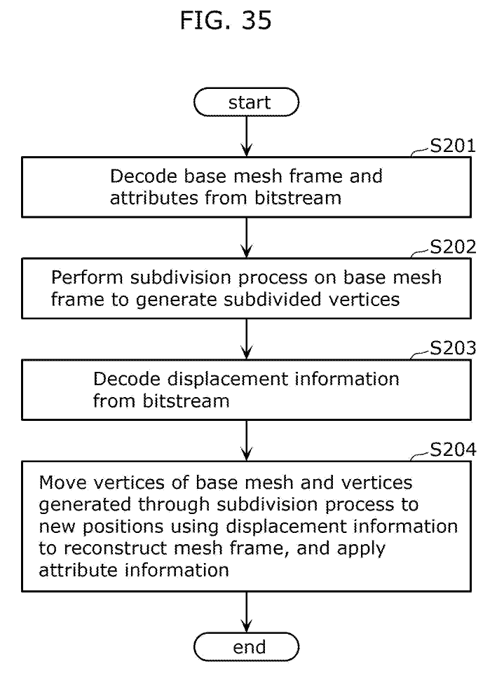

FIG. 35 is a flowchart illustrating the process by decoding device 200. FIG. 36 is an explanatory diagram schematically illustrating the decoding of a mesh frame (3D mesh). With reference to FIG. 35 and FIG. 36, the process by decoding device 200 will be described.

In step S201, decoding device 200 decodes a base mesh frame and attributes from a bitstream (equivalent to a compressed bitstream). An example of the decoded base mesh frame (equivalent to a decoded base mesh frame) is illustrated as decoded base mesh frame 2301 (see FIG. 36).

In step S202, decoding device 200 performs the subdivision process on the base mesh frame decoded in step S201 to produce subdivided vertices. An example of the base mesh frame (mesh frame) including the subdivided vertices is illustrated as base mesh frame 2302 (see FIG. 36).

In step S203, decoding device 200 decodes displacement information from the bitstream (equivalent to the compressed bitstream). An example of the decoded displacement information is illustrated as displacement information 2303 (see FIG. 36). Displacement information 2303 is in a vector format. In other words, displacement information 2303 is represented as displacement vectors.

In step S204, using the displacement information, decoding device 200 moves the vertices of the base mesh frame including the subdivided vertices to new positions to reconstruct the shape of the mesh frame and further applies attribute information to restore the mesh frame. An example of the attributes is texture. An example of the reconstructed mesh frame is illustrated as mesh frame 2304 (see FIG. 36).

Hereinafter, the subdivision will be described. The subdivision is executed by a subdivider (specifically, subdivider 1206 or subdivider 2204).

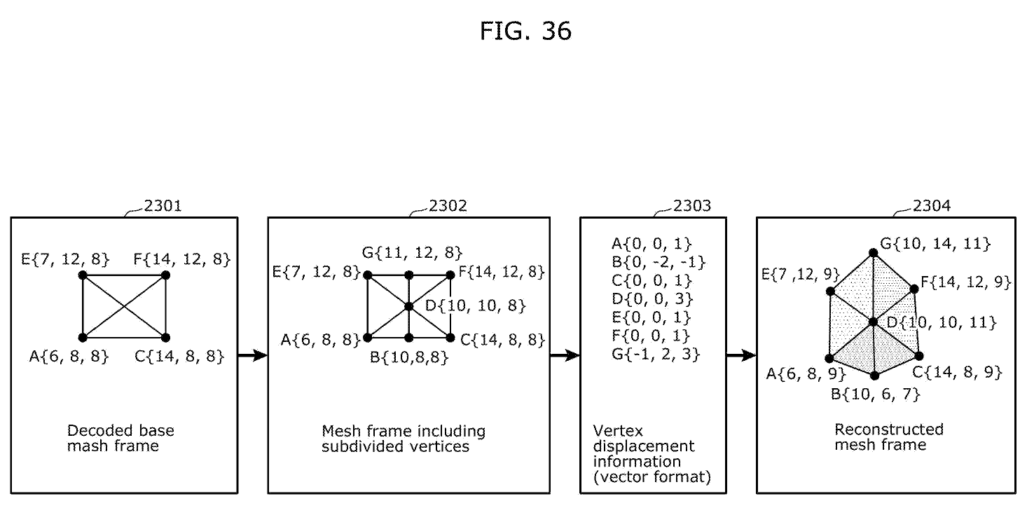

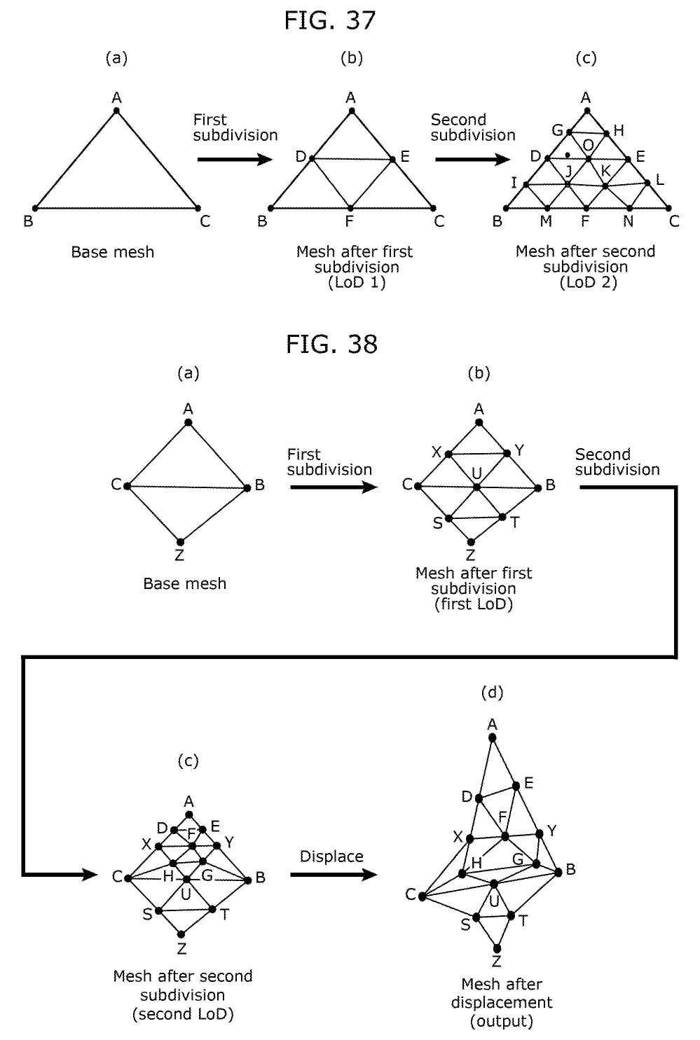

FIG. 37 is an explanatory diagram illustrating an example of the subdivision.

A base mesh illustrated in (a) in FIG. 37 includes vertices A, B, and C and connection information indicating their connectivity.

In (b) in FIG. 37, a mesh produced by the first subdivision, in other words, a mesh after the first subdivision is illustrated. In the first subdivision, the subdivider generates vertices D, E, and F and connection information indicating their connectivity. This mesh produced by the subdivider will also be referred to as LoD1 or a first LoD.

Vertex D in the mesh after the first subdivision is a vertex that is generated by subdivision based on vertex A and vertex B. Likewise, vertex F is a vertex that is generated by subdivision based on vertex B and vertex C. Vertex E is a vertex that is generated by subdivision based on vertex A and vertex C.

Note that, as an example, vertex D can be the midpoint of segment AB (in other words, edge AB) connecting vertices A and B, which are used to generate vertex D. Likewise, vertex E can be the midpoint of segment AC. Vertex F can be the midpoint of segment BC.

In (c) in FIG. 37, a mesh produced by the second subdivision, in other words, a mesh after the second subdivision is illustrated. In the second subdivision, the subdivider generates vertices G, H, I, J, K, L, M, N, and O and connection information indicating their connectivity. This mesh produced by the subdivider will also be referred to as LoD2 or a second LoD.

Vertex G in the mesh after the second subdivision is a vertex that is generated by subdivision based on vertex A and vertex D. Likewise, vertex H is a vertex that is generated by subdivision based on vertex A and vertex E. Vertex I is a vertex that is generated by subdivision based on vertex B and vertex D. Vertex J is a vertex that is generated by subdivision based on vertex D and vertex F. Vertex K is a vertex that is generated by subdivision based on vertex E and vertex F. Vertex L is a vertex that is generated by subdivision based on vertex C and vertex E. Vertex M is a vertex that is generated by subdivision based on vertex B and vertex F. Vertex N is a vertex that is generated by subdivision based on vertex C and vertex F. Vertex O is a vertex that is generated by subdivision based on vertex D and vertex E.

Note that, as an example, vertex G can be the midpoint of segment AD (in other words, edge AD) connecting vertices A and D, which are used to generate vertex G. Likewise, vertex H can be the midpoint of segment AE. Vertex I can be the midpoint of segment BD. Vertex J can be the midpoint of segment DF. Vertex K can be the midpoint of segment EF. Vertex L can be the midpoint of segment CE. Vertex M can be the midpoint of segment BF. Vertex N can be the midpoint of segment CF. Vertex O can be the midpoint of segment DE.

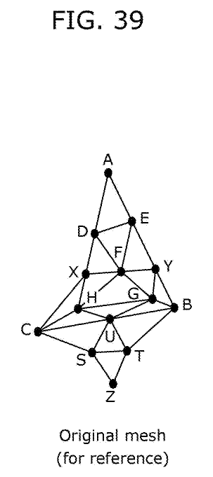

Hereinafter, the displacement of vertices will be described with reference to FIG. 38 and FIG. 39. The displacement of vertices is executed by reconstructor 2209.

FIG. 38 is an explanatory diagram illustrating an example of the displacement of vertices in which the vertices are subdivided and then displaced. FIG. 39 is an explanatory diagram illustrating an example of the vertices of the original mesh.

A base mesh illustrated in (a) in FIG. 38 includes vertices A, B, C, and Z and connection information indicating their connectivity.

In (b) in FIG. 38, a mesh produced by the first subdivision, in other words, a mesh after the first subdivision (i.e., a first LoD) is illustrated. In the first subdivision, the subdivider generates vertex S, T, U, X, or Y and connection information indicating their connectivity. Vertex S, T, U, X, or Y is similar to vertices D, E, and F illustrated in (b) in FIG. 37.

In (c) in FIG. 38, a mesh produced by the second subdivision, in other words, a mesh after the second subdivision (i.e., a second LoD) is illustrated. In the second subdivision, the subdivider generates vertices D, E, F, G, and H and connection information indicating their connectivity. Vertices D, E, F, G, and H are similar to vertices G, H, I, J, K, L, M, N, or O illustrated in (c) in FIG. 37.

In (d) in FIG. 38, a mesh including vertices that are subdivided and then displaced is illustrated. Vertices A, B, C, D, E, F, G, H, S, T, U, X, Y, and Z illustrated in (d) in FIG. 38 are at positions that are displaced from positions of the respective vertices illustrated in (c) in FIG. 38 using the displacement information.

The original mesh illustrated in FIG. 39 is an example of the mesh input into encoding device 100, that is, a mesh before encoding.

The mesh illustrated in FIG. 38 has a shape similar to that of the original mesh illustrated in FIG. 39. Since the displacement information is generated by displacement vector calculator 1207 of encoding device 100 as information indicating the displacement from the vertices of the base mesh to the vertices of the original mesh, the mesh having the shape similar to that of the original mesh is generated by the reconstruction of the mesh using the displacement information that has been generated in such a manner.

Decoding device 200 is capable of outputting the mesh illustrated in (d) in FIG. 38.

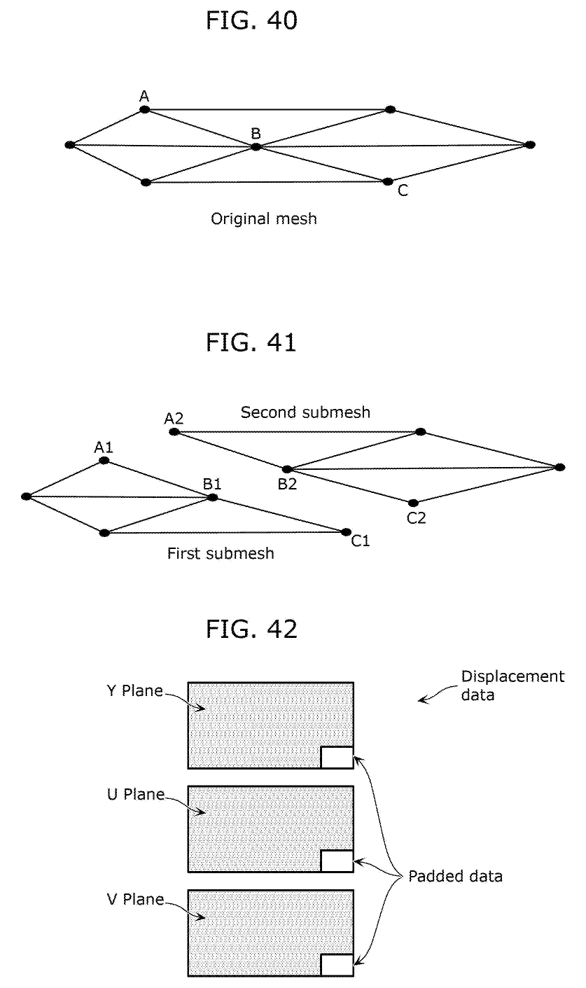

Next, the division of a mesh into submeshes will be described with reference to FIG. 40 and FIG. 41.

The mesh can be divided into a plurality of portions each of which is smaller than the mesh and can be encoded. When the mesh is divided, the vertices of the mesh can be divided such that sets of coordinates and connectivity of the vertices included in each portion are independently encodable.

FIG. 40 is an explanatory diagram illustrating an example of a mesh. FIG. 41 is an explanatory diagram illustrating an example of the division of a mesh into submeshes.

The mesh illustrated in FIG. 40 is an original mesh and may also be referred to as a full mesh, in contrast to a submesh.

FIG. 41 illustrates how the full mesh illustrated in FIG. 40 is divided into two submeshes. For vertices A, B, and C of the full mesh (see FIG. 40), vertex A is duplicated into vertex A1 and vertex A2, vertex B is duplicated into vertex B1 and vertex B2, and vertex C is duplicated into vertex C1 and vertex C2. Thus, the two submeshes (i.e., a first submesh and a second submesh) are created from the full mesh. The first submesh and the second submesh are meshes that are independently decodable.

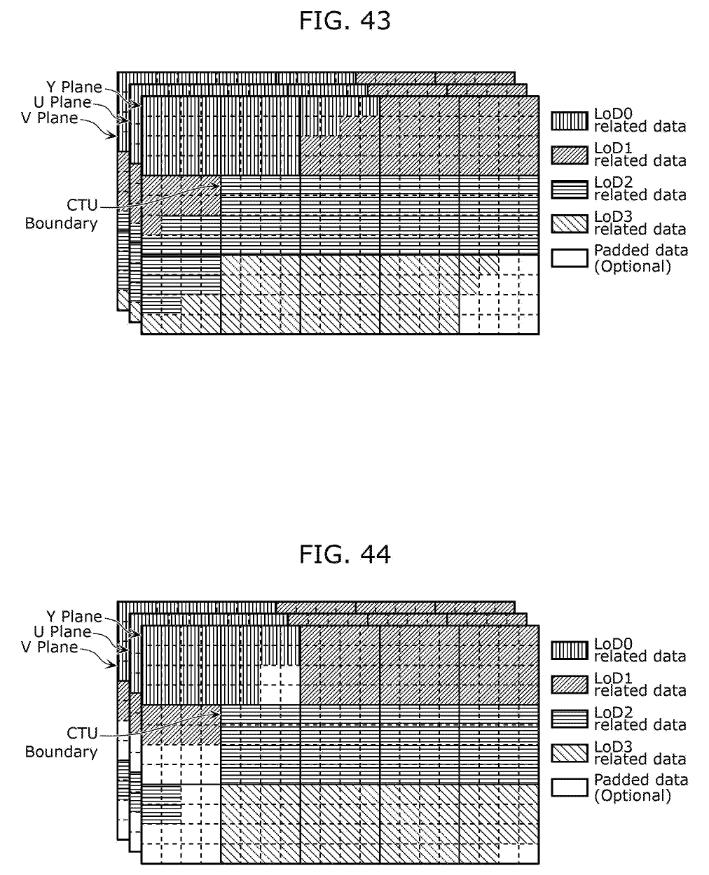

Hereinafter, the packing of displacement information into an image frame will be described with reference to FIG. 42, FIG. 43, and FIG. 44.

FIG. 42, FIG. 43, and FIG. 44 are explanatory diagrams illustrating examples of packing the displacement information into an image frame. Note that the image frame can be rephrased as a video frame.

Items of displacement data on vertices are mapped into, for example, components of an image frame in a YUV format (i.e., into Y components (Y Plane), U components (U Plane), and V components (V Plane)), thus being encoded as image frame data. This case will be described below as an example. Note that, as another example, the items of displacement data on vertices may be mapped into components of an image frame in an RGB format (R components, G components, and B components), thus being encoded as the image frame data.

Decoding device 200 can use an image encoding module to extract the items of displacement data. Each of the items of displacement data may be in the form of an X component, a Y component, or a Z component in a global coordinate system (e.g., a Cartesian coordinate system) or a normal, a tangent, or a bi-tangent component in a local coordinate system. Methods of mapping the displacement data into the image frame include the following methods.

For example, in a first method, the items of displacement data are arranged in a traversing order in the image frame. An example of the packing of the items of displacement data in this case is illustrated in FIG. 42. The items of displacement data are directly mapped onto the image frame according to a predefined traversing order.

Note that the image frame has a fixed height and width, and thus there are cases where the items of displacement data do not fit exactly in the frame. In such a case, the remaining part of the image frame is padded with data for padding (also referred to as Padded data) (see FIG. 42).

For example, in a second method, the items of displacement data are separated into a plurality of LoDs and mapped into the Y components, U components, and V components of the image frame. An example of the packing of the items of displacement data in this case is illustrated in FIG. 43. Here, the items of displacement data in the image frame for the next LoD start immediately after the items of displacement data for the previous LoD end. As in the first method, in the case where the items of displacement data do not exactly fit in the image frame, the image frame is padded at its end portion (see FIG. 43).

For example, in a third method, the items of displacement data corresponding to the LoDs are mapped onto the Y components, U components, and V components of the image frame in a manner different from the second method. An example of the packing of the items of displacement data in this case is illustrated in FIG. 44. In this manner, each LoD can be independently decoded. In the third method, interim padding is performed for each LoD's displacement data to provide CTU alignment together with the padding at the end of the video frame (see FIG. 44).

Next, encoding device 100 and decoding device 200 in the case where a mesh is divided into a plurality of submeshes will be described.

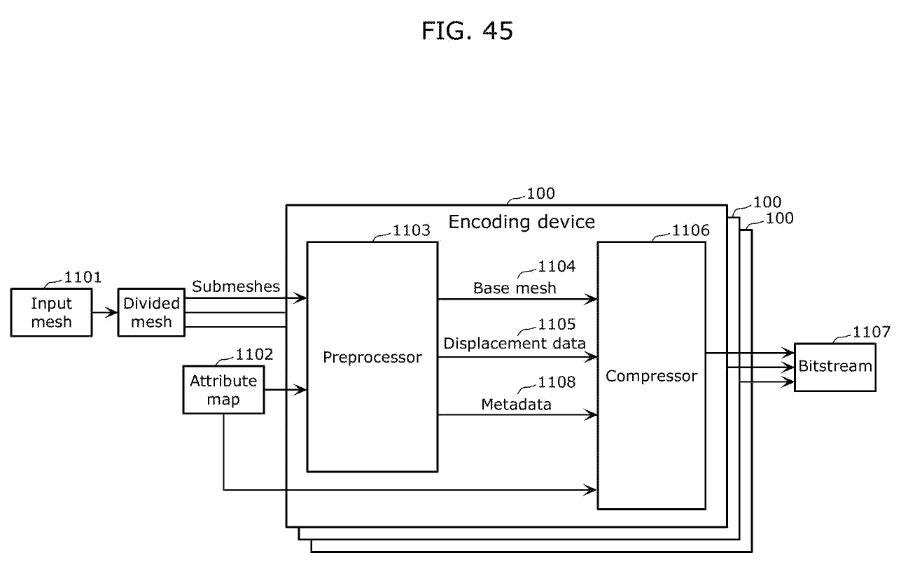

FIG. 45 is a diagram illustrating another configuration example of encoding device 100 according to the embodiment. Specifically, FIG. 45 is a diagram illustrating a configuration of a submesh encoding device that performs an encoding process in the case where input mesh 1101 is divided into divided meshes (a plurality of submeshes). For example, the submesh encoding device includes a plurality of encoding devices 100.

Input mesh 1101 (full mesh) inputted to the submesh encoding device is divided into a plurality of meshes (submeshes). For example, the plurality of submeshes are inputted to a plurality of encoding devices 100. Each of the plurality of submeshes may be inputted to any one of the plurality of encoding devices 100. For example, the submesh encoding device divides input mesh 1101 into a plurality of submeshes, and input the plurality of submeshes obtained by division to a plurality of encoding device 100.

Moreover, after dividing into the plurality of submeshes, an encoding process regarding a submesh boundary (process for an overlapping submesh) is performed.

For example, for each of the submeshes, preprocessing is performed by preprocessor 1103, and a base mesh, displacement data, and metadata are generated and encoded.

It is to be noted that encoding device 100 may be implemented by configuring such a submesh encoding device. In other words, encoding device 100 may be configured to include a plurality of preprocessors 1103 and a plurality of compressors 1106. For each of the sets of preprocessors 1103 and compressors 1106, a predetermined process may be performed on a submesh. Moreover, the total number of sets of preprocessors 1103 and compressors 1106 included in encoding device 100 may be any number of sets, and is not particularly limited.

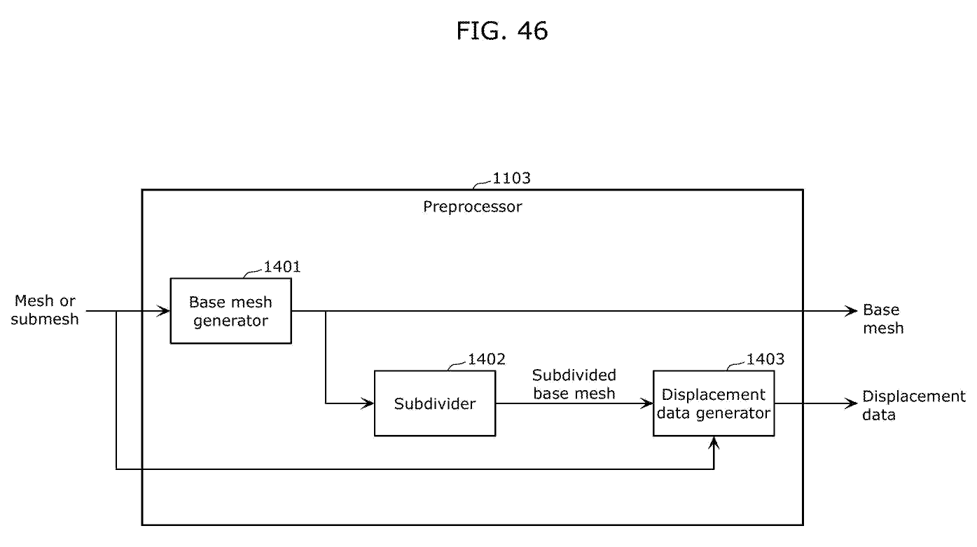

FIG. 46 is a block diagram illustrating a configuration example of preprocessor 1103 according to the embodiment.

Preprocessor 1103 includes, for example, base mesh generator 1401, subdivider 1402, and displacement data generator 1403.

First, in preprocessor 1103, a base mesh is generated by base mesh generator 1401.

Next, the base mesh is subdivided by subdivider 1402 in a predetermined manner, and a subdivided mesh that is the base mesh subdivided (a subdivided mesh or a subdivided base mesh) is generated.

Displacement data is generated by displacement data generator 1403 from the subdivided mesh and a submesh that is obtained by dividing input mesh 1101.

For example, the displacement data is a difference vector between input mesh 1101 and the subdivided mesh.

It is to be noted that, also in decoding, the same subdivision method as that of encoding is used.

Moreover, for example, a subdivision method in encoding and parameters for use in the subdivision may be transmitted from encoding device 100 to decoding device 200.

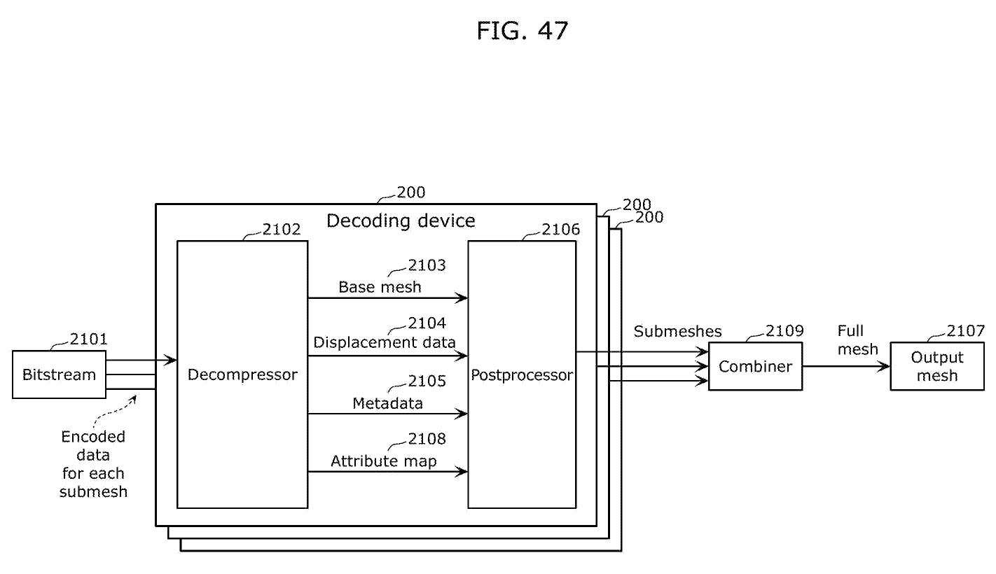

FIG. 47 is a diagram illustrating another configuration example of decoding device 200 according to the embodiment. Specifically, FIG. 47 is a diagram illustrating a configuration of a submesh decoding device that performs a decoding process in the case where a plurality of submeshes are included in bitstream 2101. For example, the submesh decoding device includes a plurality of decoding devices 200. For example, the submesh decoding device includes a plurality of decoding devices 200 and combiner 2109.

Encoded data for each of the submeshes included in bitstream 2101 is inputted to decompressor 2102 of each decoding device 200.

Moreover, for example, in postprocessor 2106, the processing of above-mentioned reconstructor 2209 is performed.

In postprocessor 2106, for each of the decoded submeshes, a base mesh is subdivided, and a displacement vector is added to the subdivided base mesh to restore the submesh.

In other words, postprocessor 2106 performs the processing of above-mentioned reconstructor 2209 for each of the submeshes.

Combiner 2109 combines (merges) the submeshes restored in a plurality of decoding devices 200, and reconstructs a full mesh before division (output mesh 2107).

It is to be noted that decoding device 200 may be implemented by configuring such a submesh decoding device. In other words, decoding device 200 may be configured to include a plurality of decompressors 2102 and a plurality of postprocessors 2106. For each of the sets of decompressors 2102 and postprocessors 2106, a predetermined process may be performed on the encoded data for each submesh. Moreover, the total number of sets of decompressors 2102 and postprocessors 2106 included in decoding device 200 may be any number of sets, and is not particularly limited.

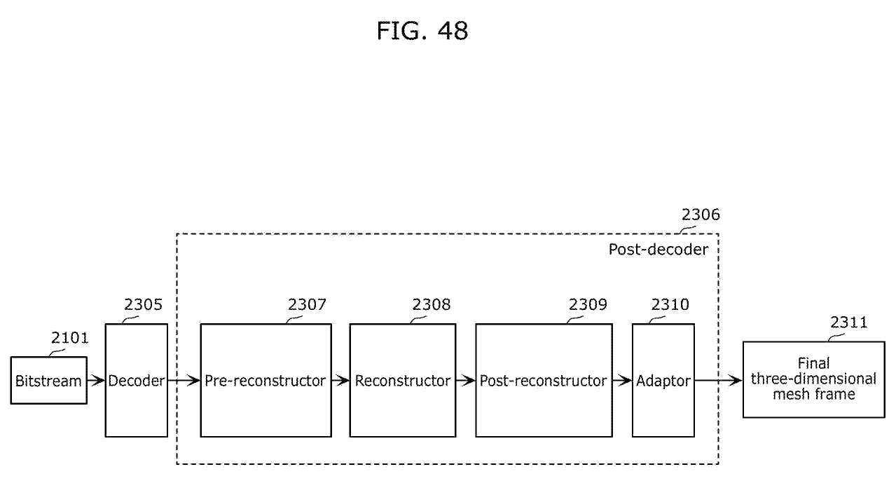

FIG. 48 is a block diagram illustrating a specific configuration example of decoding device 200 according to the embodiment. Specifically, FIG. 48 illustrates a specific configuration of post-decoder 2306 out of decoder 2305 and post-decoder 2306 included in decoding device 200.

Post-decoder 2306 includes pre-reconstructor 2307, reconstructor 2308, post-reconstructor 2309, and adaptor 2310.

The process in post-decoder 2306 is optional for an application. An example of the process in post-decoder 2306 (post-decoding process) is conversion of decoded data into a nominal format, such as video conversion from the YUV space to the RGB space. The post-decoding process may encapsulate a plurality of processes such as a pre-reconstruction process, a reconstruction process, a post-reconstruction process, and an adaptation process.

Pre-reconstructor 2307 performs the pre-reconstruction process. For example, in the context of vide-based dynamic mesh coding, pre-reconstructor 2307 scales normalized texture coordinates up in order to align with the dimensions of a texture image.

Reconstructor 2308 performs the reconstruction process. For example, the reconstruction process is invoked for decoded atlas frames, decoded base mesh frames, decoded video frames, and syntax elements associated with the same mesh sequence. Output of the reconstruction process is a sequence of reconstructed mesh frames before the post-reconstruction process.

Post-reconstructor 2309 performs the post-reconstruction process. For example, in the context of video-based dynamic mesh coding, post-reconstructor 2309 performs a number of smoothing operations on the reconstructed mesh frames. The smoothing operations include, for example, collapsing edges included in a mesh or adding new vertices to a mesh.

Adaptor 2310 performs an adaptation process. For example, the adaptation process is applied by some kind of application in order to adapt reconstructed meshes to a given scenario. For example, vertices of the reconstructed mesh are transformed from a three-dimensional model coordinate system to a three-dimensional world coordinate system. Adaptor 2310 outputs a reconstructed final mesh frame (final three-dimensional mesh frame 2311).

Hereinafter, in a case where submeshes overlap, a method performed in decoding device 200 for detecting an overlapping vertex between the submeshes or an overlapping edge, which connects an overlapping vertex and an other overlapping vertex, between the submeshes, and a method performed by encoding device 100 for generating and transmitting metadata (a parameter for each pair of boundary vertices described later) for detecting an overlapping vertex or an overlapping edge will be described.

It should be noted that the overlapping edge and the overlapping vertex may also be referred to as a boundary edge and a boundary vertex, respectively.

Hereinafter, in order to optimize the size and decoding complexity of a bitstream and detect a boundary vertex of a submesh in an efficient way, a new method in which decoding time is reduced by using fewer bits will be described.

A boundary vertex is a vertex positioned on an edge connected to only one face in a three-dimensional mesh. A boundary vertex may be a vertex included in a first submesh (also referred to as a vertex held by a first submesh, a vertex belonging to a first submesh, or a vertex contained in a first submesh) and also a vertex that is located at a position similar to or the same position as the position of a vertex included in a second submesh. A boundary vertex may include a plurality of faces connected to the boundary vertex. In other words, a boundary vertex may contact a plurality of faces in a submesh.

A parameter for each pair of boundary vertices may be signaled for indicating whether a third vertex that is different from the pair is a boundary vertex.

For example, decoding device 200 first identifies a vertex on an outermost periphery (also referred to as an outermost vertex) in a submesh by checking three-dimensional mesh connection information. A set of outermost vertices is a subset of boundary vertices.

Next, decoding device 200 decodes a parameter for each pair of outermost vertices connected via an edge, and further determines a boundary vertex.

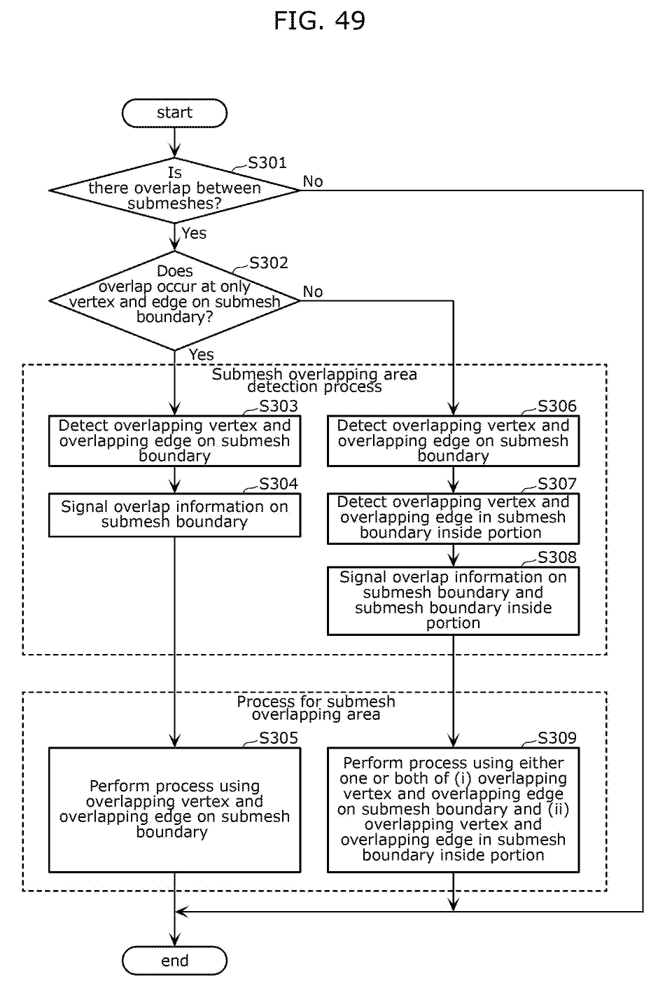

FIG. 49 is a flowchart illustrating a process for a submesh boundary performed by encoding device 100 according to the embodiment. It should be noted that encoding device 100 may signal overlap information on overlap between submeshes and transmit the overlap information to decoding device 200.

For example, a submesh boundary is a portion of a submesh at which the submesh is coupled with an other submesh, and is a portion containing a vertex and an edge that are included in an outer periphery (outermost periphery) of the submesh. A submesh boundary is, for example, a portion that includes a boundary vertex and a boundary edge in a submesh.

First, encoding device 100 determines whether there is overlap between submeshes (S301). For example, encoding device 100 determines whether one of submeshes overlaps any other one of the submeshes. Overlap between submeshes means, for example, a state in which, when one submesh and an other submesh are coupled, the one submesh and the other submesh overlap by at least part of a vertex, an edge, and/or a face. For example, overlap between submeshes means that, in an original mesh (full mesh), one submesh shares a vertex, an edge, and/or a face with an other submesh, as in the case of a boundary edge. For example, a state in which a first submesh and a second submesh overlap means a state in which a first submesh and a second submesh each include a vertex, an edge, or a face at the same coordinates.

When encoding device 100 determines that there is overlap between submeshes (Yes in S301), encoding device 100 determines whether the overlap occurs at only a vertex and an edge on a boundary (also referred to as a submesh boundary) of a submesh (S302). In other words, encoding device 100 determines whether a boundary of one of the submeshes overlaps (is shared with) an other one of the submeshes and a portion other than the boundary (also referred to as a submesh boundary inside portion or simply referred to as an inside portion) of the one of the submeshes does not overlap (is not shared with) the other one of the submeshes.

According to the determination result in step S302, a series of steps S303 and S304 in which a submesh overlapping area that is an overlapping area between submeshes (e.g., a vertex, an edge, and/or a face of a submesh) is determined (detected) or submesh overlapping area determination in steps S306 to S308 is performed, and a process for a submesh overlapping area in either one of step S305 or step S309 is performed.

When encoding device 100 determines that the overlap occurs at only a vertex and an edge on a submesh boundary (Yes in S302), encoding device 100 detects an overlapping vertex and an overlapping edge on the submesh boundary (S303).

Next, encoding device 100 signals, in a bitstream, overlap information including information related to the overlap on the submesh boundary (S304). The overlap information is, for example, information indicating the overlapping vertex and the overlapping edge.

Next, encoding device 100 performs a process using the overlapping vertex and the overlapping edge on the submesh boundary (S305).

In contrast, when encoding device 100 determines that the overlap does not occur at only a vertex and an edge on a submesh boundary, that is, when encoding device 100 determines that the overlap occurs at, in addition to a vertex and an edge on a submesh boundary, at least any of a vertex, an edge, and a face in a submesh boundary inside portion (No in S302), encoding device 100 first detects an overlapping vertex and an overlapping edge on the submesh boundary (S306).

Next, encoding device 100 detects an overlapping vertex and an overlapping edge in the submesh boundary inside portion (S307).

Next, encoding device 100 signals, in a bitstream, overlap information including information related to the overlap on the submesh boundary and the overlap in the submesh boundary inside portion (S308).

Next, encoding device 100 performs a process using either one or both of (i) the overlapping vertex and the overlapping edge on the submesh boundary and (ii) the overlapping vertex and the overlapping edge in the submesh boundary inside portion (S309).

It should be noted that when encoding device 100 determines that there is no overlap between submeshes (No in S301), encoding device 100 does not perform a process related to submesh overlap.

Detection of a submesh overlapping area is, for example, performed using divided meshes such as submeshes. The detection of a submesh overlapping area may be performed at an arbitrary timing as long as it is performed after dividing an original mesh into submeshes. For example, at the division into submeshes, encoding device 100 may determine which vertices are to be overlapped and store information indicating the vertices determined in memory or the like. Moreover, after the division into submeshes, encoding device 100 may investigate all of the vertices of the submeshes obtained by the division and determine vertices and edges to be overlapped.

Furthermore, as described above, encoding device 100 makes determination on an overlapping area with respect to a submesh boundary, and switches between processes according to whether the overlapping area is (A) a vertex and an edge on the submesh boundary or (B) a vertex and an edge on the submesh boundary and a vertex and an edge in a submesh boundary inside portion.

In the case of (A) described above, encoding device 100 detects the overlapping area on the submesh boundary in a predetermined method, and transmits, to decoding device 200, a bitstream including overlap information indicating the detection result.

Moreover, in the case of (B) described above, encoding device 100 detects the overlapping area on the submesh boundary and the overlapping area in the submesh boundary inside portion in a predetermined method, and transmits, to decoding device 200, a bitstream including overlap information indicating the detection result.

It should be noted that when decoding device 200 can detect an overlapping area of a submesh in a method that is the same as the method performed by encoding device 100, encoding device 100 does not need to signal overlap information in a bitstream.

For example, when decoding device 200 can detect an overlapping area on a submesh boundary, encoding device 100 may signal, in a bitstream, overlap information including only information on an overlapping area in a submesh boundary inside portion when performing the process in the case of (B) described above.

Moreover, the predetermined method for detecting an overlapping area on a submesh boundary and the method for detecting an overlapping area in a submesh boundary inside portion are not particularly limited and may be arbitrarily determined.

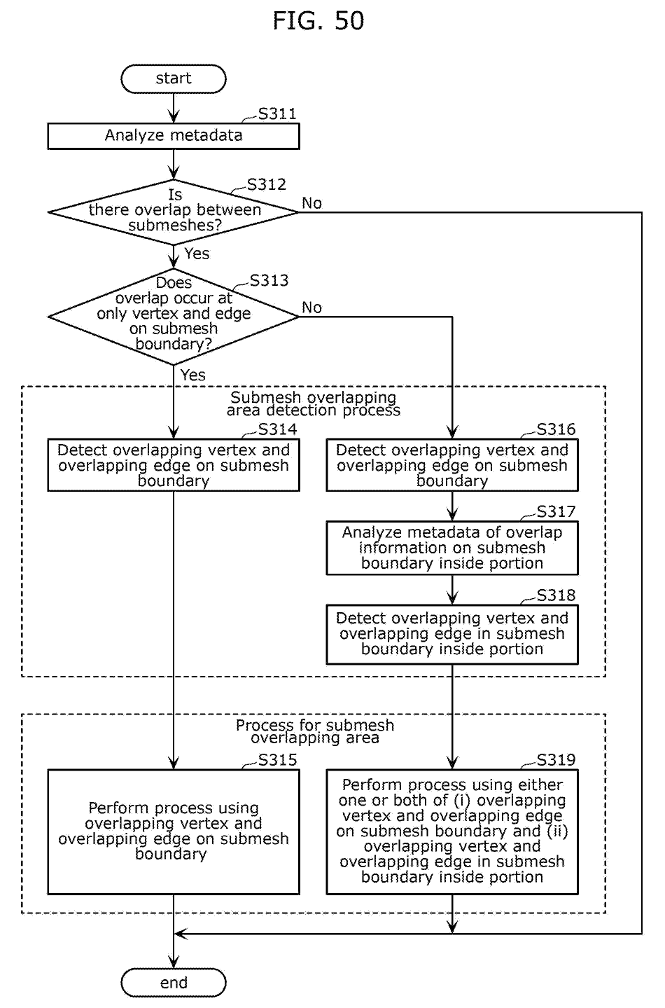

FIG. 50 is a flowchart illustrating an example of a process for a submesh boundary performed by decoding device 200 according to the embodiment.

First, decoding device 200 analyzes metadata (S311). Specifically, decoding device 200 obtains the above-described overlap information that is an example of metadata included in a bitstream received from encoding device 100.

Next, decoding device 200 determines whether there is overlap between submeshes, based on the metadata (specifically, overlap information) (S312).

When decoding device 200 determines that there is overlap between submeshes (Yes in S312), decoding device 200 further determines whether the overlap occurs at only a vertex and an edge on a submesh boundary, based on the metadata (S313).

According to the determination result in step S313, step S314 in which a submesh overlapping area is determined or submesh overlapping area determination in steps S316 to S318 is performed, and a process for a submesh overlapping area in either one of step S315 or step S319 is performed.

When decoding device 200 determines that the overlap occurs at only a vertex and an edge on a submesh boundary (Yes in S313), decoding device 200 detects an overlapping vertex and an overlapping edge on the submesh boundary (S314).

Next, decoding device 200 performs a process using the overlapping vertex and the overlapping edge on the submesh boundary (S315).

In contrast, when decoding device 200 determines that the overlap does not occur at only a vertex and an edge on a submesh boundary, that is, when decoding device 200 determines that the overlap occurs at, in addition to a vertex and an edge on a submesh boundary, at least any of a vertex, an edge, and a face in a submesh boundary inside portion (No in S313), decoding device 200 first detects an overlapping vertex and an overlapping edge on the submesh boundary (S316).

Next, decoding device 200 analyzes metadata of overlap information on an overlapping vertex and an overlapping edge in the submesh boundary inside portion (S317). Specifically, decoding device 200 obtains (extracts), from the metadata included in the bitstream, overlap information including information related to an overlapping vertex and an overlapping edge in the submesh boundary inside portion.

Next, decoding device 200 detects the overlapping vertex and the overlapping edge in the submesh boundary inside portion, based on the metadata analyzed (S318).

Next, decoding device 200 performs a process using either one or both of (i) the overlapping vertex and the overlapping edge on the submesh boundary and (ii) the overlapping vertex and the overlapping edge in the submesh boundary inside portion (S319).

It should be noted that when decoding device 200 determines that there is no overlap between submeshes (No in S312), decoding device 200 does not perform a process related to submesh overlap.

As described above, decoding device 200 makes determination on an overlapping area with respect to a submesh boundary, and switches between processes according to whether the overlapping area is (A) a vertex and an edge on the submesh boundary or (B) a vertex and an edge on the submesh boundary and a vertex and an edge in a submesh boundary inside portion.

It should be noted that the example illustrated in FIG. 50 is an example in which encoding device 100 and decoding device 200 can detect an overlapping vertex and an overlapping edge on a submesh boundary in a predetermined method and only information on a submesh boundary inside portion is signaled in a bitstream. In the case of (B) described above, decoding device 200 can detect an overlapping vertex and an overlapping edge in a submesh boundary inside portion by analyzing overlap information (metadata) including information related to overlap in the submesh boundary inside portion.

FIG. 51 is a flowchart illustrating another example of the process for a submesh boundary performed by decoding device 200 according to the embodiment.

The present example is different from the example illustrated in FIG. 50 in a process for submesh overlap. In the process for a submesh overlapping area in this example, step S321 is performed, and then step S322 or step S323 is performed.

After step S314 or step S318 is performed, decoding device 200 determines whether edges between the submeshes overlap (S321).

When decoding device 200 determines that edges between the submeshes overlap (Yes in S321), decoding device 200 performs a process using a subdivision method and the number of iterations of subdivision that are common to the submeshes (S322). In other words, decoding device 200 performs subdivision of each of the submeshes using a subdivision method and the number of iterations of subdivision that are common to the submeshes.

In contrast, when decoding device 200 determines that edges between the submeshes do not overlap (No in S321), decoding device 200 performs a process using, for each of the submeshes, an individual subdivision method and an individual number of iterations of subdivision (S323). In other words, decoding device 200 performs, for each of the submeshes, subdivision of the submesh using an individual subdivision method and an individual number of iterations of subdivision.

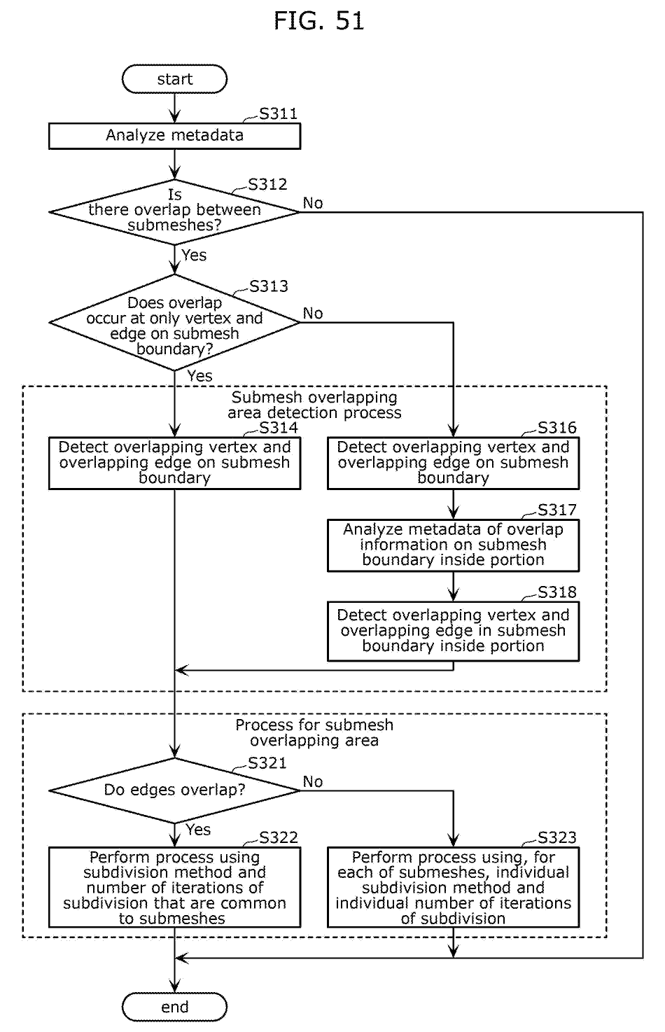

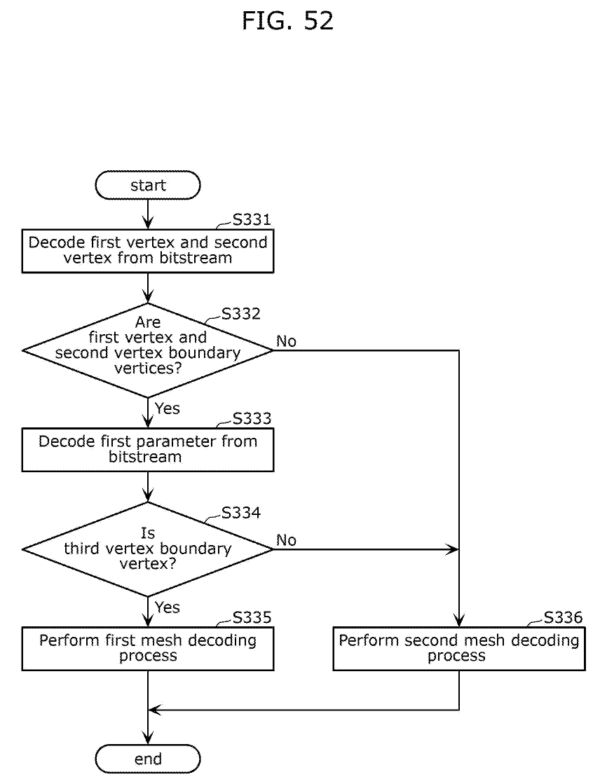

FIG. 52 is a flowchart illustrating a process for a submesh performed by decoding device 200 according to the embodiment. Specifically, FIG. 52 is a flowchart illustrating an example in which processes are switched according to determination regarding a vertex and an edge on a submesh boundary and a vertex and an edge in a submesh boundary inside portion, as in the case of (B) described above.

First, decoding device 200 decodes a first vertex and a second vertex from a bitstream encoded (S331). The first vertex and the second vertex are, for example, two points that form an edge (i.e., vertices at both ends of an edge).

Next, decoding device 200 determines whether the first vertex and the second vertex are boundary vertices (S332). In other words, decoding device 200 determines whether the edge formed by the first vertex and the second vertex is a boundary edge.

When decoding device 200 determines that the first vertex and the second vertex are boundary vertices (Yes in S332), decoding device 200 decodes a first parameter from the bitstream (S333). Specifically, decoding device 200 obtains a first parameter that is information for detecting an overlapping area in a submesh boundary inside portion in metadata included in the bitstream. The first parameter is, for example, the above-described overlap information.

Next, decoding device 200 determines whether the first parameter indicates that a third vertex is a boundary vertex (S334).

When decoding device 200 determines that the first parameter indicates that the third vertex is a boundary vertex (Yes in S334), that is, when decoding device 200 determines that all of the first vertex, the second vertex, and the third vertex are boundary vertices, decoding device 200 performs a first mesh decoding process (S335).

In contrast, when decoding device 200 determines that the first parameter does not indicate that the third vertex is a boundary vertex (No in S334) or when decoding device 200 determines that the first vertex and the second vertex are not boundary vertices (No in S332), that is, when decoding device 200 determines that at least one of the first vertex, the second vertex, or the third vertex is not a boundary vertex, decoding device 200 performs a second mesh decoding process that is different from the first mesh decoding process (S336).

Thus, the processes (specifically, the submesh decoding processes) are switched based on whether an overlapping edge is included in a submesh boundary inside portion.

It should be noted that the content of each of the first mesh decoding process and the second mesh decoding process is not particularly limited and may be an arbitrary process.

As described above, for example, decoding device 200: decodes a first vertex and a second vertex from a bitstream (encoded bitstream); determines whether the first vertex and the second vertex are boundary vertices; decodes a first parameter from the bitstream; determines whether the first parameter indicates that a third vertex is a boundary vertex; performs, when the first vertex, the second vertex, and the third vertex are determined to be boundary vertices, a first mesh decoding process; and performs, when at least one of the first vertex, the second vertex, and the third vertex is determined not to be a boundary vertex, a second mesh decoding process that is different from the first mesh decoding process.

Moreover, for example, the first parameter is signaled in a base mesh sub-bitstream, an atlas frame parameter set, an atlas tile header, a patch data unit, or Supplemental Enhancement Information (SEI).

Furthermore, for example, the first vertex is connected to the second vertex via an edge.

Furthermore, for example, the edge connecting the first vertex and the second vertex is part of only one face.

Furthermore, for example, decoding device 200 decodes the first parameter when decoding device 200 determines that the first vertex and the second vertex are boundary vertices.

Furthermore, for example, the first vertex, the second vertex, and the third vertex belong to the same face in a submesh. In other words, the first vertex, the second vertex, and the third vertex are vertices that are included in the same face among faces in a submesh.

Moreover, for example, the first vertex, the second vertex, and the third vertex are connected to each other.

Furthermore, for example, when decoding device 200 determines that the first vertex, the second vertex, and the third vertex are boundary vertices, decoding device 200 performs the first mesh decoding process. The first mesh decoding process includes a post-decoding process, a reconstruction process, a pre-reconstruction process, a post-reconstruction process, or an adaptation process.

Furthermore, for example, when decoding device 200 determines that at least one of the first vertex, the second vertex, or the third vertex is not a boundary vertex, decoding device 200 performs the second mesh decoding process that is different from the first mesh decoding process. The second mesh decoding process includes a post-decoding process, a reconstruction process, a pre-reconstruction process, a post-reconstruction process, or an adaptation process.

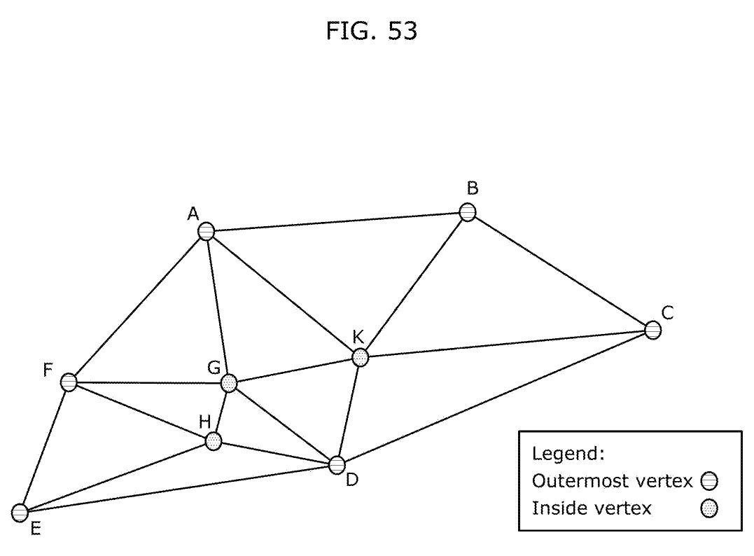

FIG. 53 is a diagram illustrating an example of a submesh according to the embodiment. It should be noted that among the vertices included in the submesh illustrated in FIG. 53, vertex A, vertex B, vertex C, vertex D, vertex E, and vertex F are outermost vertices, and vertex G, vertex H, and vertex K are inside vertices. The inside vertices are vertices other than the outermost vertices among the vertices included in the submesh.

In step S331 described above, decoding device 200 decodes a first vertex and a second vertex from a bitstream. The first vertex and the second vertex may belong to the same submesh. The first vertex and the second vertex may be connected via an edge.

[Method for Detecting Vertex on Submesh Boundary]

Moreover, in step S332 described above, decoding device 200 determines whether the first vertex and the second vertex are boundary vertices. For example, decoding device 200 determines whether the vertices are boundary vertices of the submesh by identifying outermost vertices based on submesh connection information.

The outermost vertices are vertices that are connected to each other via an edge to serve as a submesh boundary. For example, when each of the first vertex and the second vertex is an outermost vertex, an edge connecting the first vertex and the second vertex is part of only one face among faces in the submesh. For example, an outermost vertex is at least part of one edge that forms only one triangle with an other vertex included in a manifold in the submesh. A manifold represents a shape that has no self-intersection and no edge that is shared among more than two faces. For example, vertex A is part of edge AB that only forms triangle ABK. In contrast, for example, each of edges contacting vertex K is part of two triangles. Accordingly, vertex K is not an outermost vertex. For example, whether an edge is a boundary edge is determined based on whether the edge is an edge belonging to only one triangle in the submesh. For example, when an edge is determined to be an edge belonging to only one triangle, the edge is determined to be a boundary edge, and when an edge is determined not to be an edge belonging to only one triangle, the edge is determined not to be a boundary edge. Moreover, for example, among one or more boundary edges, a boundary edge that overlaps (is shared with) an other submesh is determined to be an overlapping edge, and a boundary edge that does not overlap (is not shared with) an other submesh is determined not to be an overlapping edge. For example, a vertex that is included in a boundary edge is also referred to as a boundary vertex, and a vertex that is included in an overlapping edge is also referred to as an overlapping vertex.

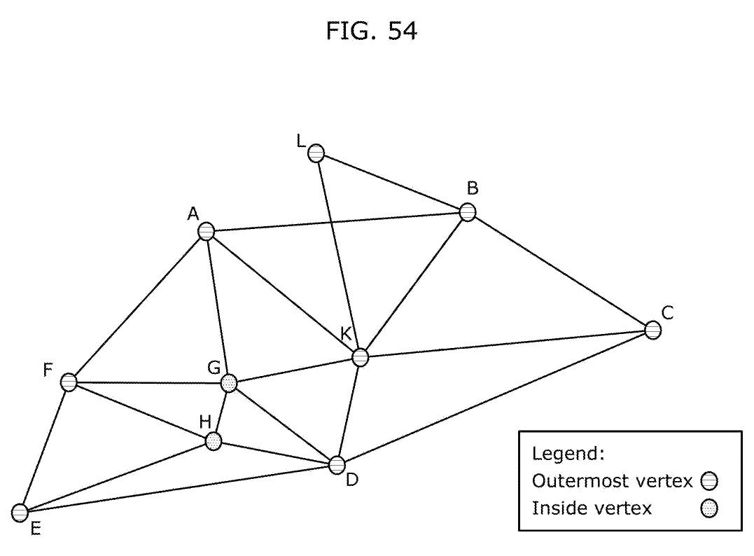

FIG. 54 is a diagram illustrating another example of the submesh according to the embodiment. It should be noted that among the vertices included in the submesh illustrated in FIG. 54, vertex A, vertex B, vertex C, vertex D, vertex E, vertex F, vertex K, and vertex L are outermost vertices, and vertex G and vertex H are inside vertices.

In step S332 described above, regarding a non-manifold in the submesh illustrated in FIG. 54, decoding device 200 reads out one or more parameters from a bitstream and identifies which of the vertices in the non-manifold is an outermost vertex. In order to detect an edge in the non-manifold, decoding device 200 determines, for example, whether there is an edge connected to three or more faces.

For example, vertex K illustrated in FIG. 54 is included in three triangles that are triangle ABK, triangle BCK, and triangle LBK. Therefore, vertex K is part of edge BK of a non-manifold. In order to determine whether vertex K is an outermost vertex, decoding device 200 may decode one or more parameters.

[Method Performed in Decoding Device for Detecting Vertex in Submesh Boundary Inside Portion Based on First Parameter Signaled]

FIG. 55 is a diagram illustrating another example of the submesh according to the embodiment. It should be noted that among the vertices included in the submesh illustrated in FIG. 55, vertex A, vertex B, vertex C, vertex D, vertex E, vertex F, and vertex H are boundary vertices, and vertex G and vertex K are non-boundary vertices (vertices that are not boundary vertices).

In step S333 described above, decoding device 200 decodes a first parameter from the bitstream. The first parameter may be a flag.

In step S334 described above, decoding device 200 determines whether the first parameter indicates that a third vertex is a boundary vertex. The first vertex, the second vertex, and the third vertex may belong to the same submesh. The first vertex, the second vertex, and the third vertex may belong to the same face in the submesh. In other words, the first parameter is a parameter for each triangle that includes at least two boundary vertices.

As illustrated in FIG. 55, for example, a parameter indicating that triangle EFH includes at least two boundary vertices (specifically, vertex E and vertex F) is decoded. Vertex H is determined to be a boundary vertex based on the parameter decoded. Likewise, since triangle AGF includes at least two boundary vertices (specifically, vertex A and vertex F), a parameter indicating whether vertex G is a boundary vertex may be decoded. Vertex G is determined to be a non-boundary vertex based on the parameter decoded. For example, in step S333, such a parameter is decoded from the bitstream. Moreover, in step S334, whether a third vertex is a boundary vertex is determined based on the parameter decoded. For example, when vertex E and vertex F are boundary vertices in triangle EFH, vertex H that is a third vertex is determined to be a boundary vertex because the parameter indicates 1 (parameter = 1). Moreover, when vertex A and vertex F are boundary vertices in triangle AGF, vertex G that is a third vertex is determined not to be a boundary vertex because the parameter indicates 0 (parameter = 0).

[Example in Which Processes are Switched Based on Whether Submesh Boundary Inside Portion Includes Boundary Vertex]

In step S335 described above, when the first vertex, the second vertex, and the third vertex are determined to be boundary vertices, decoding device 200 performs the first mesh decoding process. For example, decoding device 200 performs, as the first mesh decoding process, subdivision (midpoint subdivision) to form a vertex at the midpoint of an edge connecting two boundary vertices. For example, decoding device 200 performs inverse linear wavelet transform on an edge connecting two boundary vertices. For example, decoding device 200 traverses a coefficient of a displacement vector (displacement coefficient) of each boundary vertex from a low frequency to a high frequency.

Moreover, in step S336 described above, when at least one of the first vertex, the second vertex, or the third vertex is determined to be a non-boundary vertex, decoding device 200 performs the second mesh decoding process that is different from the first mesh decoding process. For example, decoding device 200 performs, as the second mesh decoding process, butterfly subdivision on an edge not connecting two boundary vertices. For example, decoding device 200 performs inverse butterfly wavelet transform on an edge not connecting two boundary vertices. For example, decoding device 200 traverses a coefficient of a displacement vector of each non-boundary vertex from a high frequency to a low frequency.

The first mesh decoding process and the second mesh decoding process may include an additional process such as a post-decoding process, a reconstruction process, a pre-reconstruction process, a post-reconstruction process, or an adaptation process. The first mesh decoding process may include at least one of a subdivision process, an inverse quantization process, an inverse image packing process, an inverse wavelet transform process, a texture coordinate derivation process, or the like. For example, decoding device 200 applies a subdivision process three times to an edge connecting two boundary vertices.

For example, in step S335, a subdivision process is repeated three times in the first mesh decoding process. Moreover, for example, in step S336, in the second mesh decoding process, a subdivision process is applied once to an edge not connecting two boundary vertices. The number of iterations of subdivision performed in step S335 and the number of iterations of subdivision performed in step S336 may be the same or different from each other.

Moreover, for example, in the first mesh decoding process, decoding device 200 may apply midpoint subdivision to an edge connecting boundary vertices, and in the second mesh decoding process, decoding device 200 may apply subdivision, such as butterfly subdivision, that is different from the midpoint subdivision to an edge connecting non-boundary vertices.

As described above, for example, in step S335, when the third vertex is a boundary vertex (i.e., when all of the edges are boundary edges), decoding device 200 performs the first mesh decoding process on a face that is a face where submeshes overlap and includes a submesh boundary.

For example, in the first mesh decoding process, in a subdivision process, decoding device 200 divides a boundary edge at the midpoint. Moreover, for example, decoding device 200 applies inverse linear wavelet transform in the first mesh decoding process. Furthermore, for example, decoding device 200 traverses a coefficient of a displacement vector of each boundary vertex from a low frequency to a high frequency.

Furthermore, for example, in step S336, when the third vertex is not a boundary vertex (i.e., when an edge that is not a boundary edge is included), decoding device 200 performs the second mesh decoding process.

For example, in the second mesh decoding process, in a subdivision process, decoding device 200 applies butterfly division to a boundary edge. Moreover, for example, decoding device 200 applies inverse butterfly wavelet transform in the second mesh decoding process. Furthermore, for example, in the second mesh decoding process, decoding device 200 traverses a coefficient of a displacement vector of each non-boundary vertex from a low frequency to a high frequency.

It should be noted that, for example, in a subdivision process performed for each of submeshes, when all of the edges in the submesh are overlapping edges (e.g., step S335), decoding device 200 applies, to all of the overlapping edges, the number of iterations of subdivision that is common to the submeshes. In contrast, for example, in a subdivision process performed for each of submeshes, when the submesh includes an edge that is not an overlapping edge (e.g., step S336), decoding device 200 applies, to an overlapping edge of the submesh, the number of iterations of subdivision that is common to the submeshes, and applies, to the edge that is not an overlapping edge, the number of iterations of subdivision that is individually assigned to the submesh.

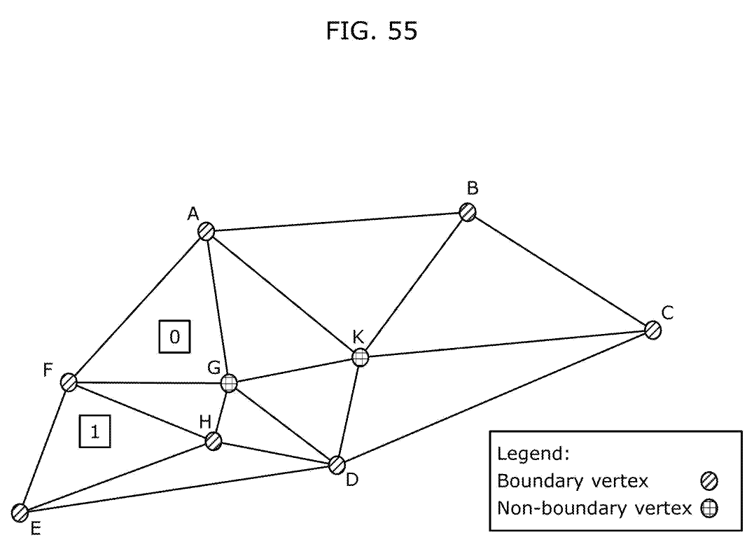

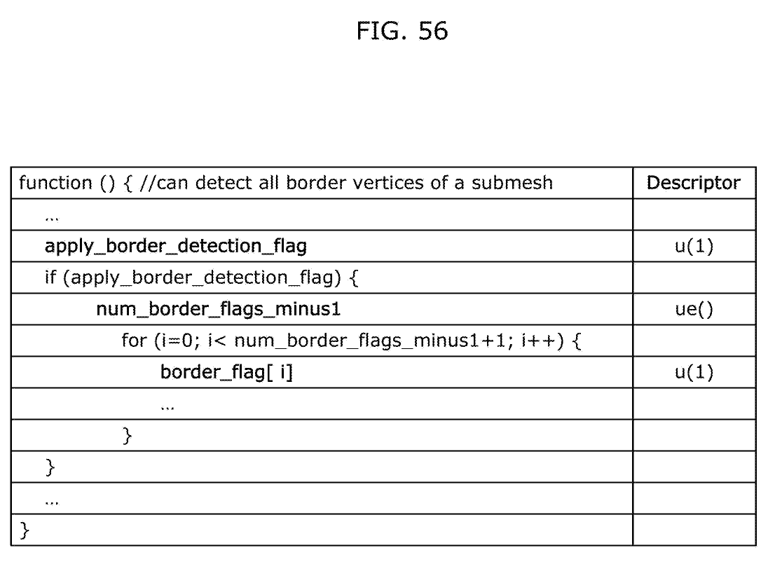

FIG. 56 is a diagram illustrating an example of syntax related to signaling of boundary information according to the embodiment. Specifically, FIG. 56 is a diagram illustrating an example of syntax elements necessary for signaling boundary information. The boundary information is an example of overlap information.

When the value of apply_border_detection_flag is equal to 1, it indicates that boundary detection is effective and a parameter for a pair of boundary vertices exists in the bitstream.

It should be noted that when apply_border_detection_flag does not exist in the bitstream, the value thereof is estimated to be 0, for example.

The value obtained by adding 1 to num_border_flags_minus1 designates the number of border_flags[i] signaled by the bitstream. For example, the value of num_border_flags_minus1 is determined in advance to be within a range from 0 to the maximum number of vertices.

When the value of border_flag[i] is equal to 1, it indicates that the vertices related to the i-th parameter are boundary vertices. Moreover, when the value of border_flag[i] is equal to 0, it indicates that the vertices are not boundary vertices.

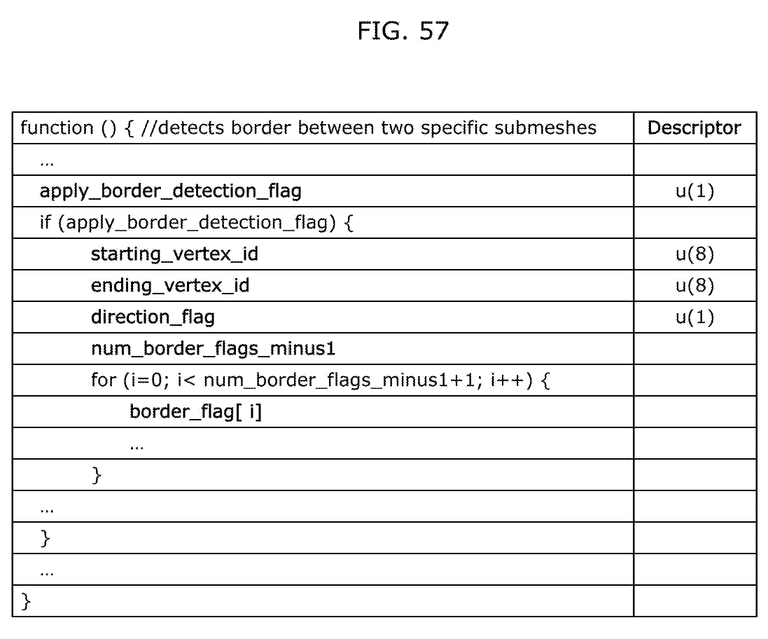

FIG. 57 is a diagram illustrating another example of the syntax related to signaling of boundary information according to the embodiment. Specifically, FIG. 57 illustrates an example of syntax elements necessary for signaling boundary information.

starting_vertex_id indicates the id of an initial vertex (also referred to as a start vertex) that is referred to by border_flags[0].

ending_vertex_id indicates the id of a final vertex (also referred to as an end vertex) that is referred to by border_flags[num_border_flags_minus1].

direction_flag indicates a direction in which vertices are scanned (traversed). For example, when the value of direction_flag is 0, it indicates that vertices are scanned in the clockwise direction. Moreover, when the value of direction_flag is 1, it indicates that vertices are scanned in the counter-clockwise direction. It should be noted that when there is no direction_flag, the value thereof is estimated to be 0, for example. Namely, direction_flag indicates an order in which vertices are processed.

FIG. 58 is a diagram for describing an example of a method of using syntax according to the embodiment. Specifically, FIG. 58 is a diagram for describing how to use the syntax illustrated in FIG. 57. It should be noted that among the vertices included in the submesh illustrated in FIG. 58, vertex A, vertex B, vertex C, vertex D, vertex E, vertex F, and vertex H are boundary vertices, and vertex G and vertex K are non-boundary vertices. Moreover, the numerical values shown in triangle AGF and triangle EFH each indicate a possible value of border_flag_[i]. In the present example, it is assumed that border_flag_[i] of triangle AGF = 0 and border_flag_[i] of triangle EHF = 1.

For example, it is assumed that starting_vertex_id indicates vertex E (i.e., the start vertex is vertex E). Moreover, it is assumed that direction_flag = 0. In this case, traversal proceeds in the clockwise direction in FIG. 58, and the next vertex is selected. In the present example, when direction_flag = 0, the vertex subsequent to vertex E is vertex F.

In contrast, for example, it is assumed that direction_flag = 1. In this case, traversal proceeds in the counter-clockwise direction in FIG. 58, and the next vertex is selected. In the present example, when direction_flag = 1, the vertex subsequent to vertex E is vertex D.

Moreover, for example, when ending_vertex_id indicates vertex B (i.e., the end vertex is vertex B), traversal proceeds from vertex E to vertex B in the direction indicated by direction_flag.

Thus, for example, encoding device 100 designates an arbitrary vertex as a start vertex in a submesh, and sequentially processes each vertex on a submesh boundary in a predetermined direction (clockwise or counter-clockwise).

The start vertex and the predetermined direction are, for example, determined by encoding device 100 in an arbitrary method. For example, encoding device 100 transmits, to decoding device 200, information indicating the start vertex and the predetermined direction, by signaling the information in a bitstream using starting_vertex_id and direction_flag.

It should be noted that encoding device 100 may transmit, to decoding device 200, information indicating an order that is an order in which vertices are processed and corresponds to the predetermined direction, by signaling, in a bitstream, information indicating, in addition to the start vertex, the identifier (id) indicating the vertex that is processed second in the order.

For example, based on the start vertex and the next vertex (in the present example, vertex E and vertex F), encoding device 100 encodes, into a bitstream, information indicating whether vertex H is a boundary vertex by using border_flag[0]. For example, encoding device 100 sequentially performs such a process on each vertex until the end vertex. For example, the end vertex may be determined by encoding device 100 in an arbitrary method. For example, encoding device 100 transmits, to decoding device 200, information indicating the end vertex, by signaling the information in a bitstream using ending_vertex_id.

As described above, for example, encoding device 100 determines whether, among vertices included in a submesh that has been divided from an original mesh, a vertex that is positioned out of a submesh boundary of the submesh (e.g., a vertex that is not positioned on an edge included in an outer periphery of the submesh, that is, an inside vertex as described above) overlaps any of vertices included in an other submesh that has been divided from the original mesh. Moreover, based on the determination result, encoding device 100 encodes, into a bitstream, information indicating the above-described border_flag[i] or the like. Furthermore, for example, encoding device 100 further encodes, into the bitstream, (i) starting_vertex_id indicating a vertex on which a predetermined process, such as the above-described first mesh decoding process or the above-described second mesh decoding process, is performed first among vertices included in the submesh, (ii) direction_flag indicating an order in which the predetermined process is performed on the vertices, and (iii) ending_vertex_id indicating a vertex on which the predetermined process is performed last. Furthermore, for example, based on the information encoded into (signaled by) the bitstream as described above, decoding device 200 determines overlap between submeshes and decodes each submesh based on the determination result.

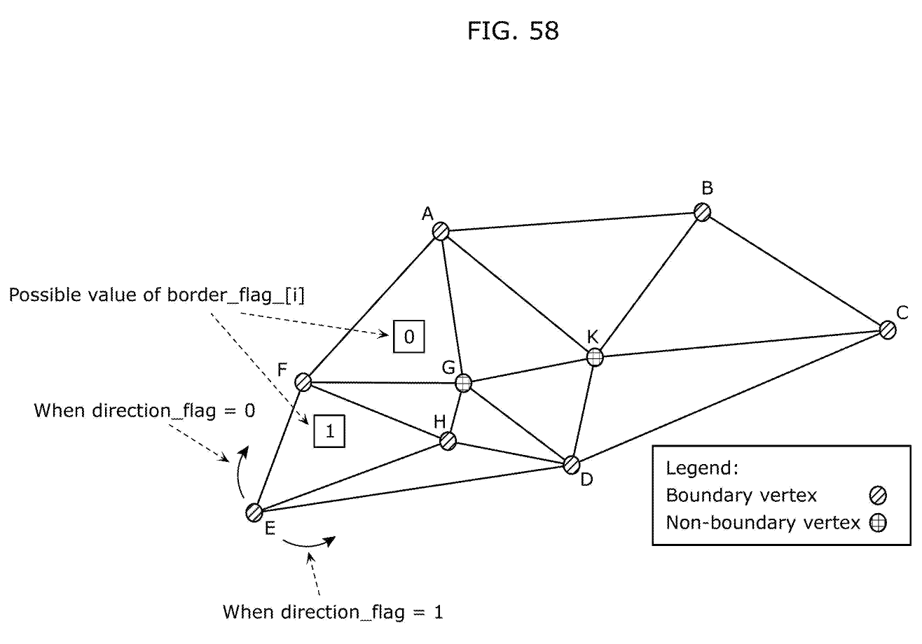

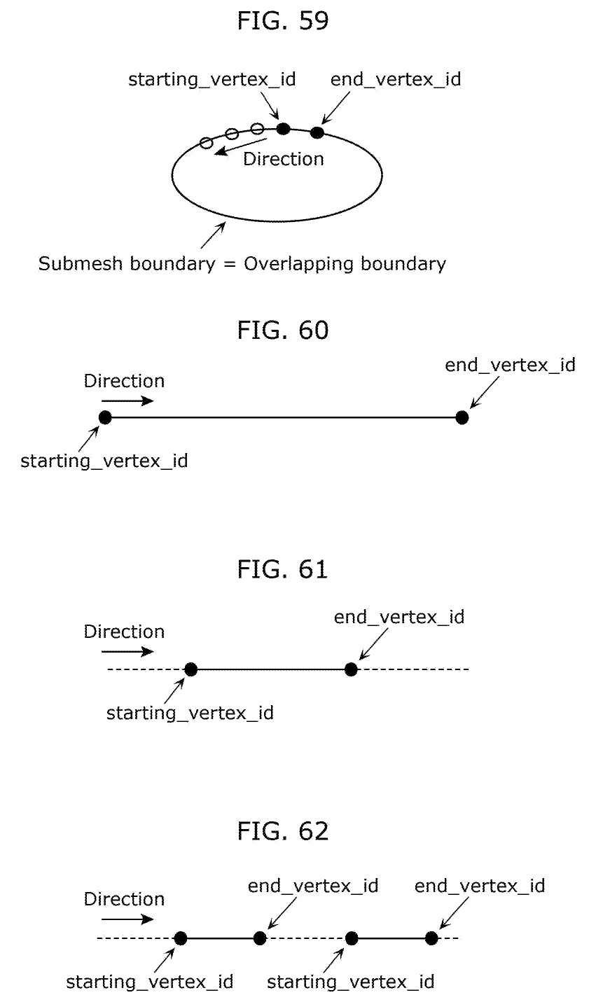

FIG. 59 is a diagram for describing an order in which vertices according to the embodiment are processed. FIG. 60 to FIG. 62 are each a diagram for describing an example of the order in which vertices according to the embodiment are processed.

It should be noted that a black circle and a white circle illustrated in FIG. 59 to FIG. 62 each indicate a vertex included in a submesh. Moreover, solid lines illustrated in FIG. 59 to FIG. 62 each indicate a line corresponding to a submesh boundary (boundary line). Specifically, solid lines illustrated in FIG. 59 to FIG. 62 are each a line connecting vertices in a processing order.

When the submesh boundary (= overlapping boundary) illustrated in FIG. 59 is in a circular shape, for example, FIG. 60 to FIG. 62 are diagrams illustrating boundary lines and overlapping lines in a developed manner. The overlapping boundary is, for example, an overlapping area as described above, and each of the overlapping lines is, for example, a line indicating an area where submeshes overlap. In FIG. 60 to FIG. 62, each of the boundary lines (e.g., boundary vertices and a boundary edge) is represented by a dotted line, and each of the overlapping lines (e.g., overlapping vertices and an overlapping edge) is represented by a solid line.

The example illustrated in FIG. 60 is a case where the whole of the submesh boundary is formed by overlapping vertices. In the present example, starting_vertex_id and end_vertex_id are identifiers that indicate a start vertex and an end vertex on a boundary line, respectively, and are also identifiers that indicate a start vertex and an end vertex on an overlapping line, respectively.

The example illustrated in FIG. 61 is a case where part of the submesh boundary is formed by overlapping vertices. In the present example, starting_vertex_id and end_vertex_id are not identifiers that indicate a start vertex and an end vertex on a boundary line, respectively, but identifiers that indicate a start vertex and an end vertex on an overlapping line, respectively.

The example illustrated in FIG. 62 is a case where overlapping areas exist on the submesh boundary. In the present example, for example, encoding device 100 signals, in a bitstream, num_submesh that is information indicating the number of submeshes, and indicates, in the bitstream, information for each of the submeshes.

As illustrated in FIG. 61 and FIG. 62, a boundary line and an overlapping line may be distinguished. In other words, a boundary edge and an overlapping edge may be distinguished. For example, a boundary line may be an edge that belongs to only one triangle in a submesh, and an overlapping line may be an edge that is a boundary line and shared with an other submesh. Moreover, a boundary vertex may be a vertex that is included in a boundary line, and an overlapping vertex may be a vertex that is a boundary vertex and shared with an other submesh.

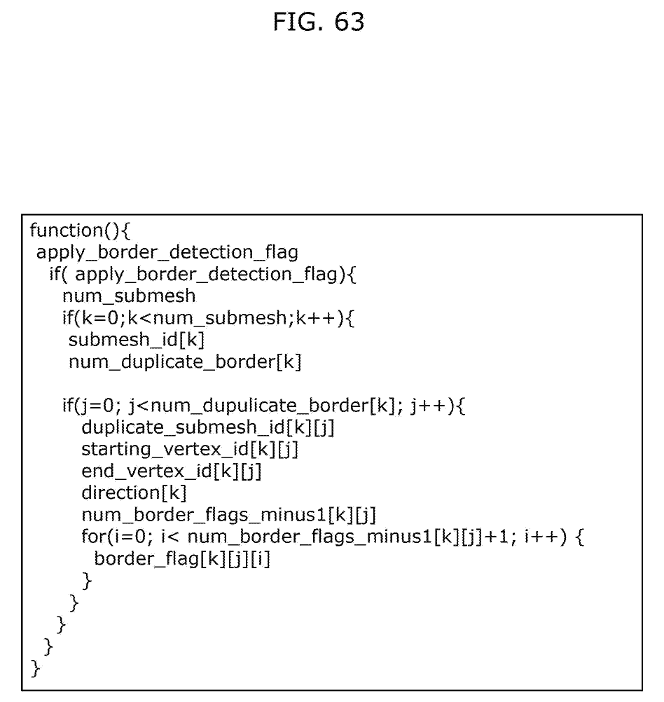

FIG. 63 is a diagram illustrating an example of syntax related to signaling of the number of submeshes according to the embodiment.

For example, encoding device 100 signals, in a bitstream, num_dupulicate_border that is information indicating the number of areas where submeshes overlap (overlapping areas each indicated by an overlapping line as described above). Moreover, for example, for each of the overlapping areas, encoding device 100 signals, in a bitstream, information indicating a start vertex and an end vertex. Information indicating the direction of traversal (the above-described direction[k]) may be common to the overlapping areas. Moreover, for example, for each of the overlapping areas, encoding device 100 may signal, in the bitstream, an identifier indicating a vertex that is processed second among vertices in the overlapping area.

Furthermore, for each of the overlapping areas, encoding device 100 may signal, in the bitstream, overlapping destination information indicating which submesh overlaps the overlapping area (e.g., duplicate_submesh_id). By this signaling, for example, information related to overlapping edges may be transmitted to decoding device 200. For example, when one submesh overlaps an other submesh at two overlapping areas, encoding device 100 signals, in a bitstream, information indicating num_duplicate_border = 2 and the same submesh_id for duplicate_submesh_id of each of the two overlapping areas. Moreover, for example, when one submesh overlaps two different submeshes at different overlapping areas, encoding device 100 signals, in a bitstream, information indicating num_duplicate_border = 2 and a different submesh_id for duplicate_submesh_id of each of the different overlapping areas.

It should be noted that num_border_flags_minus1 does not need to be transmitted when num_border_flags_minus1 can be detected (calculated) in a process performed by decoding device 200.

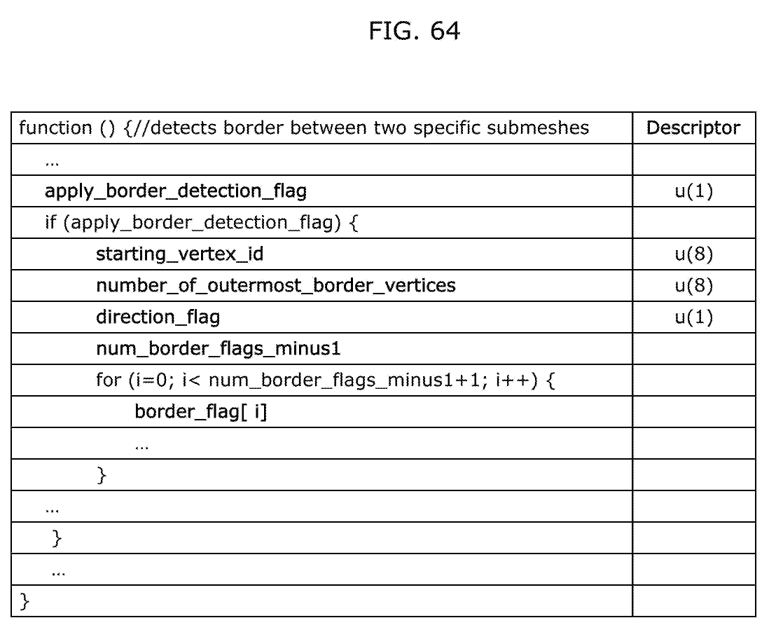

FIG. 64 is a diagram illustrating another example of the syntax related to signaling of boundary information according to the embodiment. Specifically, FIG. 64 illustrates another example of the syntax elements necessary for signaling boundary information.

starting_vertex_id indicates the identifier of an initial vertex (start vertex) from which a scan (process) starts.

number_of_outermost_border_vertices indicates the number (total number) of vertices detected as outermost vertices.

When the value of direction_flag is 0, it indicates that vertices are scanned (traversed) in the clockwise direction. Moreover, when the value of direction_flag is 1, it indicates that vertices are scanned in the counter-clockwise direction. When there is no direction_flag, the value thereof is estimated to be 0, for example.

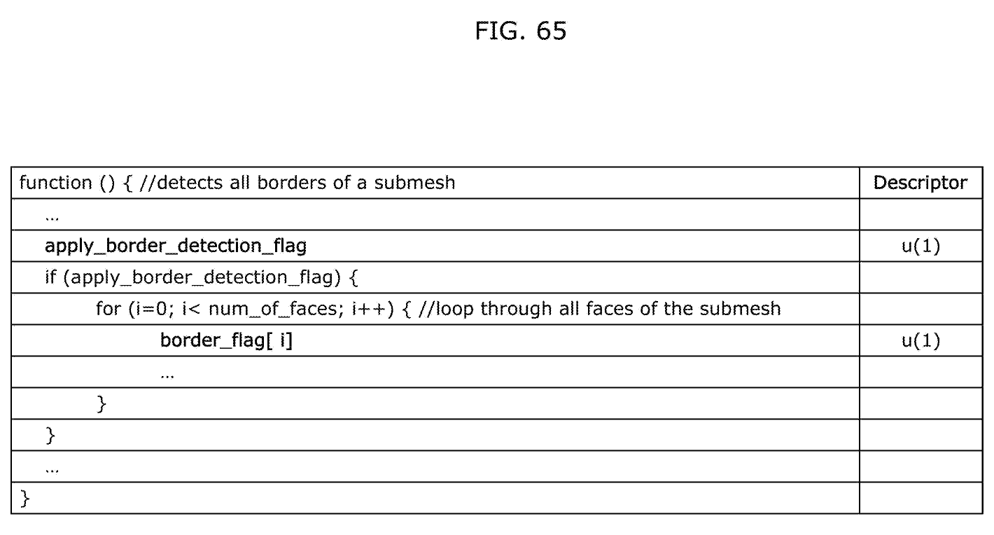

FIG. 65 is a diagram illustrating another example of the syntax related to signaling of boundary information according to the embodiment. Specifically, FIG. 65 illustrates another example of the syntax elements necessary for signaling boundary information. Each pair of vertices are associated with a different border_flag. In the example illustrated in FIG. 65, a flag is signaled for each face in a submesh.

When the value of apply_border_detection_flag is equal to 1, it indicates that boundary detection is effective (i.e., detection of a boundary is possible) and a parameter for a pair of boundary vertices exists in the bitstream. When apply_border_detection_flag does not exist, the value thereof is estimated to be 0, for example.

When the value of border_flag[i] is equal to 1, it indicates that vertices associated with the i-th parameter are boundary vertices. Moreover, when the value of border_flag[i] is equal to 0, it indicates that vertices associated with the i-th parameter are not boundary vertices.

It should be noted that, for example, regarding a submesh boundary that is a boundary (overlapping area) where submeshes overlap, whether the submeshes overlap at a face on the submesh boundary is indicated by indicating (signaling), in a bitstream, whether the submeshes overlap at a vertex contacting the submesh boundary. The information indicating whether the submeshes overlap at a vertex contacting the submesh boundary is not limited to information indicating the overlapping area and may be used as information indicating an edge and a face in a submesh boundary inside portion connected to the submesh boundary in a predetermined one of the submeshes. Moreover, such information may be used as information indicating an edge and a face in a submesh boundary outside portion. Furthermore, information indicating whether a vertex, an edge, and a face are included in a submesh boundary inside portion or a submesh boundary outside portion may be indicated in a bitstream. Moreover, either one or both of: information on a submesh boundary inside portion; and information on a submesh boundary outside portion may be indicated in a bitstream.

Furthermore, the information indicating whether the submeshes overlap at a vertex contacting the submesh boundary is not limited to information indicating the submesh boundary and may be used as information indicating an edge and a face that are connected to a predetermined edge in a group of edges connected to each other in a predetermined one of the submeshes.

For example, such information may be used for a process for a boundary where submeshes overlap and may be signaled in a bitstream. Moreover, such information may be used for: a process for a boundary that is a boundary of a submesh and does not overlap an other submesh; a process for a boundary of a submesh regardless of whether the boundary overlaps an other submesh; or a process for part of a boundary where submeshes overlap.

As described above, the above-described signaling method and the above-described configuration of syntax may be used for: notification of information related to an edge included in a submesh boundary; or notification of information related to edges sequentially arranged in a predetermined order in an arbitrary three-dimensional mesh. Moreover, the information notified using the above-described signaling method and the above-described configuration of syntax does not need to be information indicating whether there is overlap with an other submesh or information indicating a process performed in an overlapping area. The information notified may be, for example, information indicating each of the edges or information indicating a state or an attribute of a mesh including each of the edges. Moreover, the information notified may be, for example, information indicating a process performed on each of the edges or a mesh including each of the edges.

It should be noted that “submeshes overlap” means that, for example, the relationship between a first submesh and a second submesh is a relationship in which a first mesh included in the first submesh shares (i) a vertex, (ii) a vertex and an edge, or (iii) a vertex, an edge, and a face, with a second mesh included in the second submesh. Moreover, “submeshes overlap” means, when focusing on one of the submeshes, that a mesh included in the one of the submeshes shares (i) a vertex, (ii) a vertex and an edge, or (iii) a vertex, an edge, and a face, with a mesh included in an other one of the submeshes.

It should be noted that in generation of submeshes, when there is a constraint that prevents a face from being shared, a target used to determine whether the submeshes overlap may be only a vertex and an edge, rather than a vertex, an edge, and a face.

Moreover, although an example in which encoding device 100 divides mesh data into submeshes and encodes the submeshes has been described above, at least part of the present disclosure can be applied to data other than mesh data. For example, when encoding device 100 divides point cloud data into sub point cloud data items and encodes the sub point cloud data items, at least part of the present disclosure may be applied to the sub point cloud data items each of which includes a boundary with a different one of the sub point cloud data items. Specifically, when a mismatch occurs at a boundary in a case where a different process is performed on each side of the boundary, the same process may be performed on an area in the vicinity of the boundary in each side of the boundary, or a correction method (amendment method) that is performed when a mismatch occurs at the boundary may be designated. Moreover, the embodiment according to the present disclosure may be applied to: a method in which a process performed on an area including a boundary and a process performed on an area not including a boundary are signaled in a bitstream; and a method in which information indicating whether a boundary is included is signaled in a bitstream. Furthermore, the embodiment according to the present disclosure may be applied as syntax for realizing such signaling.

Namely, an aspect directly or indirectly indicated by the embodiment according to the present disclosure can be widely used when sub data items generated by spatially dividing a single data item are encoded or decoded.

### Overview of Present Disclosure

Next, an overview of techniques derived from the disclosure in this specification will be described.

For example, in a decoding method according to the present disclosure, for a plurality of submeshes forming an overall three-dimensional mesh, position information of a vertex included in a polygon forming a submesh and connection information regarding a connection relationship between vertexes are obtained from an encoded bitstream (that is, decoding of information), the polygon is generated using the position information and the connection information (that is, decoding of a face), whether an edge forming the polygon is a boundary between submeshes is determined (that is, conditional determination of an edge), a division process for the edge is determined based on the determination result (that is, determination of a subdivision process based on the determination result), and the edge is divided (subdivided) using the division process.

Specific examples or modifications of the division process will be described below.

In the division process, the method of dividing the edge (the division method) may be specified.

In the division process, the number of times the edge is divided (the number of iterations of division) may be specified.

In the division process, the method of dividing the edge and the number of times the edge is divided (the division method and the number of iterations of division) may be specified.

The division process may be a process of generating a new vertex based on position information of a plurality of vertexes forming the edge (another definition of the division process).

In the decoding process, a parameter that specifies the division process may be decoded from an encoded bitstream (signaling of the division process).

At least any of the division processes may be prescribed in advance (a predetermined division process).

The division process includes not dividing the edge (an option not to divide).

Specific examples or modifications of the determination process will be described below.

In the determination process, whether one edge to be processed among edges forming the polygon is a boundary of submeshes may be determined (an edge-based determination process).

In the determination process, whether edges forming the polygon include an edge that is a boundary of submeshes may be determined (determination of whether the polygon includes a boundary edge).

The boundary of submeshes may be an edge that includes, at opposite ends thereof, a plurality of vertexes forming a plurality of submeshes (a definition of the boundary).

Specific examples of the relationship between the determination result and the division process will be described below.

In the division process, when the one edge to be processed is a boundary of submeshes, the one edge may be divided using a first division process.

In the division process, when the one edge to be processed is not a boundary of submeshes, the one edge may be divided using a second division process.

In the division process, when the polygon includes an edge that is a boundary of submeshes, the edge that is a boundary of submeshes may be divided using the first division process, and an edge that is not a boundary of submeshes may be divided using the second division process.

In the division process, when the polygon includes no edge that is a boundary of submeshes, all the edges included in the polygon may be divided using the second division process.

In the division process, when the polygon includes an edge that is a boundary of submeshes, whether the first division process and the second division process are in a predetermined relationship may be determined, and the division process may be determined based on the determination result. For example, the division process may be switched based on the result of comparison between the number of iterations of division specified in the first division process and the number of iterations of division specified in the second division process.

Specific examples of the first division process (a division process for a boundary) and the second division process (a division process for a non-boundary) will be described below.

The first division process and the second division process may be different processes (different division processes are selected).

The first division process may be selected from a first division process group, and the second division process may be selected from a second division process group. The first division process group and the second division process group may include different division processes (a division process is selected from among a plurality of division processes or in other words different options).

In the first division process, a same common process may be selected for a plurality of submeshes. Alternatively, in the division process, processes may be selected from the same group for a plurality of submeshes.

The first division process may be determined on a sequence basis or on a frame basis. A parameter used for the first division process may be encoded in an encoded bitstream.

The second division process may be determined on a submesh basis. A parameter used for the second division process may be encoded in an encoded bitstream.

Note that "different processes" may mean processes that are different in at least one of the number of iterations of division or the division method.

Furthermore, for example, an encoding device according to the present disclosure includes a circuit and a memory connected to the circuit, and in operation, the circuit encodes a first vertex and a second vertex in a bitstream, the first vertex being connected to the second vertex by an edge, determines whether the edge is a boundary edge, derives a third vertex from only the first vertex and the second vertex when the edge is a boundary edge, a position of the third vertex being interpolated based on only a position of the first vertex and a position of the second vertex, and derives a fourth vertex from the first vertex, the second vertex, and at least one fifth vertex that is different from the first vertex and the second vertex when the edge is not a boundary edge, a position of the fourth vertex being interpolated based on the position of the first vertex, the position of the second vertex, and a position of the at least one fifth vertex.

Furthermore, for example, an encoding device according to the present disclosure includes an input terminal to which at least one image is input, a block divider that divides a first image included in the at least one image into a plurality of blocks, an intra predictor that predicts a block included in the first image using a reference image included in the first image, an inter predictor that predicts a block included in the first image using a reference block included in a second image that is different from the first image, a loop filter that filters a block included in the first image, a transformer that transforms a prediction error between an original signal and a prediction signal generated by the intra predictor or the inter predictor to generate a transformed coefficient, a quantizer that quantizes the transformed coefficient to generate a quantized coefficient, an entropy encoder that variable-length encodes the quantized coefficient to generate an encoded bitstream, and an output terminal from which the encoded quantized coefficient and the bitstream including control information are output, the encoder encodes a first vertex and a second vertex in the bitstream, the first vertex being connected to the second vertex by an edge, determines whether the edge is a boundary edge, derives a third vertex from only the first vertex and the second vertex when the edge is a boundary edge, a position of the third vertex being interpolated based on only a position of the first vertex and a position of the second vertex, and derives a fourth vertex from the first vertex, the second vertex, and at least one fifth vertex that is different from the first vertex and the second vertex when the edge is not a boundary edge, a position of the fourth vertex being interpolated based on the position of the first vertex, the position of the second vertex, and a position of the at least one fifth vertex.

Furthermore, for example, a decoding device according to the present disclosure includes a circuit and a memory connected to the circuit, and in operation, the circuit decodes a first vertex and a second vertex from a bitstream, the first vertex being connected to the second vertex by an edge, determines whether the edge is a boundary edge, derives a third vertex from only the first vertex and the second vertex when the edge is a boundary edge, a position of the third vertex being interpolated based on only a position of the first vertex and a position of the second vertex, and derives a fourth vertex from the first vertex, the second vertex, and at least one fifth vertex that is different from the first vertex and the second vertex when the edge is not a boundary edge, a position of the fourth vertex being interpolated based on the position of the first vertex, the position of the second vertex, and a position of the at least one fifth vertex.

Furthermore, for example, a decoding device according to the present disclosure includes an input terminal to which the bitstream is input, a decoder that decodes the bitstream to output a quantized coefficient, an inverse quantizer that inverse-quantizes the quantized coefficient to output a transformed coefficient, an inverse transformer that inverse-transforms the transformed coefficient to output a prediction error, an intra predictor that predicts a block included in a first image using a reference image included in the first image, an inter predictor that predicts a block included in the first image using a reference block included in a second image that is different from the first image, a loop filter that filters a block included in the first image, and an output terminal from which an image including the first image is output, the decoder decodes a first vertex and a second vertex from the bitstream, the first vertex being connected to the second vertex by an edge, determines whether the edge is a boundary edge, derives a third vertex from only the first vertex and the second vertex when the edge is a boundary edge, a position of the third vertex being interpolated based on only a position of the first vertex and a position of the second vertex, and derives a fourth vertex from the first vertex, the second vertex, and at least one fifth vertex that is different from the first vertex and the second vertex when the edge is not a boundary edge, a position of the fourth vertex being interpolated based on the position of the first vertex, the position of the second vertex, and a position of the at least one fifth vertex.

Furthermore, for example, an encoding method according to the present disclosure includes encoding a first vertex and a second vertex in a bitstream, the first vertex being connected to the second vertex by an edge, determining whether the edge is a boundary edge, deriving a third vertex from only the first vertex and the second vertex when the edge is a boundary edge, a position of the third vertex being interpolated based on only a position of the first vertex and a position of the second vertex, and deriving a fourth vertex from the first vertex, the second vertex, and at least one fifth vertex that is different from the first vertex and the second vertex when the edge is not a boundary edge, a position of the fourth vertex being interpolated based on the position of the first vertex, the position of the second vertex, and a position of the at least one fifth vertex.

Furthermore, for example, a decoding method according to the present disclosure includes decoding a first vertex and a second vertex from a bitstream, the first vertex being connected to the second vertex by an edge, determining whether the edge is a boundary edge, deriving a third vertex from only the first vertex and the second vertex when the edge is a boundary edge, a position of the third vertex being interpolated based on only a position of the first vertex and a position of the second vertex, and deriving a fourth vertex from the first vertex, the second vertex, and at least one fifth vertex that is different from the first vertex and the second vertex when the edge is not a boundary edge, a position of the fourth vertex being interpolated based on the position of the first vertex, the position of the second vertex, and a position of the at least one fifth vertex.

Furthermore, for example, whether the edge is a boundary edge is determined based on the number of connections to the edge. Furthermore, for example, whether the edge is a boundary edge is determined by using one or more parameters decoded from the bitstream. Furthermore, for example, the one or more parameters are decoded from a header of the bitstream. Furthermore, for example, the first vertex, the second vertex, the third vertex, the fourth vertex, and the fifth vertex are vertexes of a three-dimensional mesh frame. Furthermore, for example, the first vertex, the second vertex, the third vertex, the fourth vertex, and the fifth vertex are vertexes of a three-dimensional submesh.

In the encoding technique for multimedia data, there is a demand for new methods for improving the encoding efficiency and the image quality and for reducing the circuit size.

Each of the embodiments, some of the components, and each of the methods in the present disclosure enables, for example, at least one of improvement in encoding efficiency, improvement in image quality, reduction in encoding/decoding processing amount, reduction in circuit size, improvement in encoding/decoding processing speed, and the like. Alternatively, each of the embodiment, a part of each component, and each of the methods in the present disclosure enables any of an element, such as a filter, a block, a size, a motion vector, a reference picture, and a reference block, or an arithmetic operation to be appropriately selected in encoding and decoding. The present disclosure includes a disclosure relating to a configuration and a method that can provide an advantage other than the advantages described above. Examples of such a configuration and a method include a configuration and a method that improve the encoding efficiency while reducing the increase in processing amount.

Additional values and advantages of aspects of the present disclosure will be apparent from the specification and the drawings. The values and/or advantages can be provided by each of the various embodiments and features described in the specification and the drawings, and all the embodiments and features in the specification and the drawings are not necessary to provide one or more of such values and/or advantages.

These general or specific aspects can be implemented by using a system, an integrated circuit, a computer program, a computer-readable recording medium such as CD-ROM, or an arbitrary combination of systems, methods, integrated circuits, computer programs, and computer-readable recording media.

Representative Example

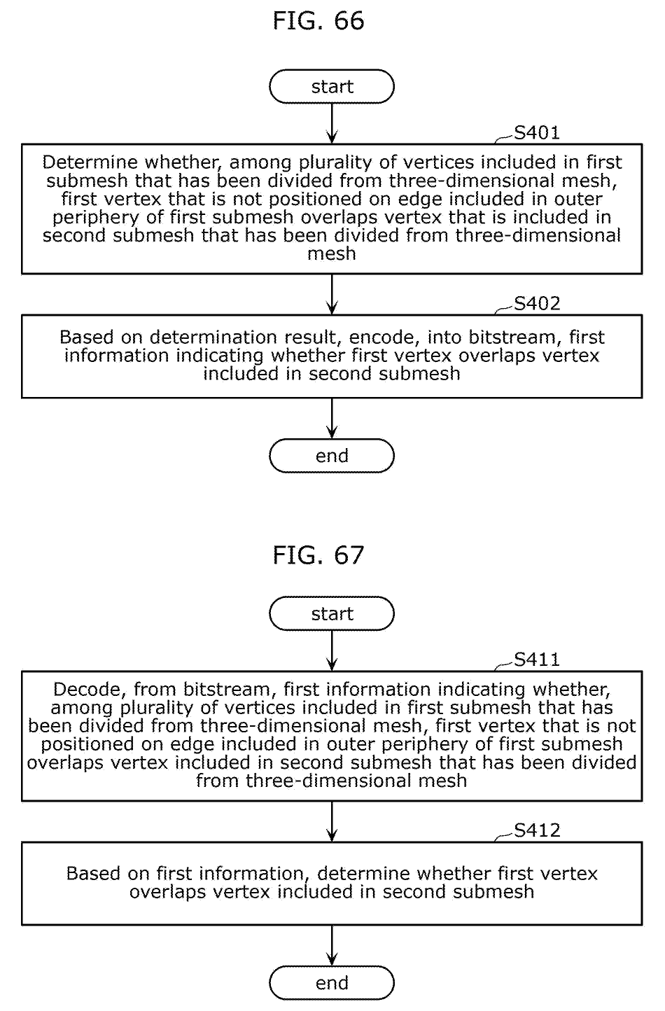

FIG. 66 is a flowchart illustrating an example of a basic encoding process according to the present embodiment. For example, encoding device 100 illustrated in FIG. 24 includes circuit 151 and memory 152 connected to circuit 151. In encoding device 100, circuit 151 performs the following processes in operation.

First, encoding device 100 determines whether, among a plurality of vertices included in a first submesh that has been divided from a three-dimensional mesh, a first vertex that is not positioned on an edge included in an outer periphery of the first submesh overlaps a vertex that is included in a second submesh that has been divided from the three-dimensional mesh (S401).

Specifically, encoding device 100 determines whether the first vertex included in the first submesh is the same vertex as any of vertices included in the second submesh (e.g., whether the first vertex has the same information, such as position information, attribute information, etc., as that of any of vertices included in the second submesh). An overlapping state means, for example, a state in which submeshes share the same vertex. For example, encoding device 100 determines whether an arbitrary vertex (first vertex) in the three-dimensional mesh is included in both of the first submesh and the second submesh. Namely, encoding device 100 determines whether the first submesh and the second submesh share the first vertex in the three-dimensional mesh. In other words, when the first submesh and the second submesh are generated by dividing the three-dimensional mesh, encoding device 100 determines whether both of the first submesh and the second submesh include the first vertex in the three-dimensional mesh.

Moreover, the edge included in the outer periphery of the first submesh is, for example, a submesh boundary as described above. In other words, the edge included in the outer periphery of the first submesh is an edge formed by connecting outermost vertices as described above. The first vertex is, for example, an inside vertex as described above. In other words, the first vertex is, among the vertices included in the first submesh, any of vertices other than outermost vertices as described above. Moreover, the first vertex is, for example, an overlapping vertex that is positioned in a submesh boundary inside portion as described above, or a boundary vertex that is positioned in a submesh boundary inside portion as described above. Furthermore, the three-dimensional mesh is, for example, an original mesh as described above. The first submesh and the second submesh are, for example, submeshes divided from an original mesh as described above.

Next, based on a determination result of the determination (S401), encoding device 100 encodes, into a bitstream, first information indicating whether the first vertex overlaps the vertex included in the second submesh (S402). Namely, encoding device 100 generates a bitstream including first information. Encoding device 100 transmits the bitstream generated to decoding device 200.

The first information is, for example, information included in overlap information as described above or boundary information as described above. Specifically, the first information is, for example, border_flag[i] as described above.

Accordingly, decoding device 200 that has received the bitstream can determine whether the first vertex overlaps the vertex included in the second submesh by only checking the first information, without decoding the first submesh and the second submesh and performing a process for determining whether the first vertex overlaps the vertex included in the second submesh, for example. Accordingly, it is possible to reduce the processing amount.

Moreover, for example, encoding device 100 further encodes, into the bitstream, second information indicating a second vertex on which a predetermined process is performed first among two or more vertices that are included in the plurality of vertices and sequentially subjected to the predetermined process.

The second information is, for example, starting_vertex_id as described above. Each of the two or more vertices is, for example, a boundary vertex. The predetermined process is, for example, a first mesh decoding process as described above.

Accordingly, based on the second information, decoding device 200 that has received the bitstream can perform the predetermined process on the second vertex first among the two or more vertices. Therefore, decoding device 200 can perform the predetermined process on the two or more vertices in an appropriate order.

It should be noted that each of the two or more vertices may be a vertex other than a boundary vertex, and the predetermined process may be, for example, a second mesh decoding process as described above.

Moreover, for example, encoding device 100 further encodes, into the bitstream, third information indicating a third vertex on which the predetermined process is performed last among the two or more vertices that are included in the plurality of vertices and sequentially subjected to the predetermined process.

The third information is, for example, ending_vertex_id.

Accordingly, based on the third information, decoding device 200 that has received the bitstream can perform the predetermined process on the third vertex last among the two or more vertices. Therefore, decoding device 200 can perform the predetermined process on the two or more vertices in an appropriate order.

Moreover, for example, encoding device 100 further encodes, into the bitstream, fourth information indicating an order of the plurality of vertices when the predetermined process is performed on each of the plurality of vertices.

Accordingly, decoding device 200 that has received the bitstream can perform the predetermined process sequentially on the two or more vertices, based on the fourth information. Therefore, decoding device 200 can perform the predetermined process on the two or more vertices in an appropriate order.

FIG. 67 is a flowchart illustrating an example of a basic decoding process according to the present embodiment. For example, decoding device 200 illustrated in FIG. 25 includes circuit 251 and memory 252 connected to circuit 251. In decoding device 200, circuit 251 performs the following processes in operation.

First, decoding device 200 decodes, from a bitstream, first information indicating whether, among a plurality of vertices included in a first submesh that has been divided from a three-dimensional mesh, a first vertex that is not positioned on an edge included in an outer periphery of the first submesh overlaps a vertex included in a second submesh that has been divided from the three-dimensional mesh (S411).

Next, decoding device 200 determines, based on the first information, whether the first vertex overlaps the vertex included in the second submesh (S412).

Accordingly, decoding device 200 can determine whether the first vertex overlaps the vertex included in the second submesh by only checking the first information, without decoding the first submesh and the second submesh and performing a process for determining whether the first vertex overlaps the vertex included in the second submesh, for example. Accordingly, it is possible to reduce the processing amount.

Moreover, for example, decoding device 200 further decodes, from the bitstream, second information indicating a second vertex on which a predetermined process is performed first among two or more vertices that are included in the plurality of vertices and sequentially subjected to the predetermined process.

Accordingly, decoding device 200 can perform the predetermined process on the second vertex first among the two or more vertices, based on the second information. Therefore, decoding device 200 can perform the predetermined process on the two or more vertices in an appropriate order.

Moreover, for example, decoding device 200 further decodes, from the bitstream, third information indicating a third vertex on which the predetermined process is performed last among the two or more vertices that are included in the plurality of vertices and sequentially subjected to the predetermined process.

Accordingly, decoding device 200 can perform the predetermined process on the third vertex last among the two or more vertices, based on the third information. Therefore, decoding device 200 can perform the predetermined process on the two or more vertices in an appropriate order.

Moreover, for example, decoding device 200 further decodes, from the bitstream, fourth information indicating an order of the plurality of vertices when the predetermined process is performed on each of the plurality of vertices.

Accordingly, decoding device 200 can perform the predetermined process sequentially on the two or more vertices, based on the fourth information. Therefore, decoding device 200 can perform the predetermined process on the two or more vertices in an appropriate order.

Other examples

Although the aspects of encoding device 100 and decoding device 200 have thus far been described according to the embodiment, the aspects of encoding device 100 and decoding device 200 are not limited to the embodiment. Modifications that may be conceived by a person skilled in the art may be applied to the embodiment, and a plurality of constituent elements in the embodiment may be combined in any manner.

For example, processing performed by a specific constituent element in the embodiment may be performed by a different constituent element instead of the specific constituent element. Moreover, the order of processes may be changed or processes may be performed in parallel.

Moreover, as stated above, it is possible to implement, as an integrated circuit, at least part of the plurality of constituent elements in the present disclosure. At least part of the processes in the present disclosure may be used as an encoding method or a decoding method. A program for causing a computer to execute the encoding method or the decoding method may be used. Furthermore, a non-transitory computer-readable recording medium on which the program is recorded may be used. In addition, a bitstream for causing decoding device 200 to perform decoding may be used.

Moreover, at least part of the plurality of constituent elements and the processes in the present disclosure may be used as a transmitting device, a receiving device, a transmitting method, and a receiving method. A program for causing a computer to execute the transmitting method or the receiving method may be used. Furthermore, a non-transitory computer-readable recording medium on which the program is recorded may be used.

### INDUSTRIAL APPLICABILITY

The present disclosure is useful in, for example, an encoding device, a decoding device, a transmitting device, a receiving device, and the like related to a three-dimensional mesh and can be applied to a computer graphics system, a three-dimensional data display system, and the like.

1. An encoding device comprising:
a circuit; and
memory that is connected to the circuit, wherein
in operation, the circuit:
determines whether, among a plurality of vertices included in a first submesh that has been divided from a three-dimensional mesh, a first vertex that is not positioned on an edge included in an outer periphery of the first submesh overlaps a vertex included in a second submesh that has been divided from the three-dimensional mesh; and
based on a determination result of the determination, encodes, into a bitstream, first information indicating whether the first vertex overlaps the vertex included in the second submesh.

2. The encoding device according to claim 1, wherein
the circuit further encodes, into the bitstream, second information indicating a second vertex on which a predetermined process is performed first among two or more vertices that are included in the plurality of vertices and sequentially subjected to the predetermined process.

3. The encoding device according to claim 1, wherein
the circuit further encodes, into the bitstream, third information indicating a third vertex on which a predetermined process is performed last among two or more vertices that are included in the plurality of vertices and sequentially subjected to the predetermined process.

4. The encoding device according to claim 1, wherein
the circuit further encodes, into the bitstream, fourth information indicating an order of the plurality of vertices when a predetermined process is performed on each of the plurality of vertices.

5. A decoding device comprising:
a circuit; and
memory that is connected to the circuit, wherein
in operation, the circuit:
decodes, from a bitstream, first information indicating whether, among a plurality of vertices included in a first submesh that has been divided from a three-dimensional mesh, a first vertex that is not positioned on an edge included in an outer periphery of the first submesh overlaps a vertex included in a second submesh that has been divided from the three-dimensional mesh; and
based on the first information, determines whether the first vertex overlaps the vertex included in the second submesh.

6. The decoding device according to claim 5, wherein
the circuit further decodes, from the bitstream, second information indicating a second vertex on which a predetermined process is performed first among two or more vertices that are included in the plurality of vertices and sequentially subjected to the predetermined process.

7. The decoding device according to claim 5, wherein
the circuit further decodes, from the bitstream, third information indicating a third vertex on which a predetermined process is performed last among two or more vertices that are included in the plurality of vertices and sequentially subjected to the predetermined process.

8. The decoding device according to claim 5, wherein
the circuit further decodes, from the bitstream, fourth information indicating an order of the plurality of vertices when a predetermined process is performed on each of the plurality of vertices.

9. An encoding method comprising:
determining whether, among a plurality of vertices included in a first submesh that has been divided from a three-dimensional mesh, a first vertex that is not positioned on an edge included in an outer periphery of the first submesh overlaps a vertex included in a second submesh that has been divided from the three-dimensional mesh; and
based on a determination result of the determining, encoding, into a bitstream, first information indicating whether the first vertex overlaps the vertex included in the second submesh.

10. A decoding method comprising:
decoding, from a bitstream, first information indicating whether, among a plurality of vertices included in a first submesh that has been divided from a three-dimensional mesh, a first vertex that is not positioned on an edge included in an outer periphery of the first submesh overlaps a vertex included in a second submesh that has been divided from the three-dimensional mesh; and
based on the first information, determining whether the first vertex overlaps the vertex included in the second submesh.
